(19) United States
(12) Patent Application Publication
(10) Pub. No.: US 2025/0167433 A1
(43) Pub. Date: May 22, 2025

(54) ELECTRONIC DEVICE INCLUDING ANTENNA

(71) Applicant: SUMSUNG ELECTRONICS CO., LTD., Suwon-si (KR)

(72) Inventors: Sewoong KIM, Suwon-si (KR); Hojung Nam, Suwon-si (KR); Euisung Kang, Suwon-si (KR); Jiho Kim, Suwon-si (KR); Soonho Hwang, Suwon-si (KR)

(73) Assignee: SUMSUNG ELECTRONICS CO., LTD., Suwon-si (KR)

(21) Appl. No.: 19/029,474

(22) Filed: Jan. 17, 2025

Related U.S. Application Data
(63) Continuation of application No. PCT/KR2024/015778, filed on Oct. 17, 2024.

(30) Foreign Application Priority Data
Oct. 31, 2023 (KR) 10-2023-0148243
Feb. 20, 2024 (KR) 10-2024-0024077

(51) Int. Cl. H01Q 1/24; H01Q 1/48; H01Q 9/04

(52) U.S. Cl. CPC H01Q 1/243; H01Q 1/48; H01Q 9/0414

(57) ABSTRACT

An electronic device includes: a housing including a side member forming a portion of an outer side of the electronic device and including a conductive portion; a printed circuit board (PCB) provided in the housing; and a wireless communication circuit electrically connected to the PCB, where the PCB includes: a plurality of first coupling pads provided on at least some of a plurality of layers of the PCB; at least one second coupling pad spaced apart from the plurality of first coupling pads; a dielectric provided between the plurality of first coupling pads and the at least one second coupling pad; and an electrical connection member connected to the plurality of first coupling pads to form an electrical path, and connected to the conductive portion, where the at least one second coupling pad is connected to the wireless communication circuit to form an electrical path.

### CROSS-REFERENCE TO RELATED APPLICATIONS

This application is a continuation application of International Application No. PCT/KR2024/015778, filed on Oct. 17, 2024, which is based on and claims priority to Korean Patent Application No. 10-2023-0148243, filed on Oct. 31, 2023, in the Korean Intellectual Property Office, and Korean Patent Application No. 10-2024-0024077, filed on Feb. 20, 2024, in the Korean Intellectual Property Office, the disclosure of which are incorporated by reference herein in their entireties.

### BACKGROUND

### 1. Field

The disclosure relates to an electronic device including an antenna.

### 2. Description of Related Art

Wireless communication technology enables the transmission and reception of various forms of information. As the wireless communication technology advances, electronic devices such as smartphones adapted to perform wireless communication may provide services using communication functions such as global positioning system (GPS), Wi-Fi, long-term evolution (LTE), or near-field communication (NFC). To perform such wireless communication, an electronic device may include an antenna structure. The above description is information the inventor(s) acquired during the course of conceiving the present disclosure, or already possessed at the time, and is not necessarily art publicly known before the present application was filed.

### SUMMARY

Additional aspects will be set forth in part in the description which follows and, in part, will be apparent from the description, or may be learned by practice of the presented embodiments.

According to an aspect of the disclosure, an electronic device may include: a housing including a side member forming a portion of an outer side of the electronic device and including a conductive portion; a printed circuit board (PCB) provided in the housing; and a wireless communication circuit electrically connected to the PCB, where the PCB includes: a plurality of first coupling pads provided on at least some of a plurality of layers of the PCB; at least one second coupling pad spaced apart from the plurality of first coupling pads; a dielectric provided between the plurality of first coupling pads and the at least one second coupling pad; and an electrical connection member connected to the plurality of first coupling pads to form an electrical path, and connected to the conductive portion, where the at least one second coupling pad is connected to the wireless communication circuit to form an electrical path, and where at least a portion of the at least one second coupling pad is provided between a pair of first coupling pads among the plurality of first coupling pads.

The at least one second coupling pad may be provided as a plurality of second coupling pads, where the plurality of first coupling pads and the plurality of second coupling pads are alternately provided on at least some of the plurality of layers of the PCB along a first direction.

The plurality of first coupling pads may be adjacent to the plurality of second coupling pads, and respective capacitances for indirect electrical signal delivery may be formed between the plurality of first coupling pads and the plurality of second coupling pads, where a total sum of the respective capacitances formed on the PCB is configured to be greater than or equal to 10 picofarads (pF).

An overlap area among the plurality of first coupling pads and the plurality of second coupling pads is substantially similar in the first direction.

The PCB may further include: at least one first conductive via connected to the plurality of first coupling pads to form an electrical path; and at least one second conductive via connected to the second coupling pad to form an electrical path.

The PCB may have a first board surface and a second board surface opposite the first board surface, where the dielectric is provided on the first board surface and the second board surface such that the plurality of first coupling pads and the at least one second coupling pad are not exposed to an outside of the PCB.

The PCB may further include: a switch connected to at least one conductive via among the at least one first conductive via and the at least one second conductive via, and configured to selectively block an electrical path formed by the at least one conductive via.

The PCB may further include: a ground spaced apart from the plurality of first coupling pads and the at least one second coupling pad; and a discharge inductive portion configured to induce an electrical signal discharge from the plurality of first coupling pads to the ground.

The at least one first coupling pad, among the plurality of first coupling pads, and the ground are provided on a same layer of the PCB, and where the discharge inductive portion includes at least one first discharge member directly connected to the at least one first coupling pad on the same layer as the ground and protruding toward the ground.

The discharge inductive portion may further include at least one second discharge member connected to the ground and protruding toward the at least one first coupling pad provided on the same layer as the ground.

A first coupling pad, among the plurality of first coupling pads, may be adjacent to a second coupling pad, among the at least one second coupling pad, along a first direction, where the first coupling pad and the second coupling pad form a coupling pad set, and where a distance in the first direction between the first coupling pad and the second coupling pad that form the coupling pad set is less than a distance in the first direction between an adjacent coupling pad sets.

At least one first coupling pad, among the plurality of first coupling pads, and the at least one second coupling pad may be provided on a same layer relative to a first direction of the PCB, where the at least one first coupling pad and the at least one second coupling pad on the same layer are alternately provided in a second direction of the PCB perpendicular to the first direction.

The PCB may further include: a third coupling pad electrically insulated from the plurality of first coupling pads and the at least one second coupling pad based on the dielectric, where the third coupling pad and the at least one second coupling pad at least partially overlap in a first direction of the PCB, and where the electrical connection member includes: a first electrical connection member connected to at least some of the plurality of first coupling pads to form an electrical path; and a second electrical connection member connected to the third coupling pad to form an electrical path.

The side member may include a first conductive portion and a second conductive portion electrically separated along the outer side of the electronic device, where the first electrical connection member and the second electrical connection member are connected to the first conductive portion and the second conductive portion, respectively.

The PCB may further include: a fourth coupling pad electrically insulated from the plurality of first coupling pads and the at least one second coupling pad based on the dielectric, and connected to the wireless communication circuit to form an electrical path, and where at least one first coupling pad, among the plurality of first coupling pads, and the fourth coupling pad overlap at least partially in a first direction of the PCB.

The PCB may further include: a radiation member including a conductive material or conductive pattern, and where the radiation member overlaps the at least one second coupling pad in a first direction of the PCB or is electrically connected to the wireless communication circuit.

According to an aspect of the disclosure, an electronic device may include: a housing including a side member forming a portion of an outer side of the electronic device and including a conductive portion; a printed circuit board (PCB) provided in the housing; and a wireless communication circuit electrically connected to the PCB, where the PCB includes: a first coupling pad; a second coupling pad spaced apart from the first coupling pad and connected to the wireless communication circuit to form an electrical path; a dielectric configured to electrically insulate the first coupling pad and the second coupling pad; an electrical connection member connected to the first coupling pad to form an electrical path, and connected to the conductive portion; a ground electrically separated from the first coupling pad and the second coupling pad; and a discharge inductive portion configured to induce an electrical signal discharge from the first coupling pad to the ground, and where the first coupling pad and the second coupling pad at least partially overlap along a first direction of the PCB.

The ground may be provided on a surface of the PCB, the first coupling pad may be provided on a same layer as the ground, and the discharge inductive portion may be between the first coupling pad and the ground on the same layer.

The discharge inductive portion may include: a first discharge member connected to the first coupling pad and protruding toward the ground; or a second discharge member connected to the ground and protruding toward the first coupling pad, where a gap is formed between the first discharge member and the ground, or between the second discharge member and the first coupling pad, and where the dielectric is provided in the gap.

According to an aspect of the disclosure, an electronic device may include: a housing including a side member forming a portion of an outer side of the electronic device and including a first conductive portion and a second conductive portion that are electrically separable; a printed circuit board (PCB) provided in the housing; and a wireless communication circuit electrically connected to the PCB, where the PCB includes: a first coupling pad; a second coupling pad spaced apart from the first coupling pad and connected to the wireless communication circuit to form an electrical path; a third coupling pad spaced apart from the first coupling pad and the second coupling pad; a dielectric configured to electrically insulate the first coupling pad, the second coupling pad, and the third coupling pad; a first electrical connection member connected to the first coupling pad to form an electrical path, and connected to the first conductive portion; and a second electrical connection member connected to the third coupling pad to form an electrical path, and connected to the second conductive portion, and where the first coupling pad and the third coupling pad at least partially overlap the second coupling pad along a first direction of the PCB.

According to an aspect of the disclosure, an electronic device may include: a housing including a side member forming a portion of an outer side of the electronic device and including a conductive portion; a printed circuit board (PCB) provided in the housing; and a wireless communication circuit electrically connected to the PCB, where the PCB includes: a first coupling pad; a second coupling pad spaced apart from the first coupling pad and connected to the wireless communication circuit through a first signal line; a fourth coupling pad spaced apart from the first coupling pad and the second coupling pad, and connected to the wireless communication circuit through a second signal line; a dielectric configured to electrically insulate the first coupling pad, the second coupling pad, and the fourth coupling pad; and an electrical connection member connected to the first coupling pad to form an electrical path and connected to the conductive portion, and where the second coupling pad and the fourth coupling pad at least partially overlap the first coupling pad along a first direction of the PCB.

According to an aspect of the disclosure, an electronic device may include: a housing including a side member forming a portion of an outer side of the electronic device, and including a first conductive portion and a second conductive portion that are electrically separable; and a printed circuit board (PCB) provided in the housing, where the PCB includes: a first coupling pad; a second coupling pad spaced apart from the first coupling pad; a dielectric configured to electrically insulate the first coupling pad and the second coupling pad; a first electrical connection member connected to the first coupling pad to form an electrical path, and connected to the first conductive portion; and a second electrical connection member connected to the second coupling pad to form an electrical path, and connected to the second conductive portion, and where the first coupling pad and the second coupling pad at least partially overlap along a first direction of the PCB.

According to an aspect of the disclosure, an electronic device may include: a housing including a side member forming a portion of an outer side of the electronic device and including a conductive portion; a printed circuit board (PCB) provided in the housing; and a wireless communication circuit electrically connected to the PCB, where the PCB includes: a first coupling pad; a plurality of second coupling pads spaced apart from the first coupling pad; a dielectric configured to electrically insulate the first coupling pad and the plurality of second coupling pads; and an electrical connection member connected to the first coupling pad to form an electrical path, and connected to the conductive portion, and where the plurality of second coupling pads are connected to the wireless communication circuit to form an electrical path, and at least a portion of the first coupling pad is provided between a pair of second coupling pads among the plurality of second coupling pads.

According to an aspect of the disclosure, an electronic device may include: a housing including a side member forming a portion of an outer side of the electronic device and including a conductive portion; a printed circuit board (PCB) provided in the housing; and a wireless communication circuit electrically connected to the PCB, where the PCB includes: a pair of first coupling pads provided on different layers among a plurality of layers of the PCB; a second coupling pad provided on a layer that is between the pair of first coupling pads and spaced apart from the pair of first coupling pads; a dielectric configured to electrically insulate the pair of first coupling pads and the second coupling pad; and an electrical connection member connected to the pair of first coupling pads to form an electrical path, and connected to the conductive portion, and where the second coupling pad is connected to the wireless communication circuit to form an electrical path, and at least a portion of the second coupling pad overlaps the pair of first coupling pads.

### BRIEF DESCRIPTION OF DRAWINGS

The above and/or other aspects will be more apparent by describing certain embodiments, taken in conjunction with the accompanying drawings, in which:

FIG. 1 is a block diagram illustrating an electronic device in a network environment according to an embodiment of the present disclosure;

FIG. 2A is a front perspective view of an electronic according to an embodiment of the present disclosure;

FIG. 2B is a rear perspective view of an electronic device according to an embodiment of the present disclosure;

FIG. 3 is an exploded perspective view of an electronic device according to an embodiment of the present disclosure;

FIG. 4A is a diagram schematically illustrating a connection structure of a side member and a printed circuit board (PCB) in an electronic device according to an embodiment of the present disclosure;

FIG. 4B is a graph illustrating antenna performance exhibited in a case of transferring an electrical signal through a capacitance between coupling pads in an electronic device according to an embodiment of the present disclosure;

FIG. 5A is a cross-sectional view of a PCB according to an embodiment of the present disclosure;

FIG. 5B is a partial cross-sectional view of a PCB, illustrating area A of FIG. 5A according to an embodiment of the present disclosure;

FIG. 5C is a partial perspective view of a PCB, illustrating area A of FIG. 5A according to an embodiment of the present disclosure;

FIG. 5D is a partial top view of a PCB, illustrating a discharge inductive portion, according to an embodiment of the present disclosure;

FIG. 5E is a partial top view of a PCB, illustrating a discharge inductive portion, according to an embodiment of the present disclosure;

FIG. 5F is a partial top view of a PCB, illustrating a discharge inductive portion, according to an embodiment of the present disclosure;

FIG. 5G is a partial top view of a PCB, illustrating a discharge inductive portion, according to an embodiment of the present disclosure;

FIG. 5H is a partial top view of a PCB, illustrating a discharge inductive portion, according to an embodiment of the present disclosure;

FIG. 6A is a partial cross-sectional view of a PCB according to an embodiment of the present disclosure;

FIG. 6B is a partial top view of a PCB, illustrating a discharge inductive portion, according to an embodiment of the present disclosure;

FIG. 7A is a partial perspective view of a PCB according to an embodiment of the present disclosure;

FIG. 7B is a partial perspective view of a PCB according to an embodiment of the present disclosure;

FIG. 7C is a partial perspective view of a PCB according to an embodiment of the present disclosure;

FIG. 7D is a partial perspective view of a PCB according to an embodiment of the present disclosure;

FIG. 7E is a partial perspective view of a PCB according to an embodiment of the present disclosure;

FIG. 7F is a partial perspective view of a PCB according to an embodiment of the present disclosure;

FIG. 7G is a partial perspective view of a PCB according to an embodiment of the present disclosure;

FIG. 8A is a partial perspective view of a PCB according to an embodiment of the present disclosure;

FIG. 8B is an exploded perspective view illustrating a layer structure of a portion of a PCB according to an embodiment of the present disclosure;

FIG. 9A is a partial perspective view of a PCB according to an embodiment of the present disclosure;

FIG. 9B is an exploded perspective view illustrating a layer structure of a portion of a PCB according to an embodiment of the present disclosure;

FIG. 10 is a partial perspective view of a PCB according to an embodiment of the present disclosure;

FIG. 11 is a partial perspective view of a PCB according to an embodiment of the present disclosure;

FIG. 12 is a partial perspective view of a PCB according to an embodiment of the present disclosure;

FIG. 13 is a partial perspective view of a PCB according to an embodiment of the present disclosure;

FIG. 14A is a diagram schematically illustrating a connection structure of a side member and a PCB in an electronic device according to an embodiment of the present disclosure;

FIG. 14B is a diagram schematically illustrating a circuit connection structure of a side member, a PCB, and a wireless communication circuit according to an embodiment of the present disclosure;

FIG. 14C is a partial perspective view of a PCB according to an embodiment of the present disclosure;

FIG. 14D is an exploded perspective view illustrating a layer structure of a portion of a PCB according to an embodiment of the present disclosure;

FIG. 15A is a diagram schematically illustrating a connection structure of a side member and a PCB in an electronic device according to an embodiment of the present disclosure;

FIG. 15B is a diagram schematically illustrating a circuit connection structure of a side member, a PCB, and a wireless communication circuit according to an embodiment of the present disclosure;

FIG. 15C is a partial perspective view of a PCB according to an embodiment of the present disclosure;

FIG. 15D is an exploded perspective view illustrating a layer structure of a portion of a PCB according to an embodiment of the present disclosure;

FIG. 16A is a diagram schematically illustrating a connection structure of a side member and a PCB in an electronic device according to an embodiment of the present disclosure;

FIG. 16B is a partial perspective view of a PCB according to an embodiment of the present disclosure;

FIG. 17A is a partial perspective view of a PCB according to an embodiment of the present disclosure;

FIG. 17B is a partial perspective view of a PCB according to an embodiment of the present disclosure;

FIG. 17C is a graph illustrating a change in radiation efficiency of an antenna with and without a radiation member on a PCB according to an embodiment of the present disclosure;

FIG. 18A is a partial perspective view of a PCB according to an embodiment of the present disclosure;

FIG. 18B is a partial cross-sectional view of a PCB according to an embodiment of the present disclosure;

FIG. 19 is a partial cross-sectional view of a PCB according to an embodiment of the present disclosure;

FIG. 20A is a partial exploded perspective view of an electronic device according to an embodiment of the present disclosure;

FIG. 20B is a partial cross-sectional view illustrating a connection structure of a PCB and a rear frame according to an embodiment of the present disclosure;

FIG. 21A is a diagram schematically illustrating a connection structure of a side member and a PCB in an electronic device according to an embodiment of the present disclosure;

FIG. 21B is a partial cross-sectional view, illustrating area F21 of FIG. 21A according to an embodiment of the present disclosure;

FIG. 22A is a front perspective view of an electronic device according to an embodiment of the present disclosure;

FIG. 22B is a rear perspective view of an electronic device according to an embodiment of the present disclosure;

FIG. 22C is an exploded perspective view of an electronic device according to an embodiment of the present disclosure;

FIG. 23 is a diagram schematically illustrating a connection structure of a side member and a PCB in an electronic device according to an embodiment of the present disclosure;

FIG. 24A is a front perspective view of an electronic device according to an embodiment of the present disclosure;

FIG. 24B is a rear perspective view of an electronic device according to an embodiment of the present disclosure;

FIG. 24C is an exploded perspective view of an electronic device according to an embodiment of the present disclosure;

FIG. 25 is a diagram schematically illustrating a connection structure of a side member and a PCB in an electronic device according to an embodiment of the present disclosure;

FIG. 26A is a front perspective view of an electronic device in an unfolded state according to an embodiment of the present disclosure;

FIG. 26B is a rear view of an electronic device in an unfolded state according to an embodiment of the present disclosure;

FIG. 26C is a perspective view of an electronic device in a folded state according to an embodiment of the present disclosure;

FIG. 27 is a diagram schematically illustrating a connection structure of a side member and a PCB in an electronic device according to an embodiment of the present disclosure;

FIG. 28A is a front perspective view of an electronic device in a first state according to an embodiment of the present disclosure;

FIG. 28B is a front perspective of an electronic device in a second state according to an embodiment of the present disclosure;

FIG. 28C is a rear perspective view of an electronic device in a first state according to an embodiment of the present disclosure;

FIG. 28D is a rear perspective of an electronic device in a second state according to an embodiment of the present disclosure; and

FIG. 29 is a diagram schematically illustrating a connection structure of a side member and a PCB in an electronic device according to an embodiment of the present disclosure.

### DETAILED DESCRIPTION

Hereinafter, various embodiments will be described in greater detail with reference to the accompanying drawings. When describing the embodiments with reference to the accompanying drawings, like reference numerals refer to like elements and a repeated description related thereto will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

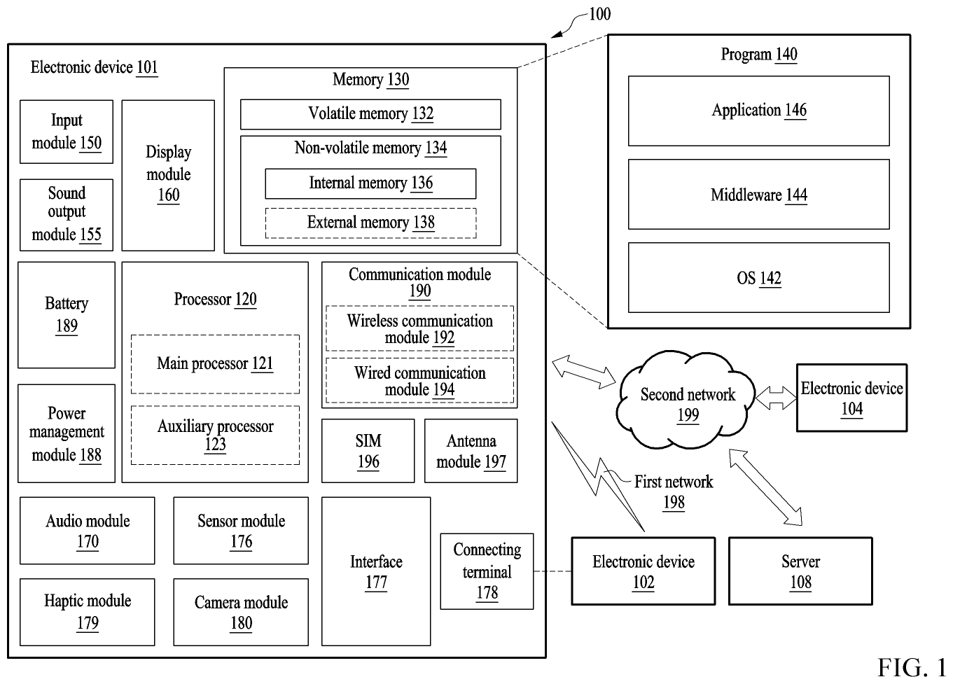

FIG. 1 is a block diagram illustrating an electronic device 101 in a network environment 100 according to an embodiment of the present disclosure.

Referring to FIG. 1, the electronic device 101 in the network environment 100 may communicate with an external electronic device 102 via a first network 198 (e.g., a short-range wireless communication network), or communicate with at least one of an external electronic device 104 and a server 108 via a second network 199 (e.g., a long-range wireless communication network). According to an embodiment, the electronic device 101 may communicate with the external electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added in the electronic device 101. In various embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated by machine learning. Such learning may be performed by, for example, the electronic device 101 in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may alternatively or additionally include a software structure other than the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134. The non-volatile memory 134 may include an internal memory 136 and an external memory 138.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing records. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector, and a control circuitry to control a corresponding one of the display, the hologram device, and the projector. According to an embodiment, the display module 160 may include a touch sensor adapted to sense a touch, or a pressure sensor adapted to measure an intensity of a force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the external electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with an external electronic device (e.g., the external electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the external electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and an external electronic device (e.g., the external electronic device 102, the external electronic device 104, or the server 108) and performing communication via the established communication channel. The communication module 190 may include one or more communication processors that are operable independently of the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as, Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., an LAN or a wide area network (WAN))). These various types of communication modules may be implemented as a single component (e.g., a single chip), or may be implemented as multiple components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4th generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., an mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an antenna array, analog beamforming, or a large-scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to various embodiments, the antenna module 197 may form an mmWave antenna module. According to an embodiment, the mmWave antenna module may include a PCB, an RFIC disposed on a first surface (e.g., a bottom surface) of the PCB or adjacent to the first surface and capable of supporting a designated high-frequency band (e.g., the mmWave band), and a plurality of antennas (e.g., array antennas) disposed on a second surface (e.g., a top or a side surface) of the PCB or adjacent to the second surface and capable of transmitting or receiving signals in the designated high-frequency band.

At least some of the components described above may be coupled mutually and communicate signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as, or a different type, from the electronic device 101. According to an embodiment, all or some of operations to be executed by the electronic device 101 may be executed at one or more of the external electronic devices 102 and 104, and the server 108. For example, if the electronic device 101 needs to perform a function or a service automatically, or in response to a request from a user or another device, the electronic device 101, instead of, or in addition to, executing the function or the service, may request one or more external electronic devices to perform at least a part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least a part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

It should be appreciated that various embodiments of the disclosure and the terms used therein are not intended to limit the technological features set forth herein to particular example embodiments and include various changes, equivalents, or replacements for a corresponding embodiment. In connection with the description of the drawings, like reference numerals may be used for similar or related components. As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof. Terms such as “first” “second,” or “1st” or “2nd” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via a third element.

It will be understood that the terms “includes,” “comprises,” “has,” “having,” “including,” “comprising,” and the like, specify the presence of stated features, figures, steps, operations, components, members, or combinations thereof, but do not preclude the presence or addition of one or more other features, figures, steps, operations, components, members, or combinations thereof.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

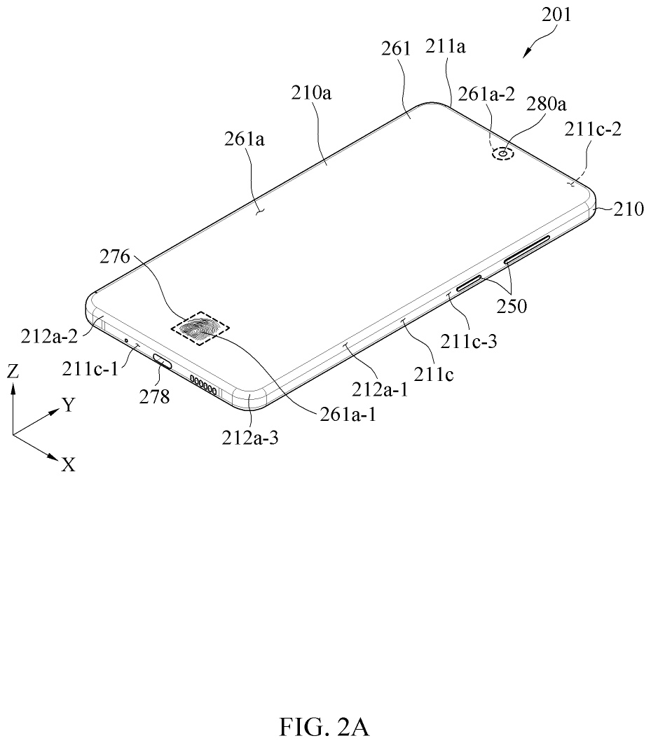

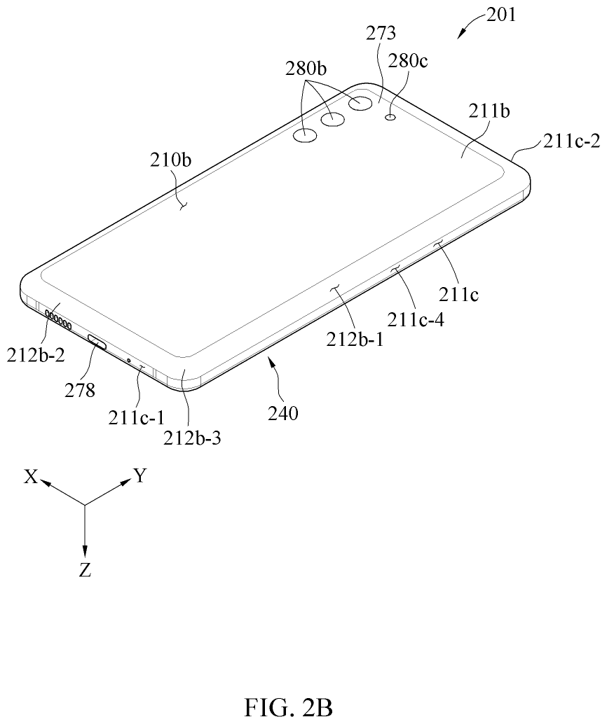

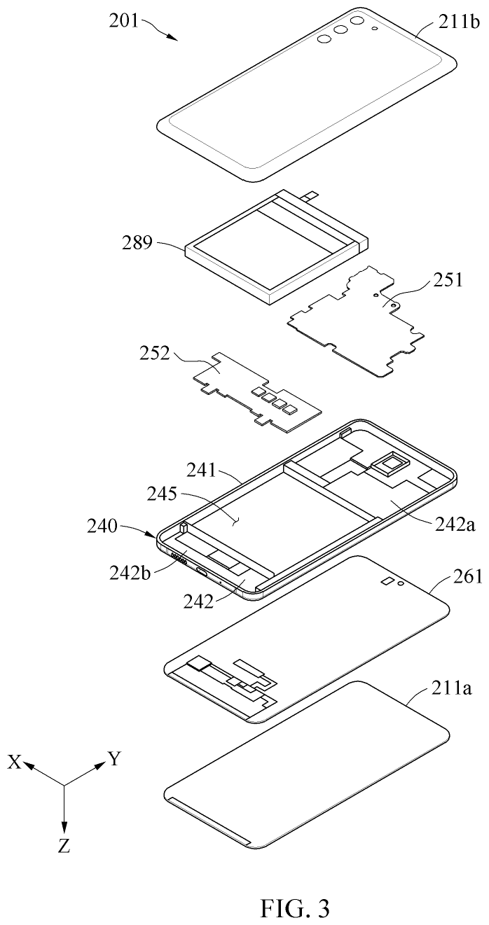

FIG. 2A is a front perspective view of an electronic according to an embodiment of the present disclosure. FIG. 2B is a rear perspective view of an electronic device according to an embodiment of the present disclosure. FIG. 3 is an exploded perspective view of an electronic device according to an embodiment of the present disclosure.

Referring to FIGS. 2A, 2B, and 3, according to an embodiment, an electronic device 201 (e.g., the electronic device 101 in FIG. 1) may include a housing 210 forming a first surface 210a (or a front surface), a second surface 210b (or a rear surface), and a side 211c enclosing a space between the first surface 210a and the second surface 210b. It is to be noted that the shape of a housing shown in the drawings is provided only as an example.

According to an embodiment, the electronic device 201 may include the housing 210 that forms the exterior and houses components therein. The housing 210 may form the front surface 210a (e.g., a surface facing a +Z direction), the rear surface 210b (e.g., a surface facing a −Z direction), and the side 211c enclosing an inner space between the front surface 210a and the rear surface 210b. In an embodiment, the housing 210 may form the side 211c by a first side 211c-1 (e.g., a surface facing a −Y direction), a second side 211c-2 (e.g., a surface facing a +Y direction), a third side 211c-3 (e.g., a surface facing a +X direction), and a fourth side 211c-4 (e.g., a surface facing a −X direction) that connect the front surface 210a and the rear surface 210b.

In an embodiment, the front surface 210a may be formed by a front plate 211a that is at least partially substantially transparent. The front plate 211a may include, for example, a glass plate or polymer plate including at least one coated layer. In an embodiment, the rear surface 210b may be formed by a rear plate 211b that is substantially opaque. The rear plate 211b may be formed with, for example, coated or tinted glass, ceramic, polymer, metal (e.g., aluminum, stainless steel, magnesium, etc.), or a combination thereof. In an embodiment, the side 211c may be formed by a side member 240 that is coupled to the front plate 211a and the rear plate 211b and includes metal and/or polymer. In an embodiment, the rear plate 211b and the side member 240 may be seamlessly formed to be integral. In an embodiment, the rear plate 211b and the side member 240 may be formed of substantially the same material (e.g., aluminum).

In an embodiment, the front plate 211a may include a plurality of first edge areas 212a-1 that face in one direction (e.g., +/−X direction), extend from at least a portion of the front surface 210a to the rear plate 211b, and are rounded; a plurality of second edge areas 212a-2 that face in another direction (e.g., +/−Y direction), extend from at least a portion of the front surface 210a to the rear plate 211b, and are rounded; and a plurality of third edge areas 212a-3 that are rounded, extending from at least a portion of the front surface 210a to the rear plate 211b, and are disposed between the plurality of first edge areas 212a-1 and the plurality of second edge areas 212a-2.

In an embodiment, the rear plate 211b may include a plurality of fourth edge areas 212b-1 that face in one direction (e.g., +/−X direction), extend from at least a portion of the rear surface 210b to the front plate 211a, and are rounded; a plurality of fifth edge areas 212b-2 that face in another direction (e.g., +/−Y direction), extend from at least a portion of the rear surface 210b to the front plate 211a, and are rounded; and a plurality of sixth edge areas 212b-3 that are rounded, extending from at least a portion of the rear surface 210b to the front plate 211a, and are disposed between the plurality of fourth edge areas 212b-1 and the plurality of fifth edge areas 212b-2.

In an embodiment, the side member 240 may enclose at least a portion of the inner space between the front surface 210a and the rear surface 210b. In an embodiment, a display 261 may be disposed on one surface (e.g., in the +Z direction) of the side member 240, and the rear plate 211b may be disposed on another surface (e.g., in the −Z direction) of the side member 240. In an embodiment, the side member 240 may include a conductive portion. For example, at least a portion of the side member 240 may be formed of a conductive material. In an embodiment, the side member 240 may include a side portion 241 disposed on at least a portion of the side 211c, and a support portion 242 coupled to the side portion 241 and disposed inside the electronic device 201.

In an embodiment, the side portion 241 may form the side 211c of the housing 210 by connecting edges of the front plate 211a and the rear plate 211b and enclosing a space between the front plate 211a and the rear plate 211b. In an embodiment, the support portion 242 may be disposed inside the electronic device 201. In an embodiment, the side portion 241 and the support portion 242 may be formed integrally or may be coupled together after being formed separately. In a case where the side portion 241 and the support portion 242 are formed separately, the side member 240 may be formed to include only the side portion 241. In an embodiment, the side portion 241 (e.g., the side member 240) may include a plurality of conductive portions disposed along the side 211c of the electronic device 201. For example, the conductive portion may be formed of a metal and/or conductive polymer material. In an embodiment, the support portion 242 may be formed of a metal and/or conductive polymer material in common with the side portion 241. In an embodiment, in a case where the support portion 242 is directly connected to the conductive portion of the side portion 241, the support portion 242 may form an electrical path leading from the conductive portion of the side portion 241 to the ground.

In an embodiment, the electronic device 201 may include the display 261 (e.g., the display module 160 in FIG. 1). In an embodiment, the display 261 may be disposed on the front surface 210a of the electronic device 201. In an embodiment, the display 261 may be exposed through at least a portion (e.g., the first edge areas 212a-1, the second edge areas 212a-2, and the third edge areas 212a-3) of the front plate 211a. In an embodiment, the display 261 may have substantially the same shape as an outer contour shape of the front plate 211a. Although not shown, according to an embodiment, the display 261 may include a touch screen panel (TSP), a pressure sensor, and/or a digitizer configured to detect a stylus pen.

In an embodiment, the display 261 may include a screen display region 261a that is visually exposed to the outside of the electronic device 201 and displays content through pixels or a plurality of cells. In an embodiment, the screen display region 261a may include a sensing area 261a-1 and a camera area 261a-2. The sensing area 261a-1 may overlap at least a portion of the screen display region 261a. The sensing area 261a-1 may allow input signals associated with a sensor module (e.g., the sensor module 176 in FIG. 1) to be transmitted. The sensing area 261a-1 may display content in conjunction with the screen display region 261a that does not overlap the sensing area 261a-1.

In an embodiment, the camera area 261a-2 may overlap at least a portion of the screen display region 261a. The camera area 261a-2 may expose a lens of a first camera module 280a (e.g., the camera module 180 in FIG. 1) disposed to face the front of the electronic device 201. For example, the camera area 261a-2 may allow optical signals (e.g., light) associated with the first camera module 280a to be transmitted. In an embodiment, the camera area 261a-2 may display content, in common with the portion of the screen display region 261a that does not overlap the camera area 261a-2. For example, the camera area 261a-2 may display content while the first camera module 280a is not operating.

In an embodiment, the electronic device 201 may include a sensor module 276. The sensor module 276 may sense signals applied to the electronic device 201. The sensor module 276 may be disposed on, for example, the front surface 210a of the electronic device 201. The sensor module 276 may be disposed on the electronic device 201 to correspond to the sensing area 261a-1 of the screen display region 261a. For example, the sensor module 276 may be disposed to perform its function in the inner space of the electronic device 201 without being visually exposed through the display 261. The sensor module 276 may receive an input signal transmitted through the sensing area 261a-1 and generate an electrical signal based on the received input signal. For example, the input signal may have a specified physical quantity (e.g., heat, light, temperature, sound, pressure, ultrasound, etc.). For another example, the input signal may include a signal associated with biometric information (e.g., fingerprint, voice, etc.) of a user.

In an embodiment, the electronic device 201 may include camera modules 280a and 280b (e.g., the camera module 180 in FIG. 1). In an embodiment, the camera modules 280a and 280b may include the first camera module 280a and a second camera module 280b. In an embodiment, the electronic device 201 may include a flash 280c disposed near the first camera module 280a and the second camera module 280b.

In an embodiment, the first camera module 280a may be disposed with a lens exposed on the front surface 210a of the housing 210 and may receive optical signals from the front (e.g., the +Z direction) of the electronic device 201. The second camera module 280b may be disposed with a lens exposed on the rear surface 210b of the housing 210 and may receive optical signals from the rear (e.g., the −Z direction) of the electronic device 201. In an embodiment, at least a portion of the first camera module 280a may be disposed on the housing 210 such that it is covered by the display 261. For example, the first camera module 280a may include an under-display camera (UDC). In an embodiment, the first camera module 280a may receive an optical signal transmitted through the camera area 261a-2. In an embodiment, the second camera module 280b may include a plurality of cameras (e.g., dual camera, triple camera, or quad camera). In an embodiment, the flash 280c may include a light-emitting diode (LED) or a xenon lamp.

In an embodiment, the electronic device 201 may include an input module 250 (e.g., the input module 150 in FIG. 1). The input module 250 may receive operational signals from the user. For example, the input module 250 may include at least one key input device disposed to be exposed on the side 211c of the housing 210.

In an embodiment, the electronic device 201 may include a connecting terminal 278 (e.g., the connecting terminal 178 in FIG. 1). In an embodiment, the connecting terminal 278 may be disposed on an outer circumferential surface of the housing 210. The electronic device 201 may be connected to an external device (e.g., another electronic device or an external power source) by wire through the connecting terminal 278.

In an embodiment, the electronic device 201 may include at least one circuit board (e.g., a printed circuit board (PCB)). For example, the electronic device 201 may include a first PCB 251 (or a main PCB) and a second PCB 252 (or a sub-PCB). The first PCB 251 and the second PCB 252 may be disposed inside the electronic device 201, for example, on a second support structure 242. The at least one PCB (e.g., 251 and 252) may be connected to the second support portion 242 through the ground. In an embodiment, the first PCB 251 may be received in a first board slot 242a formed by the second support portion 242. In an embodiment, the second PCB 252 may be received in a second board slot 242b formed by the second support portion 242. In an embodiment, the PCB (e.g., 251 and 252) may be a rigid PCB or a flexible PCB (FPCB) that is at least partially bendable. In an embodiment, the PCB (e.g., 251 and 252) may be formed in a multi-layer structure. Hereinafter, for ease of description, a direction in which layers of a PCB is stacked will be referred to as a first direction.

In an embodiment, the electronic device 201 may include a battery 289 disposed therein. The battery 289 may be disposed in a battery slot 245 formed in the second support portion 242.

According to various embodiments, an electronic device may be a device of one of various types. The electronic device may include, as non-limiting examples, a portable communication device (e.g., a smartphone), a computing device, a portable multimedia device, a portable medical device, a camera, a wearable device, or consumer electronics. However, the electronic device described herein is not limited to the preceding examples.

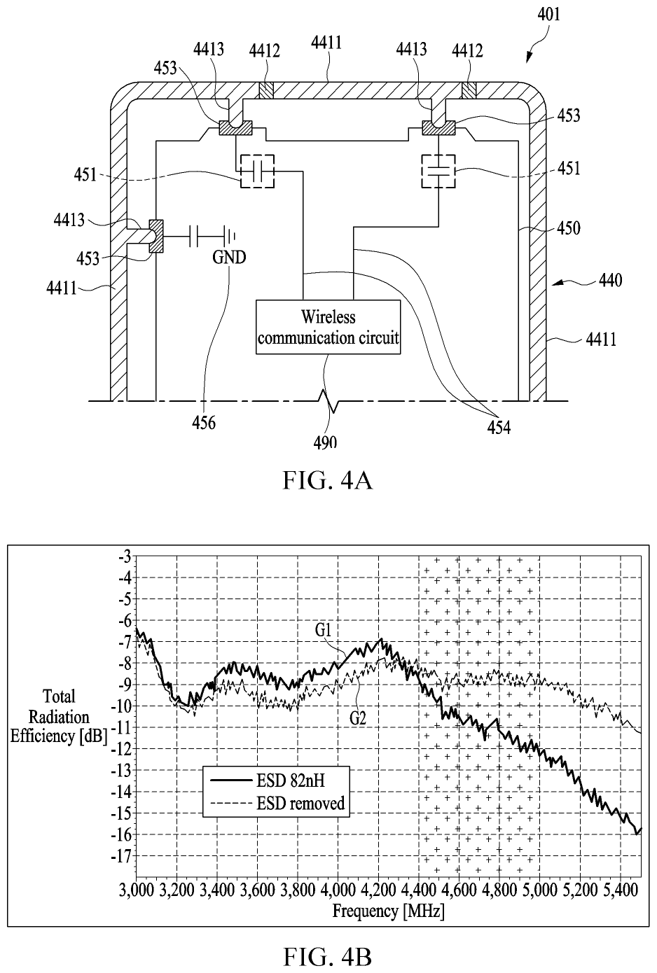

FIG. 4A is a diagram schematically illustrating a connection structure of a side member and a PCB in an electronic device according to an embodiment of the present disclosure. FIG. 4B is a graph illustrating antenna performance exhibited in a case of transferring an electrical signal through a capacitance between coupling pads in an electronic device according to an embodiment of the present disclosure.

Referring to FIG. 4A, according to an embodiment, an electronic device 401 (e.g., the electronic device 201 in FIG. 2A) may include a housing (e.g., the housing 210 in FIG. 2A), a PCB 450 (e.g., the first PCB 251 or the second PCB 252 in FIG. 3), and a wireless communication circuit 490.

In an embodiment, the housing may include a front surface (e.g., the front surface 210a in FIG. 2A), a rear surface (e.g., the rear surface 210b in FIG. 2A) opposite the front surface, and a side (e.g., the side 211c in FIG. 2A) enclosing an inner space between the front surface and the rear surface. In an embodiment, the housing may include a side member 440 (e.g., the side member 240 in FIG. 3) that forms at least a portion of the side and encloses the inner space. In an embodiment, the side member 440 may include a plurality of conductive portions 4411 formed of a conductive material. In an embodiment, some of the conductive portions 4411 may function as a radiator through which electrical signals flow. In an embodiment, the side member 440 may include an insulative portion 4412 disposed between the plurality of conductive portions 4411 and configured to electrically separate the conductive portions 4411 that are adjacent to each other. In an embodiment, the side member 440 may include at least one connective portion 4413 formed on a conductive portion 4411 and electrically connected to the PCB 450. In an embodiment, the connective portion 4413 may function as a feed point to which an electrical signal is applied to the conductive portion 4411 or as a ground point from which the electrical signal applied to the conductive portion 4411 escapes. In an embodiment, the connective portion 4413 may overlap at least a portion of the PCB 450 disposed within the housing, with reference to a top view shown in FIG. 4. For example, the connective portion 4413 may be in direct contact with an electrical connection member 453 disposed on the PCB 450, as shown in FIG. 4. Alternatively, the connective portion 4413 may be disposed so as not to overlap the PCB 450. For example, the connective portion 4413 may be in indirect contact with the electrical connection member 453 disposed on the PCB 450 through a separate circuit.

In an embodiment, the PCB 450 may be disposed in the inner space of the housing. In an embodiment, the PCB 450 may be formed in a multi-layer structure with a plurality of layers stacked. In an embodiment, the PCB 450 may include at least one electrical connection member 453 electrically connected to the conductive portion 4411. In an embodiment, the electrical connection member 453 may be provided in the form of a conductive contact member formed of a conductive material or in the form of a C-clip. For example, the electrical connection member 453 may contact the connective portion 4413 formed on the conductive portion 4411. In an embodiment, the PCB 450 may be mounted in the inner space of the housing such that the electrical connection member 453 contacts the connective portion 4413 of the corresponding conductive portion 4411, respectively.

In an embodiment, the PCB 450 may be electrically connected to the wireless communication circuit 490. For example, the wireless communication circuit 490 may be disposed on the PCB 450 or may be disposed on another PCB. In an embodiment, the PCB 450 may include at least one signal line 454 connected to the wireless communication circuit 490. In an embodiment, the PCB 450 may form at least one electrical path leading from the electrical connection member 453 connected to the conductive portion 4411 to the wireless communication circuit 490 via the signal line 454.

In an embodiment, the PCB 450 may include a plurality of coupling pads 451 disposed on the electrical path. The coupling pads 451 may electrically connect the electrical connection member 453 and the corresponding signal line 454 connected to the wireless communication circuit 490 by a coupled feeding structure (or a coupling connection structure). In an embodiment, the coupling pads 451 may electrically connect the electrical connection member 453 and the signal line 454 that correspond to each other by the coupled feeding structure, thereby indirectly transferring an electrical signal through a capacitance formed between the coupling pads 451. According to an embodiment, the coupled feeding structure may prevent or block a direct electrical signal delivery (or transfer) between the conductive portions 4411 of the side member 440 and the wireless communication circuit 490, and may thus form an electrostatic discharge (ESD) blocking structure that prevents or reduces an electrostatic or noise signal transfer from the conductive portions 4411 to the wireless communication circuit 490.

In an embodiment, the PCB 450 may include a ground 456 for grounding electrostatic or noise signals transferred from the conductive portions 4411. In an embodiment, the ground 456 of the PCB 450 may be connected to a ground region (e.g., a region of the ground 456 of the side member 440) of the electronic device 401 to allow a noise signal applied to the PCB 450 to escape externally from the PCB 450 to be removed.

Referring to FIG. 4B, shown is antenna radiation performance (or antenna radiation efficiency) exhibited when an electrical signal of a specific frequency band is transmitted and received through the conductive portions 4411 of the side member 440. In the graph of FIG. 4B, a horizontal axis represents a frequency band radiated through a conductive portion, and a vertical axis represents a total radiation efficiency through the conductive portion. In the graph, line G1 represents the radiation efficiency depending on a frequency band exhibited when the conductive portions 4411 and the wireless communication circuit 490 are directly connected through a circuit including an ESD protection element, and line G2 represents the radiation efficiency depending on a frequency band exhibited when the conductive portions 4411 and the wireless communication circuit 490 are connected through a capacitance formed between the plurality of coupling pads 451 under the same conditions as G1.

Comparing lines G1 and G2 shown in FIG. 4B, it may be verified that, in a lower frequency band, there is no significant difference in the radiation efficiency between G1 and G2, while, in a higher frequency band (e.g., ultra-high band (UHB) area, 4,400 to 5,000 megahertz (Mhz)), G2 has more effective radiation efficiency than G1. For example, it may be verified that, in a specific frequency band, the antenna radiation efficiency may be more stably maintained by employing a method of connecting the conductive portions 4411 and the wireless communication circuit 490 through the coupled feeding structure through the plurality of coupling pads 451 without the separate ESD protection element, instead of a method of directly connecting the conductive portions 4411 and the wireless communication circuit 490 through the circuit including the ESD protection element. That is, it may be verified that using the coupled feeding structure with the ESD element omitted may improve a phenomenon where the antenna radiation efficiency deteriorates, in a specific frequency band.

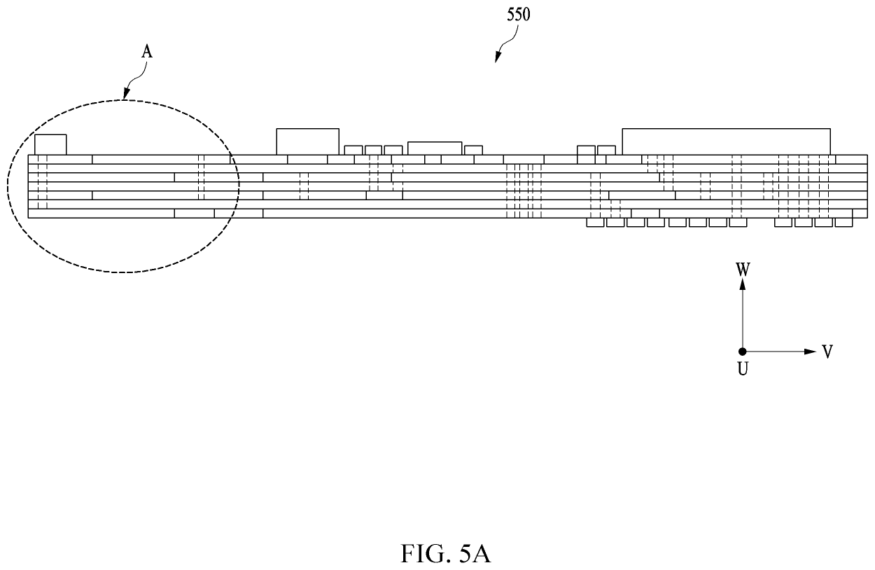

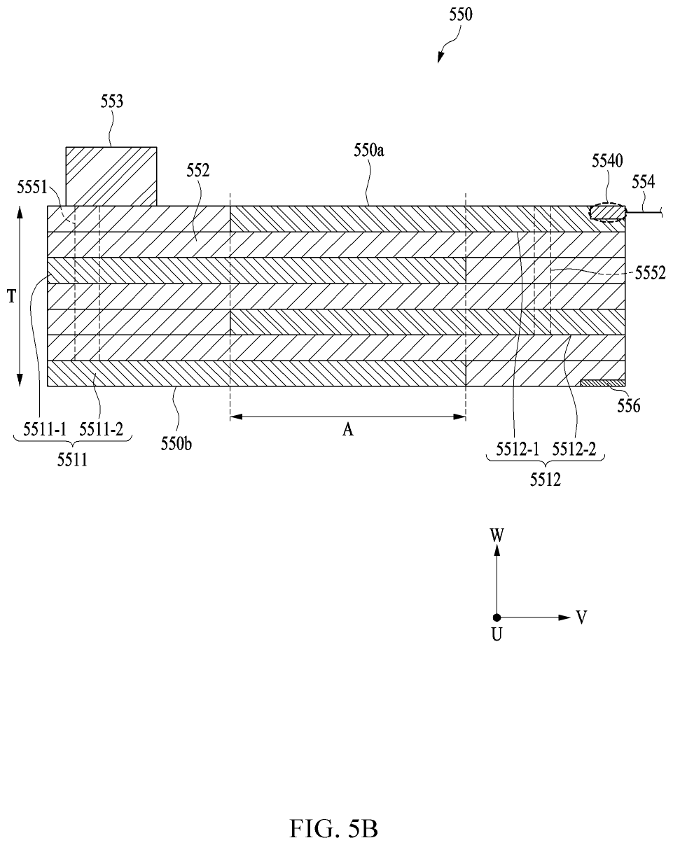

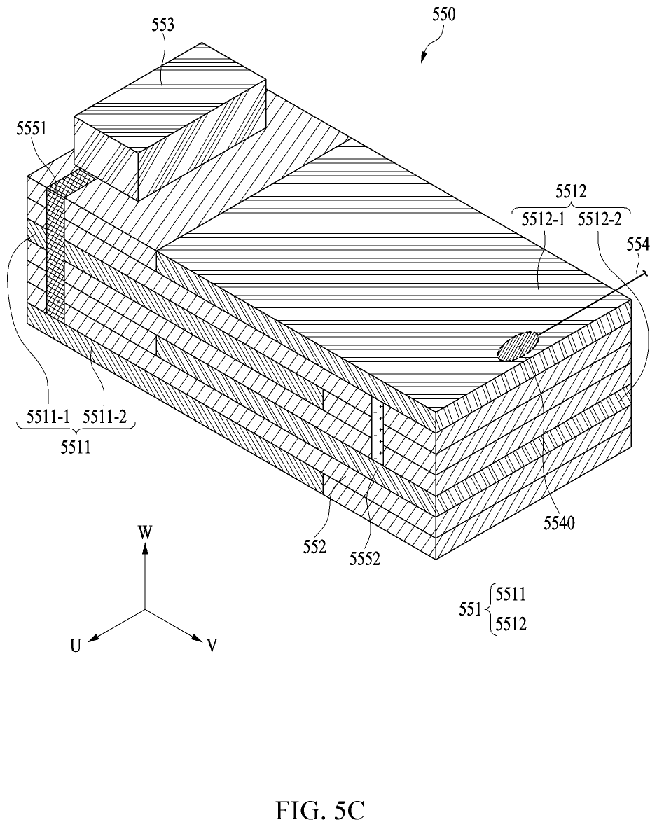

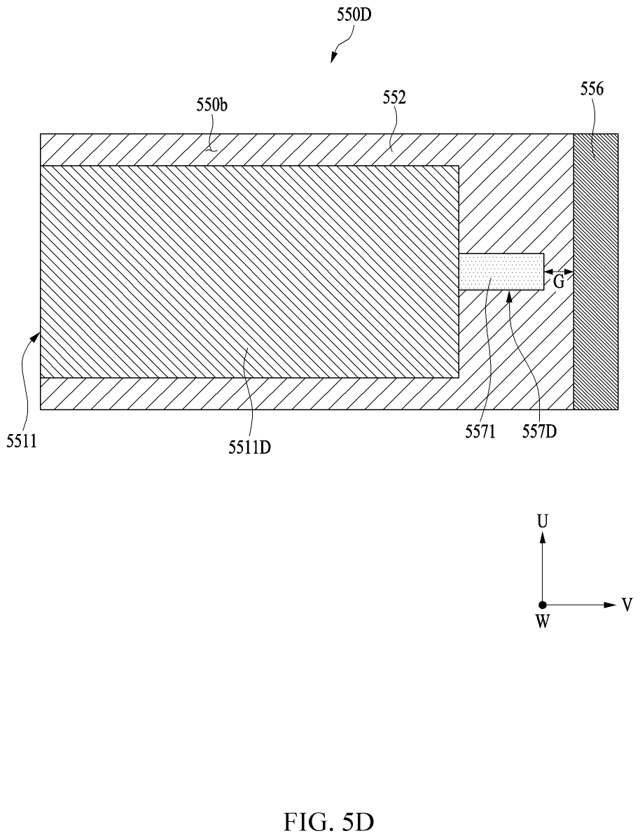

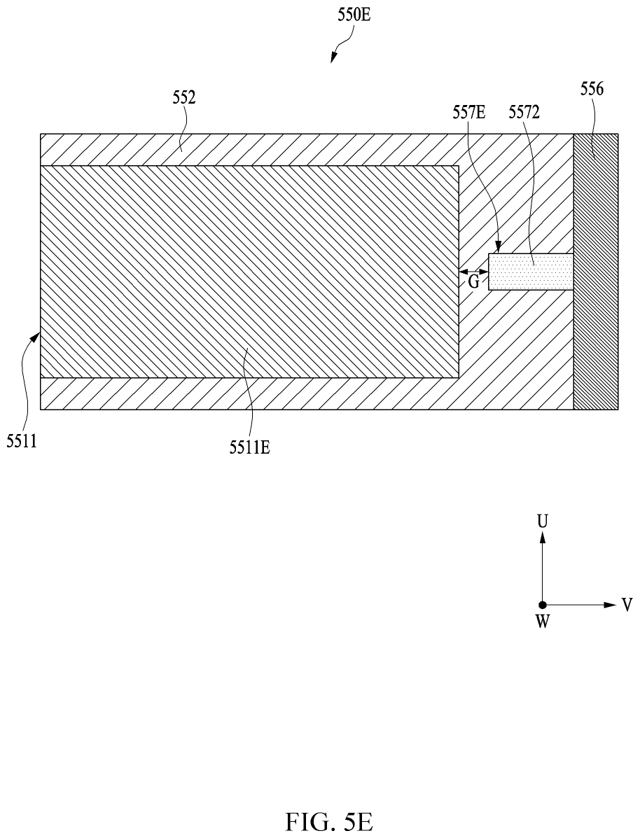

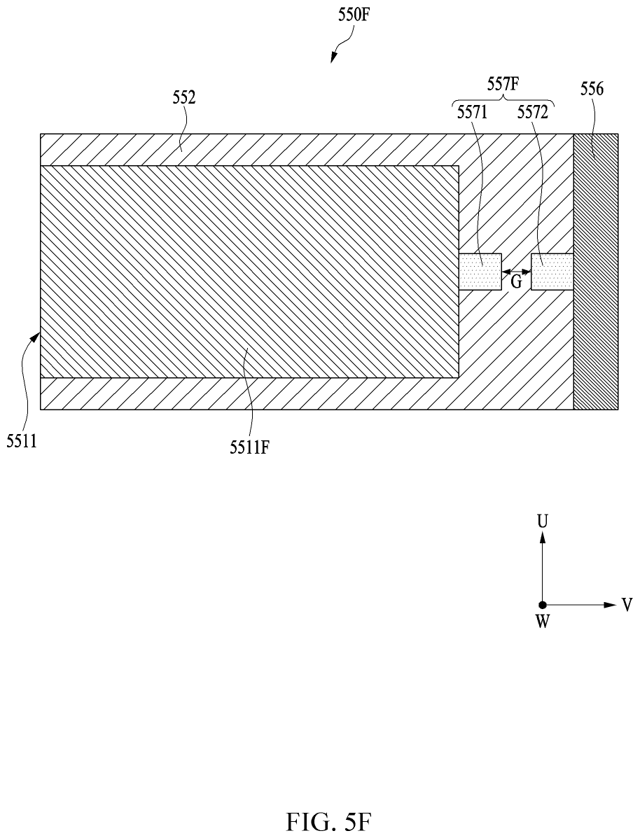

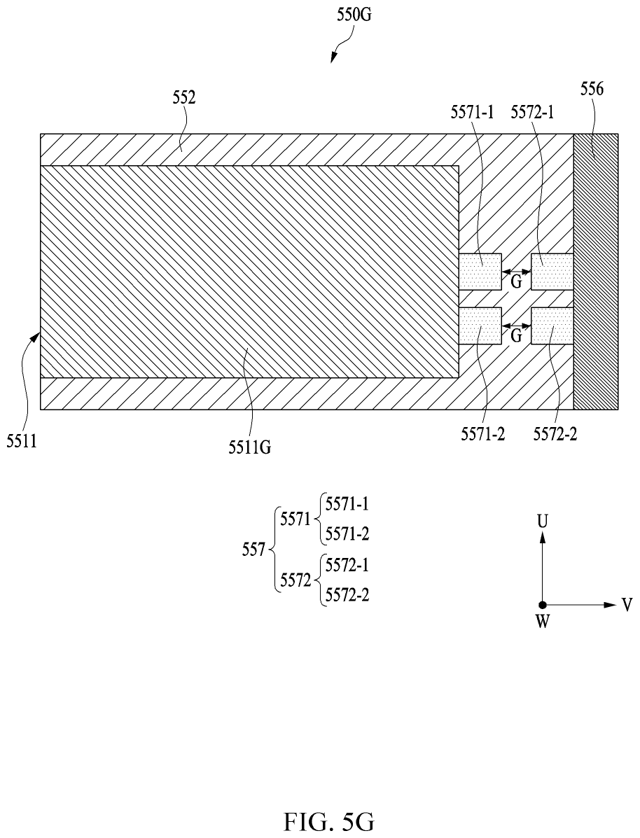

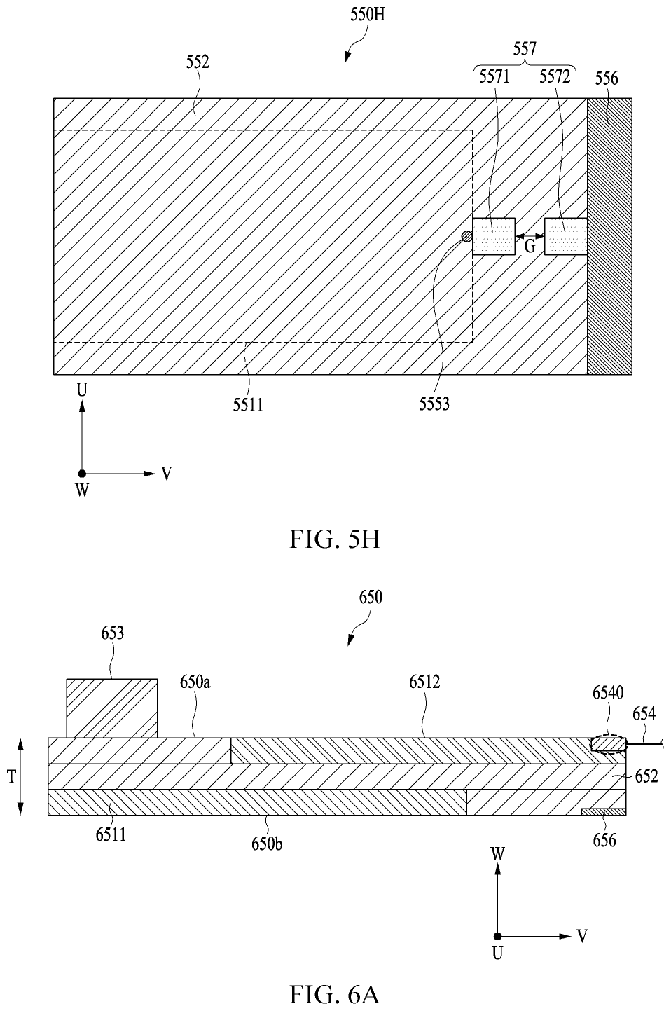

FIG. 5A is a cross-sectional view of a PCB according to an embodiment of the present disclosure. FIG. 5B is a partial cross-sectional view of a PCB, illustrating area A of FIG. 5A. FIG. 5C is a partial perspective view of a PCB, illustrating area A of FIG. 5A. FIG. 5D is a partial top view of a PCB, illustrating a discharge inductive portion, according to an embodiment of the present disclosure. FIG. 5E is a partial top view of a PCB, illustrating a discharge inductive portion, according to an embodiment of the present disclosure. FIG. 5F is a partial top view of a PCB, illustrating a discharge inductive portion, according to an embodiment of the present disclosure. FIG. 5G is a partial top view of a PCB, illustrating a discharge inductive portion, according to an embodiment of the present disclosure. FIG. 5H is a partial top view of a PCB, illustrating a discharge inductive portion, according to an embodiment of the present disclosure.

Referring to FIGS. 5A through 5C, according to an embodiment, a plurality of coupling pads 551 may be formed on a portion of a PCB 550. For example, as shown in FIG. 5A, the coupling pads 551 may be disposed at an edge of the PCB 550 adjacent to a side member (e.g., the side member 440 in FIG. 4A) of an electronic device (e.g., the electronic device 401 in FIG. 4A), for example, an edge area of the PCB 550 adjacent to a conductive portion (e.g., the conductive portions 4411 in FIG. 4A). Although FIG. 5A shows a coupled feeding structure formed by the coupling pads 551 in an area indicated as A, this is provided only for ease of description, and it is to be noted that the coupled feeding structure may be formed in various areas of the PCB 550 connected to conductive portions of the side member. Hereinafter, embodiments will be described based on the coupled feeding structure formed in a portion of the PCB 550.

FIGS. 5A through 5H schematically illustrate a portion of the PCB 550 in which the coupling pads 551 are formed. Referring to FIGS. 5A through 5H, according to an embodiment, the PCB 550 (e.g., the PCB 450 in FIG. 4A) may include an electrical connection member 553, a signal line 554 connected to a wireless communication circuit (e.g., the wireless communication circuit 490 in FIG. 4A), a plurality of coupling pads 551, a dielectric 552, a plurality of conductive vias 5551 and 5552, a ground 556, and a discharge inductive portion 557.

In an embodiment, the PCB 550 may include a first board surface 550a and a second board surface 550b opposite the first board surface 550a. The first board surface 550a and the second board surface 550b may form both outer surfaces exposed to the outside of the PCB 550. In addition, additional layers may be disposed on at least a portion of the first board surface 550a and the second board surface 550b of the PCB 550. For example, on the outer surfaces of the first board surface 550a and the second board surface 550b of the PCB 550, additional structures, such as, for example, a protective layer (e.g., a dielectric layer formed with the dielectric 552), a conductive layer for a signal delivery (or transfer), or a shield can for protecting elements disposed on the first board surface 550a or the second board surface 550b, may be disposed. Hereinafter, although the first board surface 550a and the second board surface 550b of the PCB 550 are described as forming the surface exposed to the outside of the PCB 550 for ease of description, it is to be noted that, even though not described separately, additional layers and/or structures may be disposed on at least a portion of the first board surface 550a and the second board surface 550b of the PCB 550, and the same description may apply to other embodiments.

In an embodiment, the PCB 550 may be formed in a multi-layer structure. For example, the PCB 550 may be formed in a multi-layer structure with the coupling pads 551 and the dielectric 552 alternately overlapping. In an embodiment, at least one coupling pad 551 and the dielectric 552 may be disposed on substantially the same plane, forming a single layer, in the PCB 550.

In an embodiment, the electrical connection member 553 may be disposed on one side of the PCB 550, for example, the first board surface 550a or the second board surface 550b. The electrical connection member 553 may be electrically connected to a conductive portion (e.g., the conductive portions 4411 in FIG. 4A) of the side member.

In an embodiment, the signal line 554 may be connected to the wireless communication circuit. Although the signal line 554 is shown in FIG. 5A as being disposed on the first board surface 550a of the PCB 550 for ease of description, it is to be noted that the position of the signal line 554 on the PCB 550, its arrangement relationship with other components, or its shape are not limited thereto.

In an embodiment, the plurality of coupling pads 551 may be disposed separately from each other on the PCB 550. At least some (e.g., 5511-1, 5511-2, 5512-1, and 5512-2) of the plurality of coupling pads 551 may have different positions in a first direction T (e.g., in a W-axis direction in FIG. 5B) of the PCB 550. For example, the plurality of coupling pads 551 may be disposed separately along the first direction T of the PCB 550. In an embodiment, the first direction T of the PCB 550 may refer to a direction in which a plurality of layers of the PCB 550 are stacked. Hereinafter, unless otherwise stated, the first direction T is to be construed as indicating a stacking direction (e.g., a thickness direction) of the plurality of layers of the PCB. In an embodiment, the dielectric 552 may be disposed between the plurality of coupling pads 551. Each of the plurality of coupling pads 551 may be electrically insulted through the dielectric 552. In an embodiment, the plurality of coupling pads 551 may include a plurality of first coupling pads 5511 and a plurality of second coupling pads 5512.

In an embodiment, the plurality of first coupling pads 5511 may be electrically connected to each other. The plurality of first coupling pads 5511 may be electrically connected to the electrical connection member 553. For example, the first coupling pads 5511 may be in direct contact with the electrical connection member 553 or may be connected to the electrical connection member 553 via a separate conductive connection line (e.g., 5511) or conductive via (e.g., 555). For example, the conductive via may be a structure in which a via hole is at least partially filled with a conductive material. For example, the plurality of first coupling pads 5511 may form an electrical path through which electrical signals flow with the electrical connection member 553. The first coupling pads 5511 may function as a feeding pad that forms an electrical path for applying electrical signals to a conductive portion (e.g., the conductive portions 4411 in FIG. 4A) via the electrical connection member 553 or for receiving electrical signals directly from the conductive portion.

In an embodiment, the first coupling pads 5511 may include a 1-1 coupling pad 5511-1 and a 1-2 coupling pad 5511-2 disposed separately along the first direction T of the PCB 550. However, the number of first coupling pads 5511 is not limited thereto, and a single coupling pad may be provided unlike what is shown.

In an embodiment, the plurality of second coupling pads 5512 may be electrically connected to each other. The plurality of second coupling pads 5512 may be electrically insulated from the first coupling pads 5511 on the PCB 550. In an embodiment, the plurality of second coupling pads 5512 may be electrically connected to the signal line 554 connected to the wireless communication circuit. For example, the second coupling pads 5512 may be in direct contact with the signal line 554 or may be connected to the signal line 554 connected to the wireless communication circuit via a separate conductive connection line or a second conductive via 5552. For example, the plurality of second coupling pads 5512 may form an electrical path through which electrical signals flow with the wireless communication circuit via the signal line 554. In an embodiment, the second coupling pads 5512 may function as a signal deliver pad that forms an electrical path for receiving electrical signals from the wireless communication circuit via the signal line 554 or for delivering (or transferring) electrical signals to the wireless communication circuit via the signal line 554.

In an embodiment, the second coupling pads 5512 may include a 2-1 coupling pad 5512-1 and a 2-2 coupling pad 5512-2 disposed separately along the first direction T of the PCB 550. However, the number of second coupling pads 5512 is not limited thereto.

In an embodiment, the first coupling pads 5511 and the second coupling pads 5512 may transfer electrical signals in a non-contact manner. For example, the first coupling pads 5511 and the second coupling pads 5512 may be disposed to at least partially overlap, with the PCB 550 viewed in one direction, and may form a capacitance therebetween for an indirect electrical signal delivery (or transfer). In an embodiment, the capacitance formed between the first coupling pads 5511 and the second coupling pads 5512 may be determined by a factor, such as, for example, a spacing or distance between a first coupling pad 5511 and a second coupling pad 5512, an overlap area therebetween, or a dielectric constant of the dielectric 552. Depending on the capacitance formed between the plurality of coupling pads 551 disposed on the PCB 550, an impedance of an electrical signal applied to a corresponding conductive portion (e.g., the conductive portions 4411 in FIG. 4A) may be determined.

In an embodiment, with the PCB 550 viewed in the first direction T, at least one second coupling pad 5512 may be disposed overlappingly between at least one pair of first coupling pads 5511. For example, relative to the first direction T of the PCB 550, the 2-1 coupling pad 5512-1 may be disposed between the 1-1 coupling pad 5511-1 and the 1-2 coupling pad 5511-2.

In an embodiment, the plurality of first coupling pads 5511 and the plurality of second coupling pads 5512 may be disposed alternately along the first direction T of the PCB 550. For example, the 1-1 coupling pad 5511-1, the 2-1 coupling pad 5512-1, the 1-2 coupling pad 5511-2, and the 2-2 coupling pad 5512-2 may be alternately disposed along the first direction T of the PCB 550. In an embodiment, the plurality of first coupling pads 5511 and the plurality of second coupling pads 5512 may at least partially overlap each other along the first direction T of the PCB 550.

In an embodiment, with the PCB 550 viewed in the first direction T, the plurality of coupling pads 551 may be disposed such that overlap areas A between adjacent first coupling pads 5511 and second coupling pads 5512 are substantially the same. For example, as shown in FIG. 5B, relative to the first direction T of the PCB 550, an overlap area A between the 1-1 coupling pad 5511-1 and the 2-1 coupling pad 5512-1, an overlap area A between the 1-1 coupling pad 5511-1 and the 2-2 coupling pad 5512-2, and an overlap area A between the 1-2 coupling pad 5511-2 and the 2-2 coupling pad 5512-2 may be substantially the same. However, it is to be noted that an arrangement of the plurality of coupling pads 551 is not limited thereto, and an overlap area between adjacent coupling pads may be set differently depending on the design.

In an embodiment, in a case where two first coupling pads 5511 and two second coupling pads 5512 are alternately disposed overlappingly along the first direction T of the PCB 550, as shown in FIG. 5B, a total capacitance formed by the plurality of coupling pads 551 may be determined by respective capacitances formed between the 1-1 coupling pad 5511-1 and the 2-1 coupling pad 5512-1, between the 1-1 coupling pad 5511-1 and the 2-2 coupling pad 5512-2, and between the 2-2 coupling pad 5512-2 and the 1-2 coupling pad 5511-2. For example, the total capacitance formed by the plurality of coupling pads 551 may be greater than or equal to a sum of the respective capacitances formed between the plurality of first coupling pads 5511 and the plurality of second coupling pads 5512 disposed adjacent to each other. In an embodiment, the total capacitance formed through an overlap area of the plurality of first coupling pads 5511 and the plurality of second coupling pads 5512 may be set according to a target capacitance. The total capacitance formed through the plurality of coupling pads 551 on the PCB 550 may be determined by the type of dielectric, the thickness of the dielectric, the distance between coupling pads, the overlap area between the coupling pads, or the like. The respective capacitances for an indirect electrical signal delivery (or transfer) may be formed between the first coupling pads 5511 and the second coupling pads 5512 that are adjacent to each other, and a total sum of the respective capacitances formed on the PCB 550, i.e., the total capacitance, may be approximately 10 picofarads (pF) or greater. However, the sum is not limited thereto.

In an embodiment, the plurality of conductive vias 5551 and 5552 may penetrate the PCB 550 in the first direction T, and electrically connect at least some (e.g., 5511 and 5512) of the plurality of coupling pads 551 that are disposed separately from each other. In an embodiment, the plurality of conductive vias 5551 and 5552 may connect the plurality of first coupling pads 5511 and the plurality of second coupling pads 5512, respectively. For example, the plurality of conductive vias 5551 and 5552 may include at least one first conductive via 5551 connected to the plurality of first coupling pads 5511 and electrically connecting the plurality of first coupling pads 5511, and at least one second conductive via 5552 connected to the plurality of second coupling pads 5512 and electrically connecting the plurality of second coupling pads 5512. The first conductive via 5551 and the second conductive via 5552 may be electrically insulated from each other. For example, the plurality of conductive vias 5551 and 5552 may not directly connect the first coupling pads 5511 and the second coupling pads 5512.

In an embodiment, the at least one first conductive via 5551 may electrically connect the plurality of first coupling pads 5511 along the first direction T of the PCB 550. For example, the first conductive via 5551 may form an electrical path between the plurality of first coupling pads 5511. In an embodiment, the first conductive via 5551 may be provided as a plurality of first conductive vias on the PCB 550, with each first conductive via be disposed between a pair of first coupling pads 5511 adjacent to each other. In an embodiment, one first conductive via 5551 may be disposed to penetrate the PCB 550 in the first direction T to connect, all at once, the plurality of first coupling pads 5511 spaced apart in the first direction T of the PCB 550. In an embodiment, in a case where the first coupling pads 5511 and the electrical connection member 553 are disposed to be separated on the PCB 550, the first conductive via 5551 may electrically connect at least one first coupling pad 5511 and the electrical connection member 553, thereby forming an electrical path between the electrical connection member 553 and the first coupling pads 5511.

In an embodiment, the at least one second conductive via 5552 may electrically connect the plurality of second coupling pads 5512 along the first direction T of the PCB 550. For example, the second conductive via 5552 may form an electrical path between the plurality of second coupling pads 5512. In an embodiment, the second conductive via 5552 may be provided as a plurality of second conductive vias on the PCB 550, with each second conductive via be disposed between a pair of second coupling pads 5512 adjacent to each other. In an embodiment, one second conductive via 5552 may be disposed to penetrate the PCB 550 in the first direction T to connect, all at once, the plurality of second coupling pads 5512 spaced apart in the first direction T of the PCB 550. In an embodiment, in a case where the second coupling pads 5512 and the signal line 554 connected to the wireless communication circuit are disposed to be separated on the PCB 550, the second conductive via 5552 may electrically connect at least one second coupling pad 5512 and the signal line 554, thereby forming an electrical path between the second coupling pads 5512 and the wireless communication circuit.

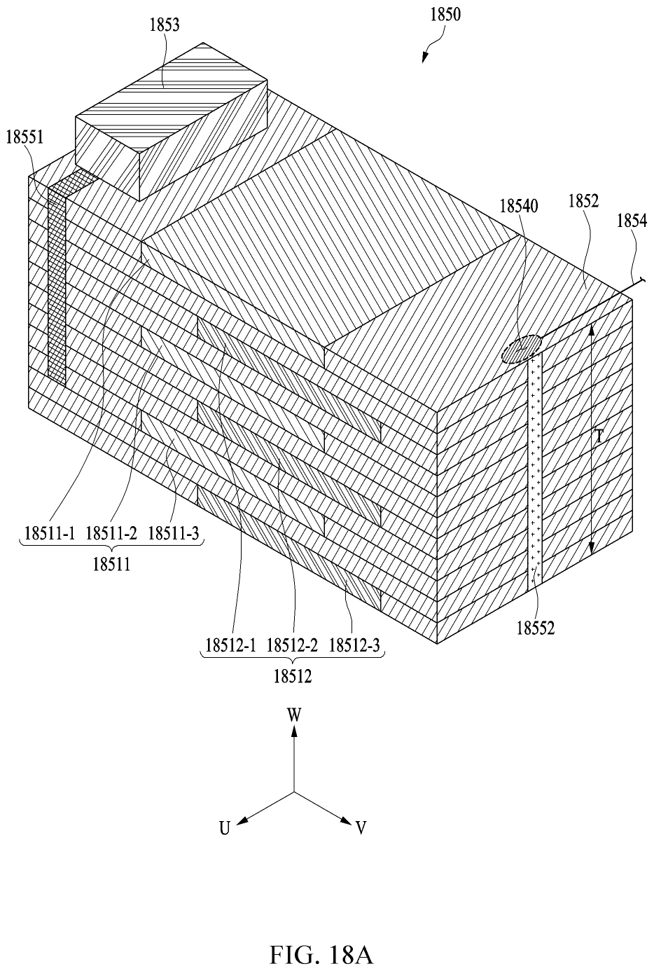

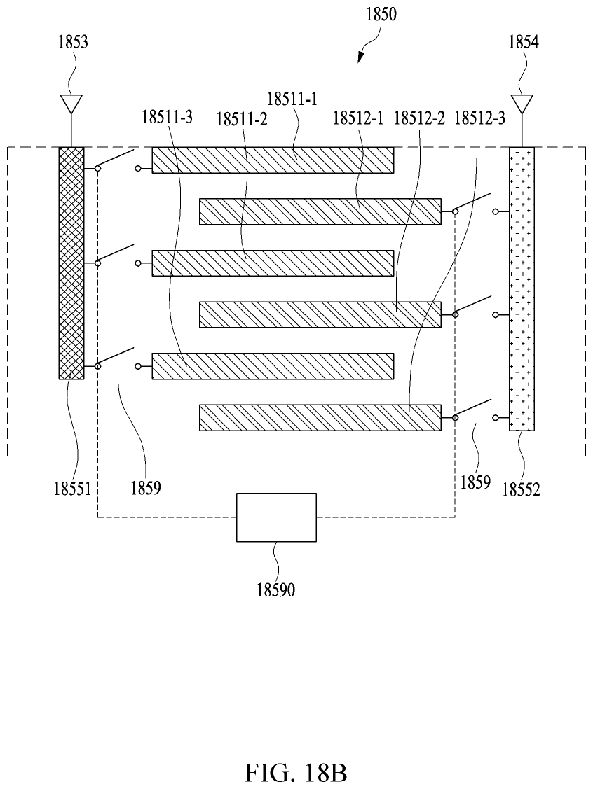

In an embodiment, a switch (e.g., a switch 1859 in FIG. 18B) may be disposed between at least one of the plurality of conductive vias 5551 and 5552 and the first coupling pad 5511 or the second coupling pad 5512 to selectively block an electrical signal connection path formed through the conductive via. For example, the switch may be disposed on at least one layer of the PCB 550 on which the first coupling pads 5511 or the second coupling pads 5512 are disposed, which will be described in more detail below.

In an embodiment, the ground 556 may be disposed on the PCB 550 and form a path through which electrostatic or noise signals introduced into the PCB 550 escape. For example, the ground 556 may allow introduced electrical signals to move through another electrical structure to prevent or reduce the electrical signals such as the electrostatic or noise signals from being introduced to components disposed on the PCB 550. For example, the ground 556 may be connected to another ground of the electronic device. In an embodiment, the ground 556 may be disposed on the PCB 550 such that it is separately disposed from the plurality of coupling pads 551. In an embodiment, the ground 556 may be disposed on an exposed surface (e.g., the second board surface 550b in FIG. 5C) of the PCB 550 to contact the other structures of the electronic device, but the position of the ground 556 on the PCB 550 is not limited thereto. In an embodiment, the ground 556 may receive electrical signals such as electrostatic or noise signals from the first coupling pads 5511 and release them to the outside of the PCB 550.

In an embodiment, at least one first coupling pad 5511 among the plurality of first coupling pads 5511 may be disposed adjacent to the ground 556. For example, relative to the first direction T of the PCB 550, one first coupling pad 5511 may be disposed on the same layer as the ground 556 to form a gap adjacent to the ground 556. For example, as shown in FIG. 5D, one first coupling pad 5511D and the ground 556 may be disposed on the second board surface 550b of the PCB 550, and the ground 556 may receive electrostatic or noise signals introduced into the PCB 550 from a conductive portion via the first coupling pad 5511D disposed adjacent thereto. However, this is provided only as an example, and it may not be required that the ground 556 and the first coupling pad 5511 are necessarily disposed on the same layer of the PCB 550. For example, as shown in FIG. 5G, the ground 556 may be disposed adjacent to the first conductive via 5551 connected to the first coupling pads 5511 and may receive electrostatic or noise signals introduced into the PCB 550 from the conductive portion via the adjacently disposed first conductive via 5551. In an embodiment, in a case where the ground 556 is disposed on the first board surface 550a of the PCB 550, the ground 556 may receive electrostatic or noise signals via the first coupling pads 5511 disposed on the first board surface 550a or via the first conductive via 5551 connected to the first coupling pads 5511. In an embodiment, it may be desirable that the ground 556 is disposed on the first board surface 550a or the second board surface 550b of the PCB 550, but it is to be noted that an arrangement position of the ground 556 on the PCB 550 is not limited thereto and may change depending on the design of the PCB 550.

In an embodiment, a discharge inductive portion (e.g., 557D, 557E, 557F, 557G, and 557H) may induce a movement for an electrical signal discharge from the first coupling pads 5511 to the ground 556. In an embodiment, the discharge inductive portion (e.g., 557D, 557E, 557F, 557G, and 557H) may function as a lightning rod that induces a movement of electrical signals from the first coupling pads 5511 to the ground 556 by narrowing a gap between the ground 556 and one (e.g., the 1-2 coupling pad 5511-2) of the first coupling pads 5511. For example, the discharge inductive portion (e.g., 557D, 557E, 557F, 557G, and 557H) may induce the movement of electrical signals between the ground 556 and the first coupling pad 5511 disposed adjacent to the ground 556 for discharge of the electrical signals.

In an embodiment, the discharge inductive portion (e.g., 557D, 557E, 557F, 557G, and 557H) may include one or more discharge members 5571 and 5572 for narrowing the gap between the first coupling pad 5511 and the ground 556. For example, the discharge members 5571 and 5572 may be formed of a conductive material. The discharge members 5571 and 5572 may narrow, by a certain gap G, the gap (or distance) between the first coupling pad 5511 and the ground 556 through which an electrical signal moves for discharge, for example, through which the electrical signal moves via the dielectric 552. In an embodiment, the gap G may be approximately 200 micrometers (μm) or less but is not limited thereto.

Referring to FIG. 5D, according to an embodiment, a discharge inductive portion 557D in a PCB 550D may include a first discharge member 5571 that is connected to one first coupling pad 5511D of the first coupling pads 5511 and extends protrusively in a direction toward the ground 556 (e.g., in a +V direction in FIG. 5D). In an embodiment, the discharge inductive portion 557D may be separately formed of the same or different material as or from the first coupling pads 5511 and connected to the first coupling pad 5511D, but may also be a protrusion formed as a portion of the first coupling pad 5511D protrudes toward the ground 556. In an embodiment, between the first discharge member 5571 and the ground 556, a gap G may be formed in which the dielectric 552 is disposed.

Referring to FIG. 5E, according to an embodiment, a discharge inductive portion 557E in a PCB 550E may include a second discharge member 5572 that is connected to the ground 556 and extends protrusively in a direction toward one first coupling pad 5511E of the first coupling pads 5511 (e.g., in a −V direction in FIG. 5E). In an embodiment, the second discharge member 5572 may be separately formed of the same or different material as or from the ground 556 and connected to the ground 556, but may also be a protrusion formed as a portion of the ground 556 protrudes toward the first coupling pad 5511E. In an embodiment, between the second discharge member 5572 and the ground 556, a gap G may be formed in which the dielectric 552 is disposed.

Referring to FIG. 5F, according to an embodiment, a discharge inductive portion 557F in a PCB 550F may include a first discharge member 5571 and a second discharge member 5572 that are connected to one first coupling pad 5511F of the first coupling pads 5511 and to the ground 556, respectively, and extend in a direction toward each other (e.g., in a V-axis direction in FIG. 5F). In an embodiment, the first discharge member 5571 may be separately formed of the same or different material as or from the first coupling pad 5511F and connected to the first coupling pad 5511F, but may also be a protrusion formed as a portion of the first coupling pad 5511F protrudes toward the ground 556. In an embodiment, the second discharge member 5572 may be separately formed of the same or different material as or from the ground 556 and connected to the ground 556, but may also be a protrusion formed as a portion of the ground 556 protrudes toward the first coupling pad 5511F. In an embodiment, between the first discharge member 5571 and the second discharge member 5572, a gap G may be formed in which the dielectric 552 is disposed.

Referring to FIG. 5G, according to an embodiment, a discharge inductive portion 557 in a PCB 550G may include a plurality of first discharge members 5571 and a plurality of second discharge members 5572 that are connected to one first coupling pad 5511G among the first coupling pads 5511 and to the ground 556, respectively, and extend in a direction facing each other (e.g., in a V-axis direction in FIG. 5G). For example, the plurality of first discharge members 5571 may include a 1-1 discharge member 5571-1 and a 1-2 discharge member 5571-2 connected to the first coupling pad 5511G and spaced apart from each other. The plurality of second discharge members 5572 may include a 2-1 discharge member 5572-1 and a 2-2 discharge member 5572-2 connected to the ground 556 and spaced apart from each other. In an embodiment, the 1-1 discharge member 5571-1 and the 2-1 discharge member 5572-1 may correspond to each other and form a gap G therebetween. The 1-2 discharge member 5571-2 and the 2-2 discharge member 5572-2 may correspond to each other and form a gap G therebetween. In an embodiment, the number of first discharge members 5571 and the second discharge members 5572 is not limited thereto. For example, the first discharge members 5571 and the second discharge members 5572 may be provided as three or more discharge members, respectively, and may be disposed to correspond to each other. The plurality of discharge members 5571 and 5572 may have the same length but may also have different lengths from each other. For example, the gaps G between the first discharge members 5571 and the second discharge members 5572 that correspond to each other may be constant. In an embodiment, the first discharge members 5571 may be separately formed of the same or different material as or from the first coupling pad 5511G and connected to the first coupling pad 5511G, but may also be a protrusion formed as a portion of the first coupling pad 5511G protrudes toward the ground 556. In an embodiment, the second discharge members 5572 may be separately formed of the same or different material as or from the ground 556 and connected to the ground 556, but may also be a protrusion formed as a portion of the ground 556 protrudes toward the first coupling pad 5511G.

Referring to FIG. 5H, according to an embodiment, a discharge inductive portion 557H in a PCB 550H may include a first discharge member 5571 that is connected to a conductive via 5553 connected to a first coupling pad 5511. The first discharge member 5571 may be formed in a different layer from the first coupling pad 5511 and connected to the first coupling pad 5511 through the conductive via 5553. The first discharge member 5571 may extend in a direction toward the ground 556 (e.g., in a +V direction in FIG. 5G). In an embodiment, the discharge inductive portion 557 may include a second discharge member 5572 that is connected to the ground 556 and extends in a direction toward the first discharge member 5571. The second discharge member 5572 may be separately formed of the same or different material as or from the ground 556 and connected to the ground 556, but may also be a protrusion formed as a portion of the ground 556 protrudes toward the first coupling pad 5511. In an embodiment, a gap G may be formed between the first discharge member 5571 and the second discharge member 5572, in which the dielectric 552 is disposed.

In an embodiment, the PCB 550 may use a coupling connection structure (or a coupled feeding structure herein) between the first coupling pads 5511 and the second coupling pads 5512 to form an indirect signal deliver path between the electrical connection member 553 connected to a conductive portion and the signal line 554 connected to the wireless communication circuit. Such an indirect signal delivery through the first coupling pads 5511 and the second coupling pads 5512 may prevent a direct connection between the electrical connection member 553 and the wireless communication circuit on the PCB 550, which may prevent or reduce a phenomenon where electrostatic or noise signals introduced into the PCB 550 through a conductive portion is transferred to the wireless communication circuit. In an embodiment, the electrostatic or noise signals introduced into the PCB 550 through the conductive portion may be induced to be transferred from the first coupling pads 5511 to the ground 556 through the discharge inductive portion (e.g., 557D, 557E, 557F, 557G, and 557H), and thus the electrostatic or noise signals introduced into the PCB 550 may be effectively released to the outside of the PCB 550.

Hereinafter, the description of the ground 556 and the discharge inductive portion (e.g., 557D, 557E, 557F, 557G, and 557H) will be omitted from certain embodiments for ease of description, but it will be apparent to those of ordinary skill in the art that the configurations of the ground 556 and the discharge inductive portion (e.g., 557D, 557E, 557F, 557G, and 557H) described above with reference to FIGS. 5D through 5G may be applicable to other embodiments. For example, even though separate descriptions and indications in the drawings are omitted, embodiments of a PCB including a coupled feeding structure should be construed as including the configurations of a ground and a discharge inductive portion described above, unless otherwise stated that such configurations are excluded.

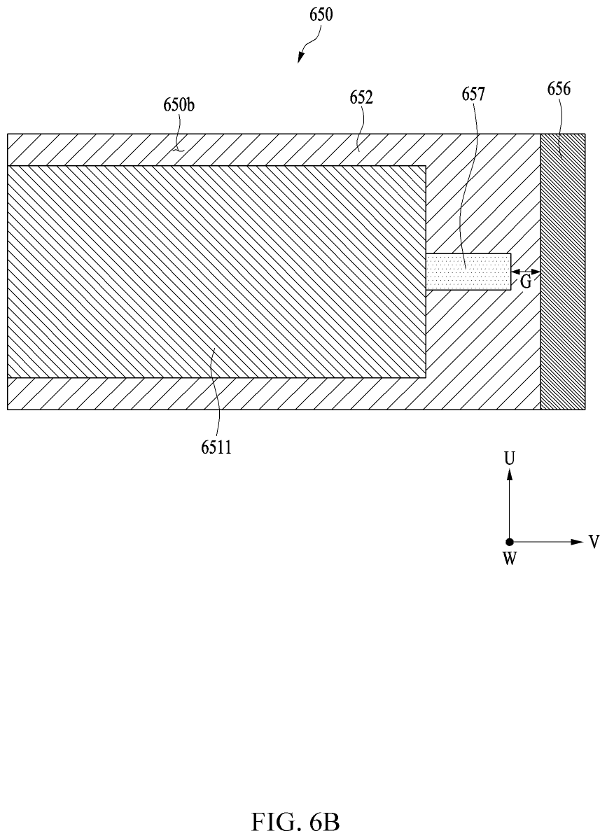

FIG. 6A is a partial cross-sectional view of a PCB according to an embodiment of the present disclosure. FIG. 6B is a partial top view of a PCB, illustrating a discharge inductive portion, according to an embodiment of the present disclosure.

Referring to FIGS. 6A and 6B, according to an embodiment, a PCB 650 may include a first coupling pad 6511, a second coupling pad 6512 disposed separately from the first coupling pad 6511, a dielectric 652 electrically insulating the first coupling pad 6511 and the second coupling pad 6512, an electrical connection member 653 connected to the first coupling pad 6511 to form an electrical path therewith and connected to a conductive portion (e.g., the conductive portions 4411 in FIG. 4A) of a side member, a signal line 654 connected to the second coupling pad 6512 to form an electrical path therewith and connected to a wireless communication circuit (e.g., the wireless communication circuit 490 in FIG. 4A), and a ground 656.

In an embodiment, the first coupling pad 6511 and the second coupling pad 6512 may be disposed separately to overlap along a first direction T of the PCB 650. A capacitance for an indirect signal delivery may be formed between the first coupling pad 6511 and the second coupling pad 6512.

In an embodiment, the electrical connection member 653 may be disposed to be in contact with the first coupling pad 6511, but may be connected thereto through a conductive connection line such as a conductive via (e.g., the first conductive vias 5551 in FIG. 5A). In an embodiment, the electrical connection member 653 may be disposed on a surface of the PCB 650, for example, a first board surface 650a of the PCB 650. In an embodiment, the signal line 654 may be directly connected to the second coupling pad 6512, but may also be connected to the second coupling pad 6512 through a conductive connection line such as a conductive via (e.g., the second conductive vias 5552 in FIG. 5A). In an embodiment, the signal line 654 may be separately formed of the same or different material as or from the second coupling pad 6512 to be connected to the second coupling pad 6512, or may be integrally formed with the second coupling pad 6512 to extend from the second coupling pad 6512.

In an embodiment, the ground 656 may be disposed on the PCB 650 such that it is separated from the first coupling pad 6511 and the second coupling pad 6512. For example, the dielectric 652 may be disposed between the ground 656 and the coupling pads to prevent a direct connection between the ground 656 and the coupling pads. In an embodiment, the ground 656 may be disposed on a surface of the PCB 650, for example, a second board surface 650b of the PCB 650, such that it is connected to another structure outside the PCB 650. In an embodiment, the ground 656 may be disposed on substantially the same plane (i.e., substantially the same layer) with the first coupling pad 6511, relative to a first direction T of the PCB 650.

In an embodiment, a discharge inductive portion 657 may be disposed between the ground 656 and the first coupling pad 6511 to induce a delivery or transfer of electrical signals such as electrostatic or noise signals. The discharge inductive portion 657 may be connected to the ground 656 or to any one of first coupling pads 6511 disposed adjacent to the ground 656, thereby narrowing a gap between the first coupling pad 6511 and ground 656. For example, in a case where the discharge inductive portion 657 is connected to the first coupling pad 6511 to protrude toward the ground 656 as shown in FIG. 6B, a gap G may be formed between the discharge inductive portion 657 and the ground 656, in which the dielectric 652 is disposed.

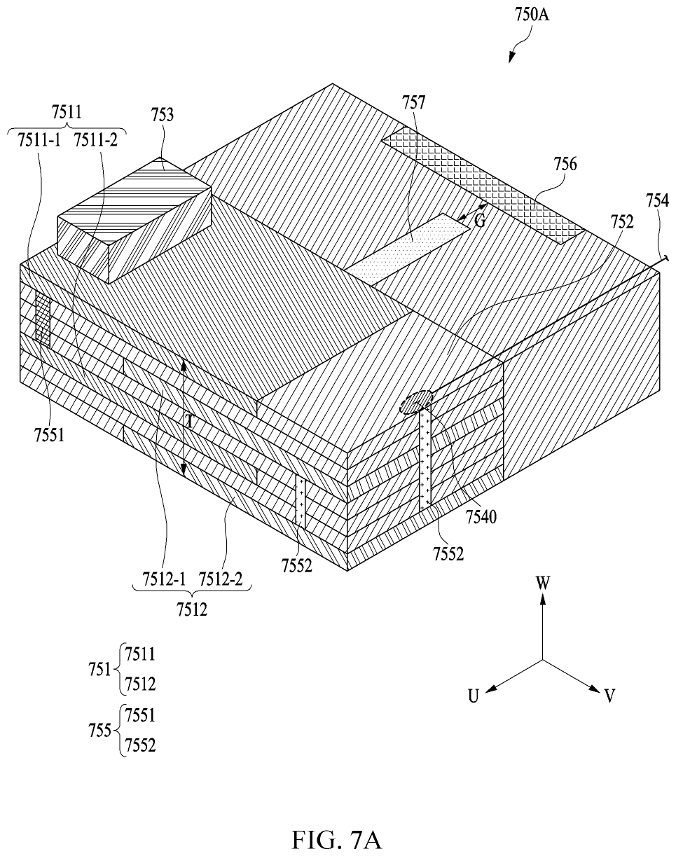

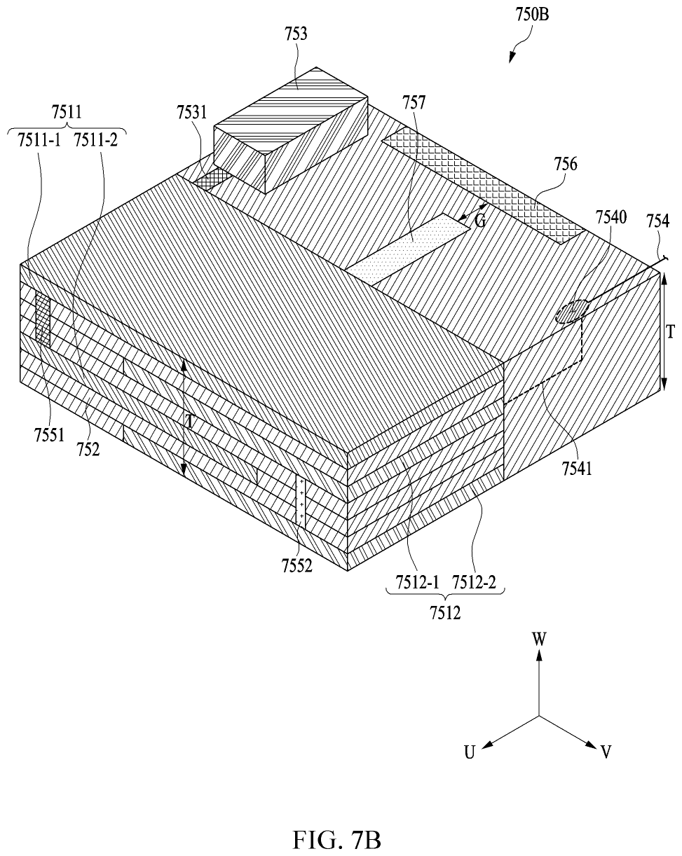

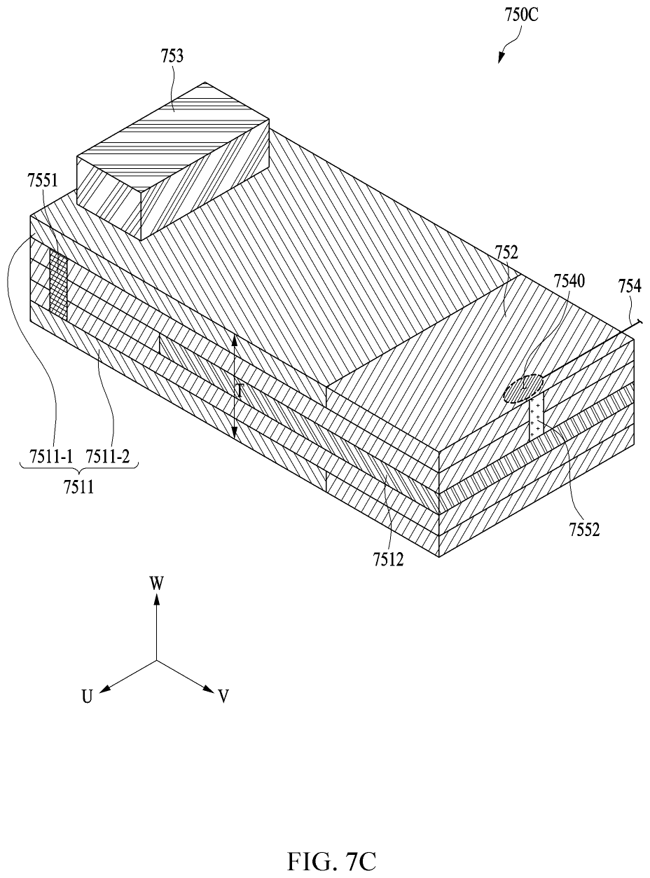

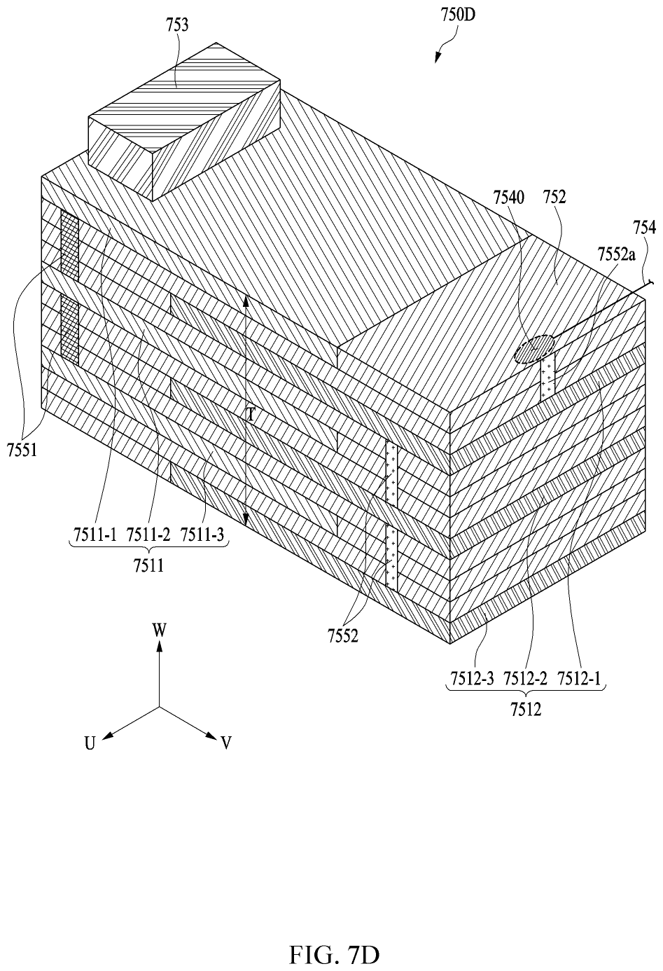

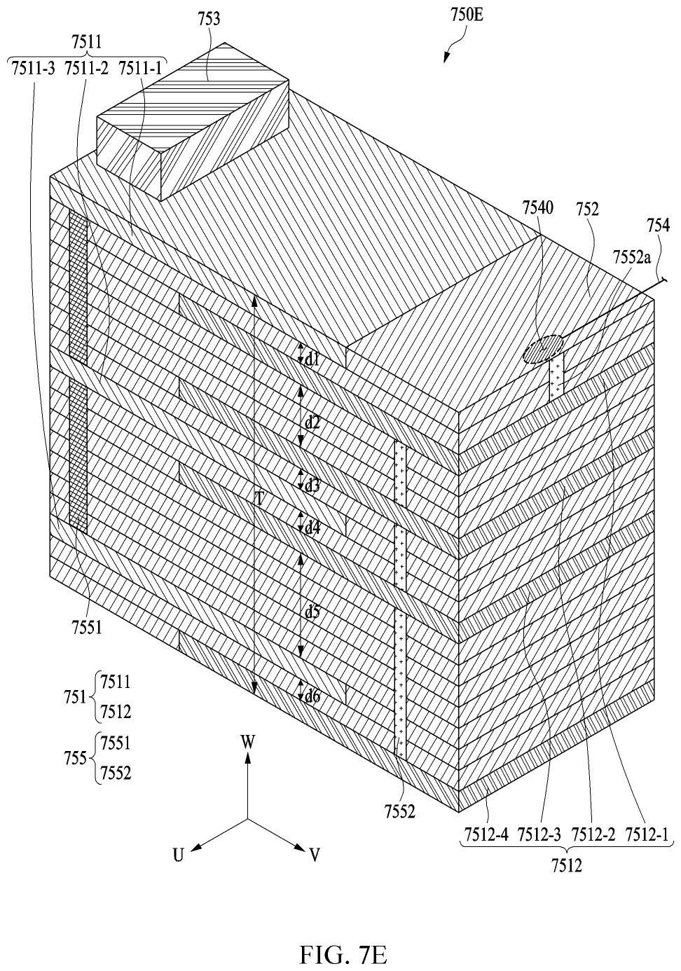

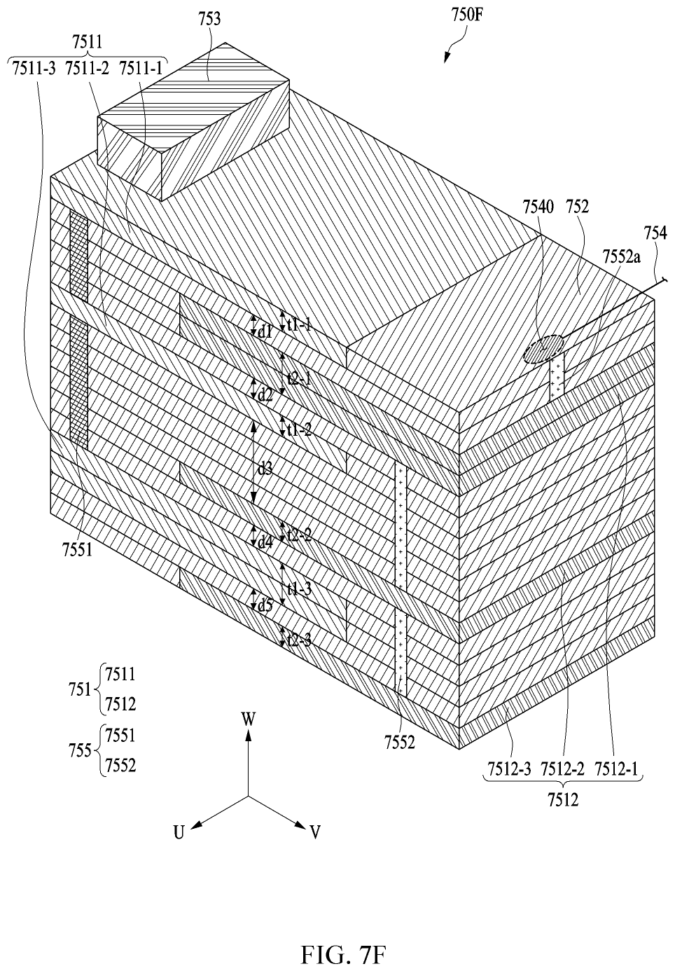

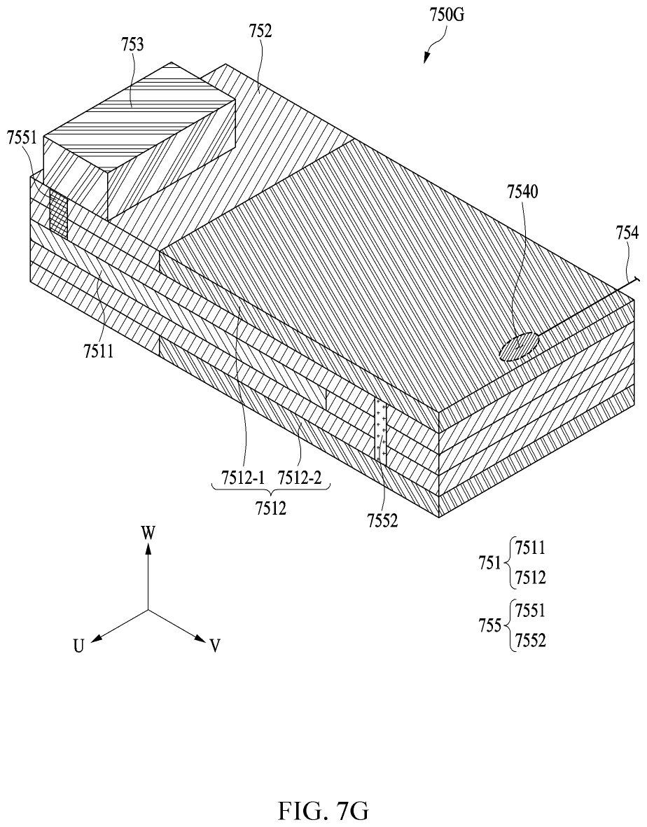

FIG. 7A is a partial perspective view of a PCB according to an embodiment of the present disclosure. FIG. 7B is a partial perspective view of a PCB according to an embodiment of the present disclosure. FIG. 7C is a partial perspective view of a PCB according to an embodiment of the present disclosure. FIG. 7D is a partial perspective view of a PCB according to an embodiment of the present disclosure. FIG. 7E is a partial perspective view of a PCB according to an embodiment of the present disclosure. FIG. 7F is a partial perspective view of a PCB according to an embodiment of the present disclosure. FIG. 7G is a partial perspective view of a PCB according to an embodiment of the present disclosure. FIGS. 7A through 7F illustrate a partial area of a PCB in which a coupled feeding structure is formed, and various embodiments of the PCB will be described with reference to respective drawings.

Referring to FIG. 7A, according to an embodiment, a PCB 750A (e.g., the PCB 450 in FIG. 4A) may include a plurality of coupling pads 751 (e.g., the coupling pads 451 in FIG. 4A) disposed separately to be electrically insulated through a dielectric 752, an electrical connection member 753 (e.g., the electrical connection member 453 in FIG. 4A), a signal line 754 connected to a wireless communication circuit (e.g., the wireless communication circuit 490 in FIG. 4A), a plurality of conductive vias 755, a ground 756, and/or a discharge inductive portion 757.

In an embodiment, the plurality of coupling pads 751 may include a plurality of first coupling pads 7511 connected to the electrical connection member 753 to form an electrical path, and a plurality of second coupling pads 7512 connected to the wireless communication circuit via the signal line 754 to form an electrical path. For example, the first coupling pads 7511 may include a 1-1 coupling pad 7511-1 and/or a 1-2 coupling pad 7511-2, and the second coupling pads 7512 may include a 2-1 coupling pad 7512-1 and/or a 2-2 coupling pad 7512-2. In an embodiment, relative to a first direction T of the PCB 750A, at least one of the second coupling pads 7512 may be disposed between a pair of first coupling pads 7511. For example, the 2-1 coupling pad 7512-1 may be disposed overlappingly between the 1-1 coupling pad 7511-1 and the 1-2 coupling pad 7511-2. In an embodiment, the plurality of first coupling pads 7511 and the plurality of second coupling pads 7512 may be alternately and overlappingly disposed along the first direction T (e.g., a W-axis direction in FIG. 7A) of the PCB 750A. For example, along the first direction T of the PCB 750A, the 1-1 coupling pad 7511-1, the 2-1 coupling pad 7512-1, the 1-2 coupling pad 7511-2, and the 2-2 coupling pad 7512-2 may be alternately and overlappingly disposed.

In an embodiment, the plurality of conductive vias 755 may be disposed to penetrate the PCB 750A in the first direction T. For example, the plurality of conductive vias 755 may include at least one first conductive via 7551 electrically connecting the first coupling pads 7511 and at least one second conductive via 7552 electrically connecting the second coupling pads 7512. In an embodiment, the at least one second conductive via 7552 may connect the second coupling pads 7512 and the signal line 754 connected to the wireless communication circuit.

In an embodiment, the ground 756 may be disposed on a surface of the PCB 750A. In an embodiment, the ground 756 may be disposed separately on the PCB 750 while electrically insulated from the plurality of coupling pads 751 via the dielectric 752. In an embodiment, relative to the first direction T of the PCB 750A, the ground 756 may be disposed on the same layer (e.g., the same plane) as at least one first coupling pad 7511 among the plurality of first coupling pads 7511. For example, the ground 756 may be disposed on the same plane as the 1-1 coupling pad 7511-1. In an embodiment, the discharge inductive portion 757 may be disposed between the 1-1 coupling pad 7511-1 and the ground 756 to induce a delivery (or transfer) of electrical signals such as electrostatic or noise signals from the 1-1 coupling pad 7511-1 toward the ground 756. For example, the discharge inductive portion 757 may be separately formed from the same or different material as or from the 1-1 coupling pad 7511-1 to be connected to the 1-1 coupling pad 7511-1, or may be a protrusion formed as a portion of the 1-1 coupling pad 7511-1 protrudes toward the ground 756.

When the discharge inductive portion 757 extends from the first coupling pads 7511 toward the ground 756, a gap G may be formed between the discharge inductive portion 757 and the ground 756, in which the dielectric 752 is disposed.

Referring to FIG. 7B, according to an embodiment, a PCB 750B (e.g., the PCB 450 in FIG. 4A) may include a plurality of coupling pads 751 (e.g., the coupling pads 451 in FIG. 4A) disposed separately to be electrically insulated via a dielectric 752, an electrical connection member 753 (e.g., the electrical connection member 453 in FIG. 4A), a signal line 754 connected to a wireless communication circuit (e.g., the wireless communication circuit 490 in FIG. 4A), a plurality of conductive vias 755, a ground 756, and/or a discharge inductive portion 757 for reducing a gap G between the ground 756 and a first coupling pad 7511.

In an embodiment, the plurality of coupling pads 751 may include a plurality of first coupling pads 7511 electrically connected through at least one first conductive via 7551, and a plurality of second coupling pads 7512 electrically connected through at least one second conductive via 7552. The first coupling pads 7511 may be connected to the electrical connection member 753 to form an electrical path. The second coupling pads 7512 may be connected to the signal line 754 connected to the wireless communication circuit to form an electrical path. In an embodiment, the plurality of first coupling pads 7511 may include a 1-1 coupling pad 7511-1 and/or a 1-2 coupling pad 7511-2 spaced apart along a first direction T of the PCB 750B. The plurality of second coupling pads 7512 may include a 2-1 coupling pad 7512-1 and/or a 2-2 coupling pad 7512-2 spaced apart along the first direction T of the PCB 750B. The plurality of first coupling pads 7511 and the second coupling pads 7512 may be alternately disposed along the first direction T of the PCB 750B. A first coupling pad 7511 and a second coupling pad 7512 that are adjacent to each other may at least partially overlap each other, with the PCB 750 viewed in first direction T. In an embodiment, the plurality of coupling pads 751 may transfer electrical signals in a non-contact manner through a capacitance formed in an overlap area between the first coupling pad 7511 and the second coupling pad 7512 that are disposed adjacent to each other.

In an embodiment, the electrical connection member 753 may be connected to the first coupling pads 7511 via a connection line 7531 of a conductive material. For example, the connection line 7531 may be separately formed of the same or different material as or from the first coupling pads 7511 to be connected to the first coupling pads 7511, and may also be an extension formed as a portion of the first coupling pads 7511 extends to the electrical connection member 753. The signal line 754 connected to the wireless communication circuit may be connected to the second coupling pads 7512 via a connection line 7541 of a conductive material. For example, the signal line 754 may be separately formed of the same or different material as or from the second coupling pads 7512 to be connected to the second coupling pads 7512, or may also be an extension formed as a portion of the second coupling pads 7512 extends.

Referring to FIG. 7C, according to an embodiment, a PCB 750C (e.g., the PCB 450 in FIG. 4A) may include a plurality of coupling pads 751 (e.g., the coupling pads 451 in FIG. 4A) disposed separately to be electrically insulated via a dielectric 752, an electrical connection member 753 (e.g., the electrical connection member 453 in FIG. 4A) adapted to be connected to a conductive portion (e.g., the conductive portions 4411 in FIG. 4A) of a side member, a signal line 754 connected to a wireless communication circuit (e.g., the wireless communication circuit 490 in FIG. 4A), and/or a plurality of conductive vias 755.

In an embodiment, the plurality of coupling pads 751 may include a plurality of first coupling pads 7511 electrically connected to the electrical connection member 753, and a plurality of second coupling pads 7512 electrically connected to the signal line 754. For example, the plurality of first coupling pads 7511 may include a 1-1 coupling pad 7511-1 and/or a 1-2 coupling pad 7511-2. In an embodiment, the plurality of first coupling pads 7511 may be electrically connected through a first conductive via 7551. The plurality of second coupling pads 7512 may be connected to the signal line 754 through a second conductive via 7552. In an embodiment, a second coupling pad 7512 may be disposed between the 1-1 coupling pad 7511-1 and the 1-2 coupling pad 7511-2 relative to a first direction T of the PCB 750C. A capacitance for a non-contact signal delivery (or transfer) may be formed between a second coupling pad 7512 and each first coupling pad 7511.

Referring to FIG. 7D, according to an embodiment, a PCB 750D (e.g., the PCB 450 in FIG. 4A) may include a plurality of coupling pads 751 (e.g., the coupling pads 451 in FIG. 4A) disposed separately be electrically insulated via a dielectric 752, an electrical connection member 753 (e.g., the electrical connection member 453 in FIG. 4A) adapted to be connected to a conductive portion (e.g., the conductive portions 4411 in FIG. 4A) of a side member, a signal line 754 connected to a wireless communication circuit (e.g., the wireless communication circuit 490 in FIG. 4A), and/or a plurality of conductive vias 755.

In an embodiment, the plurality of coupling pads 751 may include a plurality of first coupling pads 7511 connected to the electrical connection member 753 to form an electrical path, and a plurality of second coupling pads 7512 connected to the signal line 754 to form an electrical path. For example, the plurality of first coupling pads 7511 may include a 1-1 coupling pad 7511-1, a 1-2 coupling pad 7511-2, and/or a 1-3 coupling pad 7511-3. In an embodiment, the plurality of second coupling pads 7512 may include a 2-1 coupling pad 7512-1, a 2-2 coupling pad 7512-2, and/or a 2-3 coupling pad 7512-3. In an embodiment, at least one second coupling pad 7512 of the plurality of second coupling pads 7512 may be disposed overlappingly between a pair of first coupling pads 7511, relative to a first direction T of the PCB 750D. For example, with the PCB 750D viewed in the first direction T, the 2-1 coupling pad 7512-1 may be disposed overlappingly between the 1-1 coupling pad 7511-1 and the 1-2 coupling pad 7511-2, and the 2-2 coupling pad 7512-2 may be disposed overlappingly between the 1-2 coupling pad 7511-2 and the 1-3 coupling pad 7511-3. In an embodiment, the plurality of first coupling pads 7511 and the plurality of second coupling pads 7512 may be alternately disposed along the first direction T of the PCB 750D such that they overlap at least partially each other. For example, along the first direction T of the PCB 750D, the three first coupling pads 7511-1, 7511-2, and 7511-3 and the three second coupling pads 7512-1, 7512-2, and 7512-3 may be alternately disposed such that they overlap at least partially. In an embodiment, relative to the first direction T of the PCB 750D, a capacitance for a non-contact signal delivery may be formed between a first coupling pad 7511 and a second coupling pad 7512 that are adjacent to each other. A total capacitance formed between the plurality of coupling pads 751 may be greater than or equal to a sum of respective capacitances formed between the first coupling pads 7511 and the second coupling pads 7512 adjacent to each other.

In an embodiment, the plurality of conductive vias 755 may include a plurality of first conductive vias 7551 electrically connecting the plurality of first coupling pads 7511, and a plurality of second conductive vias 7552 electrically connecting the plurality of second coupling pads 7512. In an embodiment, the plurality of first conductive vias 7551 may electrically connect a pair of first coupling pads 7511 disposed adjacent to each other along the first direction T of the PCB 750D. For example, the first conductive vias 7551 may be disposed between the 1-1 coupling pad 7511-1 and the 1-2 coupling pad 7511-2, and between the 1-2 coupling pad 7511-2 and the 1-3 coupling pad 7511-3. In an embodiment, the plurality of second conductive vias 7552 may electrically connect a pair of second coupling pads 7512 disposed adjacent to each other along the first direction T of the PCB 750D. For example, the second conductive vias 7552 may be disposed between the 2-1 coupling pad 7512-1 and the 2-2 coupling pad 7512-2, and between the 2-2 coupling pad 7512-2 and the 2-3 coupling pad 7512-3. In an embodiment, in a case where the signal line 754 connected to the wireless communication circuit is disposed separately from the second coupling pads 7512 through the dielectric 752, at least one second connecting conductive via 7552a may electrically connect the second coupling pads 7512 and the signal line 754.

Referring to FIG. 7E, according to an embodiment, a PCB 750E (e.g., the PCB 450 in FIG. 4A) may include a plurality of coupling pads 751 (e.g., the coupling pads 451 in FIG. 4A) disposed separately to be electrically insulated via a dielectric 752, an electrical connection member 753 (e.g., the electrical connection member 453 in FIG. 4A) adapted to be connected to a conductive portion (e.g., the conductive portions 4411 in FIG. 4A) of a side member, a signal line 754 connected to a wireless communication circuit (e.g., the wireless communication circuit 490 in FIG. 4A), and/or a plurality of conductive vias 755.

In an embodiment, the plurality of coupling pads 751 may include a plurality of first coupling pads 7511 connected to the electrical connection member 753 to form an electrical path, and a plurality of second coupling pads 7512 connected to the signal line 754 to form an electrical path. In an embodiment, the plurality of second coupling pads 7512 may be connected to the signal line 754 through at least one conductive via 7522a. In an embodiment, the first coupling pads 7511 may include a 1-1 coupling pad 7511-1, a 1-2 coupling pad 7511-2, and/or a 1-3 coupling pad 7511-3. In an embodiment, the second coupling pads 7512 may include a 2-1 coupling pad 7512-1, a 2-2 coupling pad 7512-2, a 2-3 coupling pad 7512-3, and/or a 2-4 coupling pad 7512-4. In an embodiment, the plurality of first coupling pads 7511 may be electrically connected through at least one first conductive via 7551. The plurality of second coupling pads 7512 may be electrically connected through at least one second conductive via 7552.

In an embodiment, along a first direction T of the PCB 750E, the plurality of coupling pads 751 may form a plurality of coupling pad sets including at least one first coupling pad 7511 and at least one second coupling pad 7512 disposed adjacent to each other. For example, the 1-1 coupling pad 7511-1 and the 2-1 coupling pad 7512-1 may be disposed adjacent to each other to form a first coupling pad set; the 2-2 coupling pad 7512-2, the 1-2 coupling pad 7511-2, and the 2-3 coupling pad 7512-3 may form a second coupling pad set; and the 1-3 coupling pad 7511-3 and the 2-4 coupling pad 7512-4 may form a third coupling pad set.

In an embodiment, relative to the first direction T of the PCB 750E, there may be various gaps or distances (e.g., d1, d3, d4, and d6) between a first coupling pad 7511 and a second coupling pad 7512 forming one coupling pad set. For example, the distance d1 between the 1-1 coupling pad 7511-1 and the 2-1 coupling pad 7512-1 forming the first coupling pad set, the distances d3 and d4 between the 2-2 coupling pad 7512-2 and the 1-2 coupling pad 7511-2, and between the 1-2 coupling pad 7511-2 and the 2-3 coupling pad 7512-3, forming the second coupling pad set, and the distance d6 between the 1-3 coupling pad 7511-3 and the 2-4 coupling pad 7512-4 forming the third coupling pad set, may be smaller than a distance d2 between the first coupling pad set and the second coupling pad set and a distance d5 between the second coupling pad set and the third coupling pad set. In an embodiment, the distance d2 between the first coupling pad set and the second coupling pad set, and the distance d5 between the second coupling pad set and the third coupling pad set may be different from each other. In an embodiment, the distances d1, d3, d4, and d6 between the first coupling pads 7511 and the second coupling pads 7512 forming the respective coupling pad sets may be substantially the same, but examples are not limited thereto, and they may also be different from each other.

Referring to FIG. 7F, according to an embodiment, a PCB 750F (e.g., the PCB 450 in FIG. 4A) may include a plurality of coupling pads 751 (e.g., the coupling pads 451 in FIG. 4A) disposed separately to be electrically insulated via a dielectric 752, an electrical connection member 753 (e.g., the electrical connection member 453 in FIG. 4A) adapted to be connected to a conductive portion (e.g., the conductive portions 4411 in FIG. 4A) of a side member, a signal line 754 connected to a wireless communication circuit (e.g., the wireless communication circuit 490 in FIG. 4A), and/or a plurality of conductive vias 755.

In an embodiment, the plurality of coupling pads 751 may include a plurality of first coupling pads 7511 electrically connected to the electrical connection member 753, and a plurality of second coupling pads 7512 electrically connected to the signal line 754. In an embodiment, the first coupling pads 7511 may include a 1-1 coupling pad 7511-1, a 1-2 coupling pad 7511-2, and/or a 1-3 coupling pad 7511-3. The plurality of first coupling pads 7511 may be electrically connected through a first conductive via 7551. In an embodiment, the second coupling pads 7512 may include a 2-1 coupling pad 7512-1, a 2-2 coupling pad 7512-2, and a 2-3 coupling pad 7512-3. In an embodiment, the plurality of second coupling pads 7512 may be connected to the signal line 754 through at least one conductive via 7522a. In an embodiment, relative to the first direction T of the PCB 750F, at least one second coupling pad 7512 may be disposed between a pair of first coupling pads 7511. In an embodiment, the plurality of first coupling pads 7511 and the plurality of second coupling pads 7512 may be disposed alternately such that they overlap at least partially along a first direction T of the PCB 750F.

In an embodiment, along the first direction T of the PCB 750F, the plurality of coupling pads 751 may form a plurality of coupling pad sets including at least one first coupling pad 7511 and at least one second coupling pad 7512 disposed adjacent to each other. For example, the 1-1 coupling pad 7511-1, the 2-1 coupling pad 7512-1, and the 1-2 coupling pad 7511-2 may be disposed adjacent to each other to form a first coupling pad set. The 2-2 coupling pad 7512-2, the 1-3 coupling pad 7511-3, and the 2-3 coupling pad 7512-3 may be disposed adjacent to each other to form a second coupling pad set. In an embodiment, a distance (e.g., d1, d2, d4, and d5) between a first coupling pad 7511 and a second coupling pad 7512 forming one coupling set may be smaller than a distance d3 between coupling pad sets adjacent to each other.

In an embodiment, relative to the first direction T of the PCB 750F, a thickness of each of the plurality of coupling pads 751 and a distance between adjacent coupling pads, for example, a thickness of the dielectric 752 disposed between the adjacent coupling pads, may be different. For example, the 1-1 coupling pad 7511-1 and the 1-2 coupling pad 7511-2 may have a 1-1 thickness t1-1 and a 1-2 thickness t1-2, respectively, and the 2-1 coupling pad 7512-1 disposed adjacent to the 1-1 coupling pad 7511-1 and the 1-2 coupling pad 7511-2 may have a 2-1 thickness t2-1 that is greater than the 1-1 thickness t1-1 and the 1-2 thickness t1-2. For example, the 2-2 coupling pad 7512-2 and the 2-3 coupling pad 7512-3 may have a 2-2 thickness t2-2 and a 2-3 thickness t2-3, respectively, and the 1-3 coupling pad 7511-3 disposed between the 2-2 coupling pad 7512-2 and the 2-3 coupling pad 7512-3 may have a 1-3 thickness t1-3 that is greater than the 2-2 thickness t2-2 and the 2-3 thickness t2-3. For example, the thicknesses of the plurality of coupling pads 751 may be the same or at least partially different from each other, and the distances between adjacent coupling pads 7511 and 7512 may also be the same or at least partially different from each other. Depending on a difference in thickness of the coupling pads 751, a capacitance formed between adjacent coupling pads 7511 and 7512 may vary. Depending on a distance between the adjacent coupling pads 7511 and 7512, the thickness of the dielectric 752 disposed between the coupling pads 7511 and 7512 may vary, and thus the capacitance formed between the adjacent coupling pads 7511 and 7512 may be set differently.

Referring to FIG. 7G, according to an embodiment, a PCB 750G (e.g., the PCB 450 in FIG. 4A) may include a plurality of coupling pads 751 (e.g., the coupling pads 451 in FIG. 4A) disposed separately to be electrically insulated via a dielectric 752, an electrical connection member 753 (e.g., the electrical connection member 453 in FIG. 4A) adapted to be connected to a conductive portion (e.g., the conductive portions 4411 in FIG. 4A) of a side member, a signal line 754 connected to a wireless communication circuit (e.g., the wireless communication circuit 490 in FIG. 4A), and/or a plurality of conductive vias 755.

In an embodiment, the plurality of coupling pads 751 may include a first coupling pad 7511 electrically connected to the electrical connection member 753, and a plurality of second coupling pads 7512 electrically connected to the signal line 754. In an embodiment, the first coupling pad 7511 may be electrically connected to the electrical connection member 753 through a first conductive via 7551. In an embodiment, the second coupling pads 7512 may include a 2-1 coupling pad 7512-1 and a 2-2 coupling pad 7512-2. In an embodiment, the plurality of second coupling pads 7512 may be electrically connected to each other through a second conductive via 7552.

In an embodiment, relative to a first direction T of the PCB 750G, the first coupling pad 7511 may be disposed between a pair of second coupling pads 7512. For example, the first coupling pad 7511 may be disposed on a layer disposed between the 2-1 coupling pad 7512-1 and the 2-2 coupling pad 7512-2. In an embodiment, the first coupling pad 7511 and the pair of second coupling pads 7512 may be disposed alternately to at least partially overlap along the first direction T of the PCB 750G.

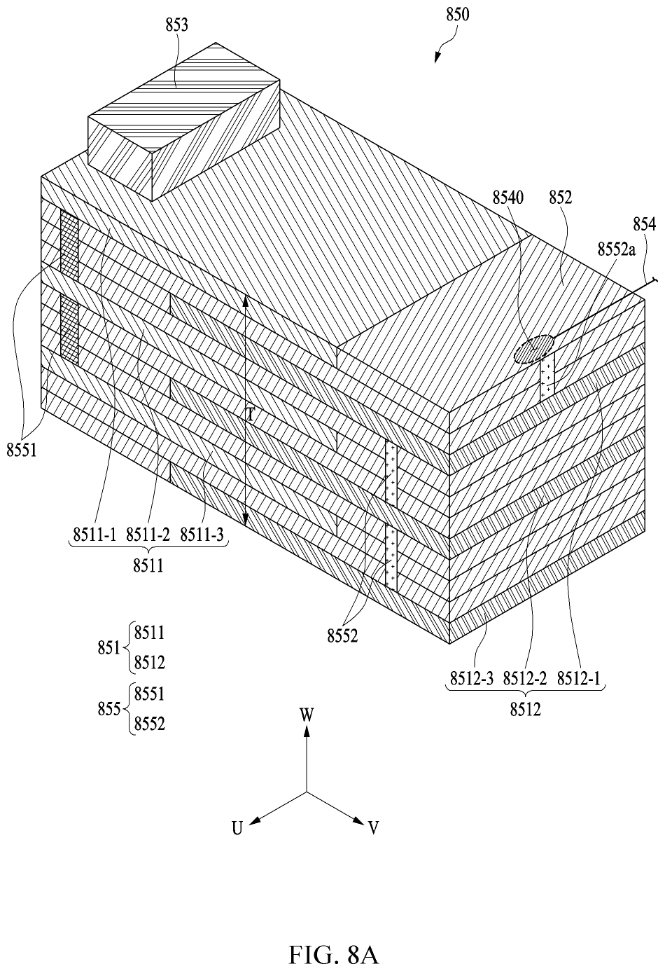

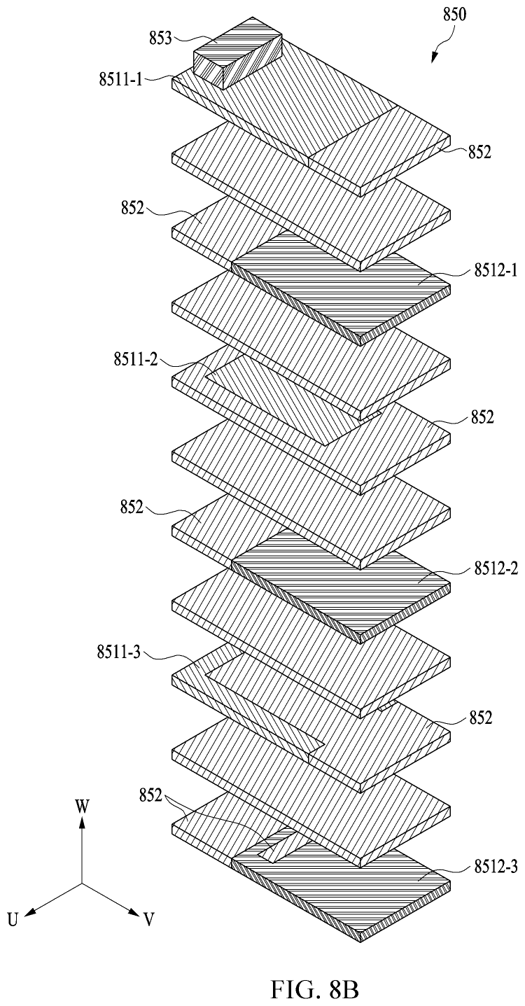

FIG. 8A is a partial perspective view of a PCB according to an embodiment of the present disclosure. FIG. 8B is an exploded perspective view illustrating a layer structure of a portion of a PCB according to an embodiment of the present disclosure.

Referring to FIGS. 8A and 8B, according to an embodiment, a PCB 850 (e.g., the PCB 450 in FIG. 4A) may include a plurality of coupling pads 851 (e.g., the coupling pads 451 in FIG. 4A) disposed separately to be electrically insulated via a dielectric 852, an electrical connection member 853 (e.g., the electrical connection member 453 in FIG. 4A) adapted to be connected to a conductive portion (e.g., the conductive portions 4411 in FIG. 4A) of a side member, a signal line 854 connected to a wireless communication circuit (e.g., the wireless communication circuit 490 in FIG. 4A), and/or a plurality of conductive vias 855.

In an embodiment, the plurality of coupling pads 851 may include a plurality of first coupling pads 8511 electrically connected through at least one first conductive via 8551, and a plurality of second coupling pads 8512 electrically connected through at least one second conductive via 8552. For example, the plurality of first coupling pads 8511 and the plurality of second coupling pads 8512 may be disposed alternately along a first direction T of the PCB 850, and adjacent first coupling pads 8511 and second coupling pads 8512 may overlap at least partially, with the PCB 850 viewed in the first direction T. For example, the first coupling pads 8511 may include a 1-1 coupling pad 8511-1, a 1-2 coupling pad 8511-2, and/or a 1-3 coupling pad 8511-3. For example, the second coupling pads 8512 may include a 2-1 coupling pad 8512-1, a 2-2 coupling pad 8512-2, and/or a 2-3 coupling pad 8512-3.

In an embodiment, relative to the first direction T of the PCB 850, overlap areas between the adjacent first coupling pads 8511 and second coupling pads 8512 may be different. For example, an overlap area between a first coupling pad 8511 and a second coupling pad 8512 adjacent to each other among the plurality of coupling pads 851 may have irregularity in form. For example, the coupling pads 851 may have different shapes. For example, as shown in FIG. 8B, with the PCB 850 viewed in the first direction T, an overlap area between the 1-1 coupling pad 8511-1 and the 2-1 coupling pad 8512-1 disposed adjacent to each other may be different from an overlap area between the 2-1 coupling pad 8512-1 and the 1-2 coupling pad 8511-2. For example, with the PCB 850 viewed in the first direction T, the 2-2 coupling pad 8512-2 and the 2-3 coupling pad 8512-3 may have different shapes, and thus overlap areas with respect to the 1-3 coupling pad 8511-3 disposed therebetween may be set differently. As the overlap areas between the first coupling pads 8511 and the second coupling pads 8512 disposed adjacent to each other along the first direction T of the PCB 850 are different, respective capacitances formed between the first coupling pads 8511 and the second coupling pads 8512 disposed adjacent to each other may be set to different magnitudes.

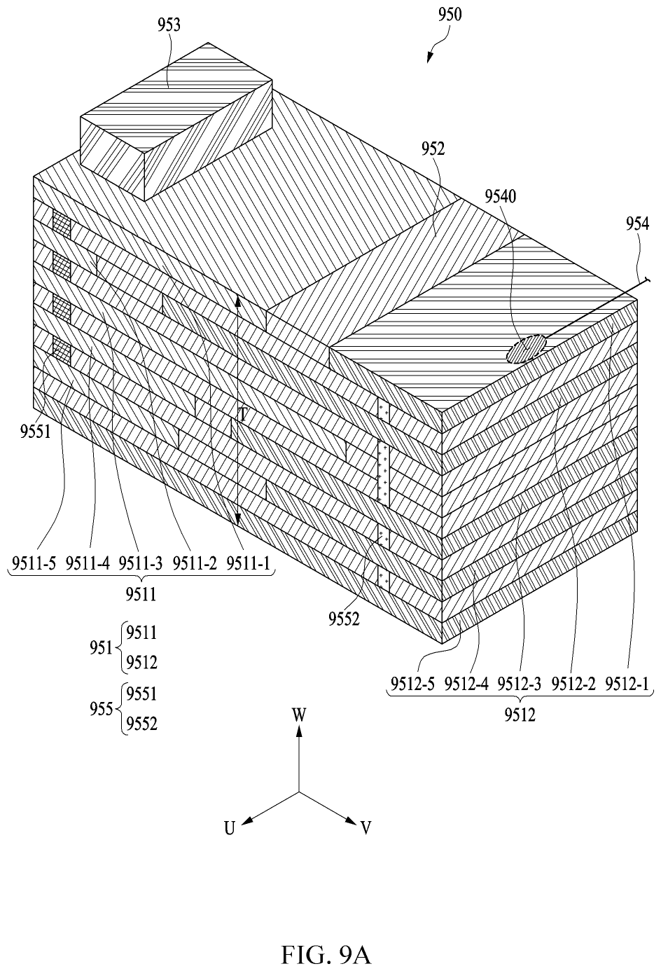

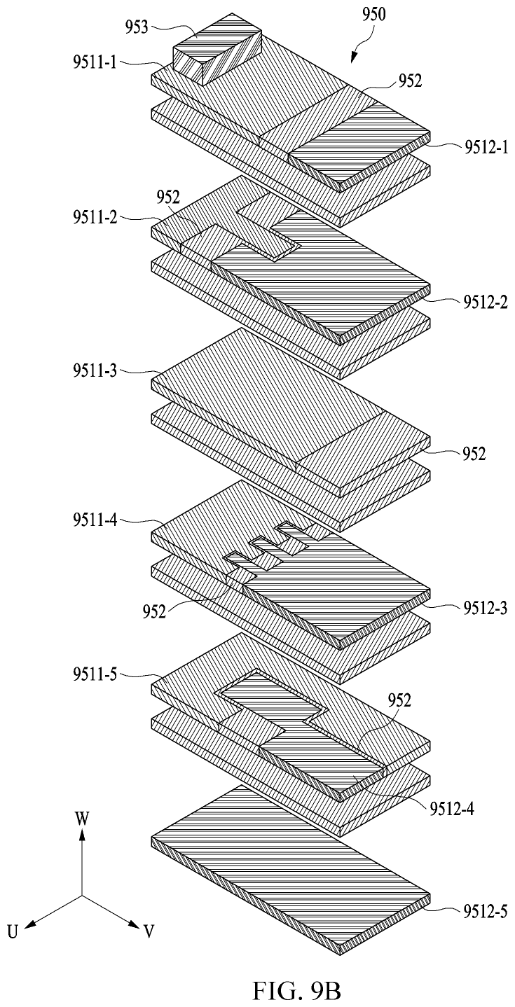

FIG. 9A is a partial perspective view of a PCB according to an embodiment of the present disclosure. FIG. 9B is an exploded perspective view illustrating a layer structure of a portion of a PCB according to an embodiment of the present disclosure.

Referring to FIGS. 9A and 9B, according to an embodiment, a PCB 950 (e.g., the PCB 450 in FIG. 4A) may include a plurality of coupling pads 951 (e.g., the coupling pads 451 in FIG. 4A) disposed separately to be electrically insulated via a dielectric 952, an electrical connection member 953 (e.g., the electrical connection member 453 in FIG. 4A) adapted to be connected to a conductive portion (e.g., the conductive portions 4411 in FIG. 4A) of a side member, a signal line 954 connected to a wireless communication circuit (e.g., the wireless communication circuit 490 in FIG. 4A), and/or a plurality of conductive vias 955.

In an embodiment, the plurality of coupling pads 951 may include a plurality of first coupling pads 9511 electrically connected through at least one first conductive via 9551 and a plurality of second coupling pads 9512 electrically connected through at least one second conductive via 9552. In an embodiment, the plurality of first coupling pads 9511 may be disposed separately along a first direction T of the PCB 950. For example, the plurality of first coupling pads 9511 may include a 1-1 coupling pad 9511-1, a 1-2 coupling pad 9511-2, a 1-3 coupling pad 9511-3, a 1-4 coupling pad 9511-4, and a 1-5 coupling pad 9511-5. In an embodiment, the plurality of second coupling pads 9512 may be disposed separately along the first direction T of the PCB 950. For example, the plurality of second coupling pads 9512 may include a 2-1 coupling pad 9512-1, a 2-2 coupling pad 9512-2, a 2-3 coupling pad 9512-3, a 2-4 coupling pad 9512-4, and a 2-5 coupling pad 9512-5. In an embodiment, the first coupling pads 9511 and the second coupling pads 9512 disposed adjacent to each other may at least partially overlap, with the PCB 950 viewed in the first direction T. For example, relative to the first direction T of the PCB 950, the 2-2 coupling pad 9512-2 may be disposed overlappingly between the 1-1 coupling pad 9511-1 and the 1-3 coupling pad 9511-3; the 2-3 coupling pad 9512-3 may be disposed overlappingly between the 1-3 coupling pad 9511-3 and the 1-5 coupling pad 9511-5; and the 2-4 coupling pad 9512-4 may be disposed overlappingly with the 1-4 coupling pad 9511-4. In an embodiment, relative to the first direction T of the PCB 950, overlap areas between adjacent first coupling pads 9511 and second coupling pads 9512 may be different. For example, an overlap area between a first coupling pad 9511 and a second coupling pad 9512 that are adjacent to each other among the plurality of coupling pads 951 may have irregularity in form. For example, the coupling pads 951 may have different shapes.

In an embodiment, at least one first coupling pad 9511 and at least one second coupling pad 9512 may be disposed on substantially the same layer, relative to the first direction T of the PCB 950. For example, the at least one first coupling pad 9511 and the at least one second coupling pad 9512 may be disposed to at least partially overlap each other when viewed in a direction perpendicular to the first direction T of the PCB 950. For example, the 1-1 coupling pad 9511-1 and the 2-1 coupling pad 9512-1 may be disposed overlappingly when viewed in a direction (e.g., a V-axis direction) perpendicular to the first direction T of the PCB 950. The 1-2 coupling pad 9511-2 and the 2-2 coupling pad 9512-2 may be disposed to overlap each other when viewed in a direction (e.g., the V-axis direction and a U-axis direction, respectively) perpendicular to the first direction T of the PCB 950. The 1-4 coupling pad 9511-4 and the 2-3 coupling pad 9512-3 may be disposed to overlap each other when viewed in a second direction (e.g., the V-axis direction and the U-axis direction, respectively) perpendicular to the first direction T of the PCB 950. The 1-5 coupling pad 9511-5 and the 2-4 coupling pad 9512-4 may be disposed to overlap each other when viewed in the second direction (e.g., the V-axis direction and the U-axis direction, respectively) perpendicular to the first direction T of the PCB 950.

In an embodiment, the plurality of coupling pads 951 may form a capacitance (e.g., a capacitance formed along the first direction T of the PCB 950) between a first coupling pad 9511 and a second coupling pad 9512 that are disposed overlappingly along the first direction T of the PCB 950. At the same time, the plurality of coupling pads 951 may also form a capacitance between a first coupling pad 9511 and a second coupling pad 9512 that are disposed on the same layer (or plane) (e.g., a capacitance formed between overlap areas in the U-axis direction or the V-axis direction). For example, the capacitances between the first coupling pads 9511 and the second coupling pads 9512 formed in the first direction T of the PCB 950, also formed in a plane direction of the PCB 950, may be used to determine a total capacitance formed by the plurality of coupling pads 951.

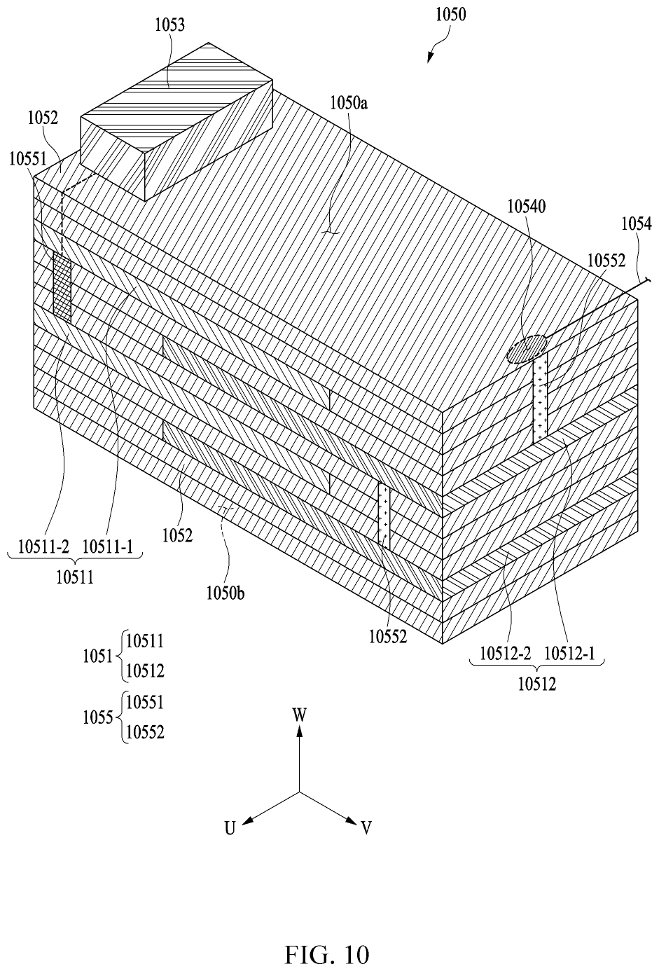

FIG. 10 is a partial perspective view of a PCB according to an embodiment of the present disclosure.

Referring to FIG. 10, according to an embodiment, a PCB 1050 (e.g., the PCB 450 in FIG. 4A) may include a plurality of coupling pads 1051 (e.g., the coupling pads 451 in FIG. 4A) disposed separately to be electrically insulated via a dielectric 1052, an electrical connection member 1053 (e.g., the electrical connection member 453 in FIG. 4A) adapted to be connected to a conductive portion (e.g., the conductive portions 4411 in FIG. 4A) of a side member, a signal line 1054 connected to a wireless communication circuit (e.g., the wireless communication circuit 490 in FIG. 4A), and/or a plurality of conductive vias 1055.

In an embodiment, the PCB 1050 may include a first board surface 1050a and a second board surface 1050b that are exposed to the outside relative to a first direction T. In an embodiment, the electrical connection member 1053 may be disposed on the first board surface 1050a of the PCB 1050. In an embodiment, a ground (e.g., the ground 556 in FIG. 5B) may be disposed on the first board surface 1050a or the second board surface 1050b of the PCB 1050.

In an embodiment, the plurality of coupling pads 1051 may include a plurality of first coupling pads 10511 electrically connected through at least one first conductive via 10551 and a plurality of second coupling pads 10512 electrically connected through at least one second conductive via 10552. In an embodiment, the plurality of first coupling pads 10511 and the plurality of second coupling pads 10512 may be alternately disposed along the first direction T of the PCB 1050. With the PCB 1050 viewed in the first direction T, a first coupling pad 10511 and a second coupling pad 10512 disposed adjacent to each other may be disposed to at least partially overlap each other. For example, the plurality of first coupling pads 10511 may include a 1-1 coupling pad 10511-1 and a 1-2 coupling pad 10511-2. The plurality of second coupling pads 10512 may include a 2-1 coupling pad 10512-1 and a 2-2 coupling pad 10512-2.

In an embodiment, the plurality of coupling pads 1051 may be disposed inside the PCB 1050 such that they are not exposed to the outside of the PCB 1050, for example, the first board surface 1050a and the second board surface 1050b. For example, the dielectric 1052 may be disposed on an outer surface of the 1-1 coupling pad 10511-1 in a direction of the first board surface 1050a, and may be disposed on an outer surface of the 2-2 coupling pad 10512-2 in a direction of the second board surface 1050b. In this case, the dielectric 1052 may be used such that the plurality of coupling pads 1051 may not be exposed to the outside of the PCB 1050.

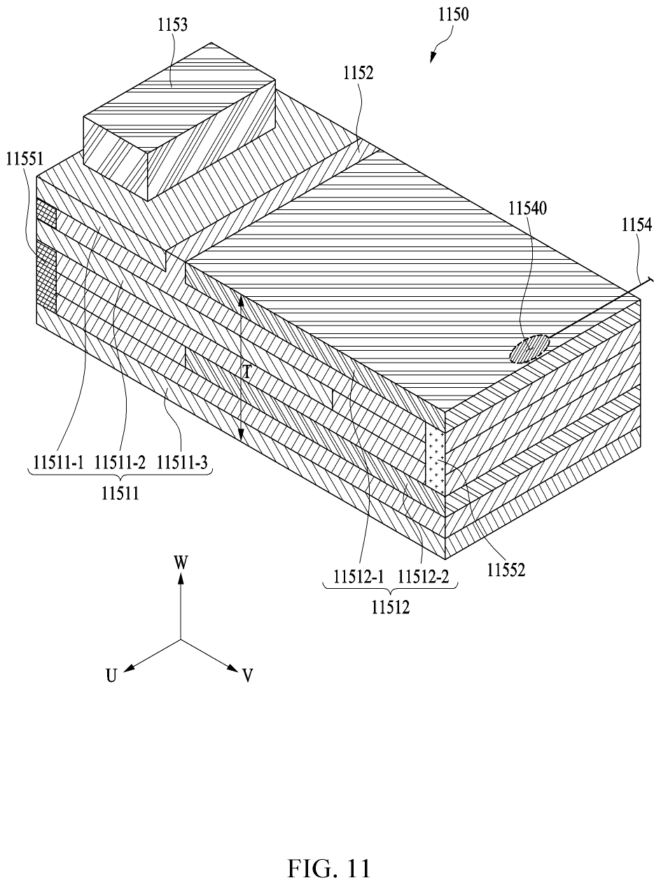

FIG. 11 is a partial perspective view of a PCB according to an embodiment of the present disclosure.

Referring to FIG. 11, according to an embodiment, a PCB 1150 (e.g., the PCB 450 in FIG. 4A) may include a plurality of coupling pads 1151 (e.g., the coupling pads 451 in FIG. 4A) disposed separately to be electrically insulated via a dielectric 1152, an electrical connection member 1153 (e.g., the electrical connection member 453 in FIG. 4A) adapted to be connected to a conductive portion (e.g., the conductive portions 4411 in FIG. 4A) of a side member, a signal line 1154 connected to a wireless communication circuit (e.g., the wireless communication circuit 490 in FIG. 4A), and/or a plurality of conductive vias 1155.

In an embodiment, the plurality of coupling pads 1151 may include a plurality of first coupling pads 11511 electrically connected through at least one first conductive via 11551 and a plurality of second coupling pads 11512 electrically connected through at least one second conductive via 11552. In an embodiment, the plurality of first coupling pads 11511 may be disposed separately along a first direction T of the PCB 1150. For example, the plurality of first coupling pads 11511 may include a 1-1 coupling pad 11511-1, a 1-2 coupling pad 11511-2, and a 1-3 coupling pad 11511-3. In an embodiment, the plurality of second coupling pads 11512 may be disposed separately along the first direction T of the PCB 1150. For example, the plurality of second coupling pads 11512 may include a 2-1 coupling pad 11512-1 and a 2-2 coupling pad 11512-2.

In an embodiment, at least one first coupling pad 11511 and a second coupling pad 11512 may be disposed to at least partially overlap, with the PCB 1150 viewed in the first direction T. For example, with the PCB 1150 viewed in the first direction T, the 2-2 coupling pad 11512-2 may be disposed between the 1-2 coupling pad 11511-2 and the 1-3 coupling pad 11511-3, and at least a portion thereof may overlap the 1-2 coupling pad 11512-2 and the 1-3 coupling pad 11511-3.

In an embodiment, at least one first coupling pad 11511 and at least one second coupling pad 11512 may be disposed on the same layer of the PCB 1150, relative to the first direction T of the PCB 1150. For example, the 1-1 coupling pad 11511-1 and the 2-1 coupling pad 11512-1 may be disposed on the same layer of the PCB 1150 in the first direction T of the PCB 1150, while being separated from each other via the dielectric 1152. The 1-1 coupling pad 11511-1 and the 2-1 coupling pad 11512-1 may at least partially overlap when viewed in a direction (e.g., a V-axis direction) perpendicular to the first direction T of the PCB 1150. A capacitance may be formed between overlap areas of the 1-1 coupling pad 11511-1 and the 2-1 coupling pad 11512-1 in the direction (e.g., the V-axis direction) perpendicular to the first direction T of the PCB 1150.

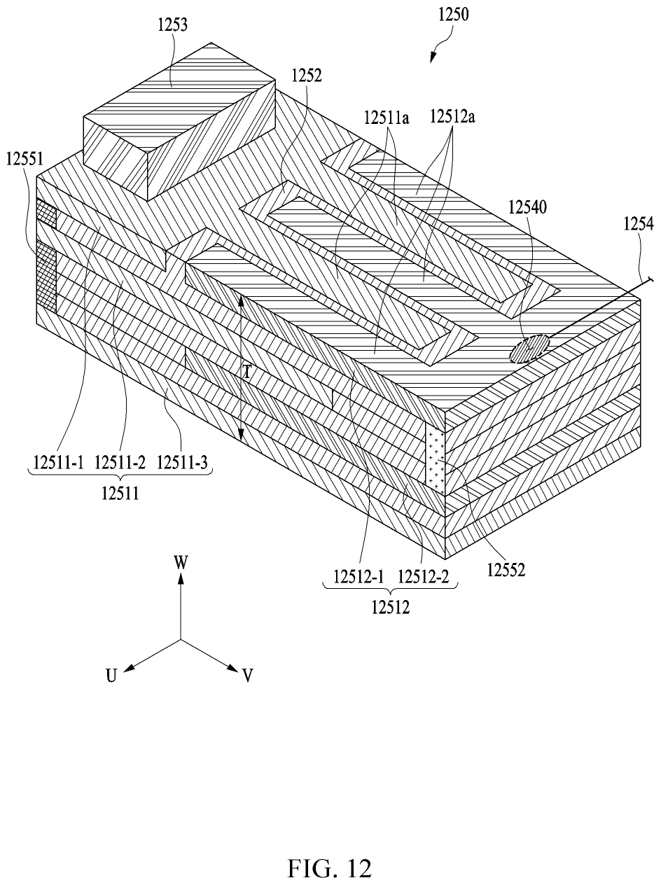

FIG. 12 is a partial perspective view of a PCB according to an embodiment of the present disclosure.

Referring to FIG. 12, according to an embodiment, a PCB 1250 (e.g., the PCB 450 in FIG. 4A) may include a plurality of coupling pads 1251 (e.g., the coupling pads 451 in FIG. 4A) disposed separately to be electrically insulated via a dielectric 1252, an electrical connection member 1253 (e.g., the electrical connection member 453 in FIG. 4A) adapted to be connected to a conductive portion (e.g., the conductive portions 4411 in FIG. 4A) of a side member, a signal line 1254 connected to a wireless communication circuit (e.g., the wireless communication circuit 490 in FIG. 4A), and/or a plurality of conductive vias 1255.

In an embodiment, the plurality of coupling pads 1251 may include a plurality of first coupling pads 12511 electrically connected through at least one first conductive via 12551 and a plurality of second coupling pads 12512 electrically connected through at least one second conductive via 12552. In an embodiment, the plurality of first coupling pads 12511 may be disposed separately along a first direction T of the PCB 1150. For example, the plurality of first coupling pads 12511 may include a 1-1 coupling pad 12511-1, a 1-2 coupling pad 12511-2, and a 1-3 coupling pad 12511-3. In an embodiment, the plurality of second coupling pads 12512 may be disposed separately along the first direction T of the PCB 1250. For example, the plurality of second coupling pads 12512 may include a 2-1 coupling pad 12512-1 and a 2-2 coupling pad 12512-2.

In an embodiment, at least one first coupling pad 12511 and a second coupling pad 12512 may be disposed to at least partially overlap, with the PCB 1250 viewed in the first direction T. For example, with the PCB 1250 viewed in the first direction T, the 2-2 coupling pad 12512-2 may be disposed between the 1-2 coupling pad 12511-2 and the 1-3 coupling pad 12511-3, and at least a portion thereof may overlap the 1-2 coupling pad 12511-2 and the 1-3 coupling pad 12511-3. In an embodiment, a capacitance may be formed between a first coupling pad 12511 and a second coupling pad 12512 disposed adjacent to each other, in the first direction T of the PCB 1250.

In an embodiment, at least one first coupling pad 12511 and at least one second coupling pad 12512 may be disposed on the same layer of the PCB 1250, relative to the first direction T of the PCB 1150. For example, the 1-1 coupling pad 12511-1 and the 2-1 coupling pad 12512-1 may be disposed on the same layer. In an embodiment, the first coupling pad 12511 and the second coupling pad 12512 disposed on the same layer may each include a plurality of pad portions that are alternately disposed in a direction perpendicular to the first direction T of the PCB 1250. For example, the 1-1 coupling pad 12511-1 may include a plurality of 1-1 pad portions 12511a that extend in a +V direction and are mutually separated, and the 2-1 coupling pad 12512-1 may include a plurality of 2-1 pad portions 12512a that extend in a −V direction and are mutually separated. In an embodiment, the plurality of 1-1 pad portions 12511a and the plurality of 2-1 pad portions 12512a may be alternately disposed along a direction perpendicular to the first direction T of the PCB 1250, for example, a U-axis direction, while being separated by the dielectric 1252. In an embodiment, a capacitance may be formed between a 1-1 pad portion 12511a and a 2-1 pad portion 12512a disposed adjacent to each other, in the U-axis direction.

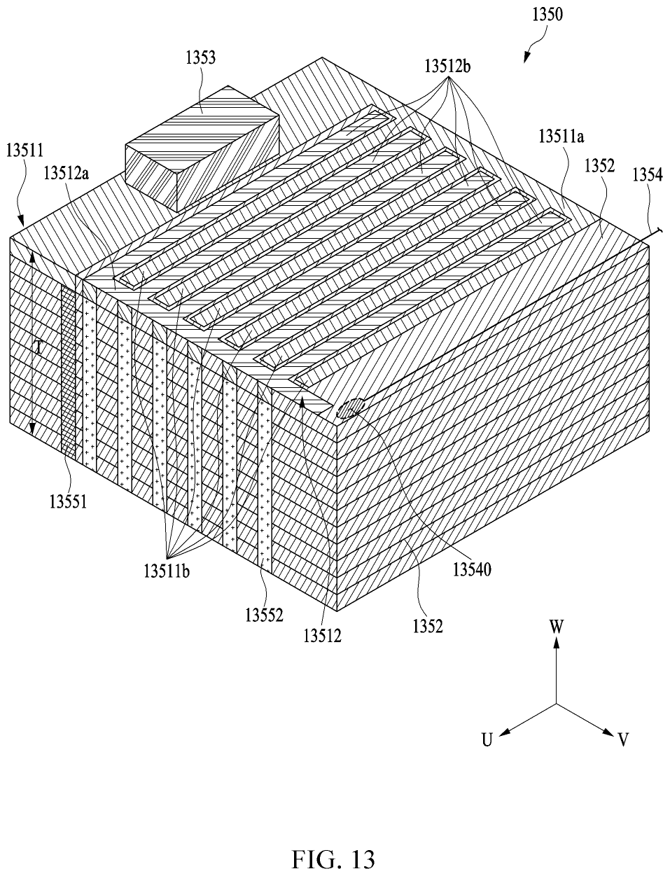

FIG. 13 is a partial perspective view of a PCB according to an embodiment of the present disclosure.

Referring to FIG. 13, according to an embodiment, a PCB 1350 (e.g., the PCB 450 in FIG. 4A) may include a plurality of coupling pads 1351 (e.g., the coupling pads 451 in FIG. 4A) disposed separately to be electrically insulated via a dielectric 1352, an electrical connection member 1353 (e.g., the electrical connection member 453 in FIG. 4A) adapted to be connected to a conductive portion (e.g., the conductive portions 4411 in FIG. 4A) of a side member, a signal line 1354 connected to a wireless communication circuit (e.g., the wireless communication circuit 490 in FIG. 4A), and/or a plurality of conductive vias 1355.

In an embodiment, the plurality of coupling pads 1351 may include a plurality of first coupling pads 13511 electrically connected through at least one first conductive via 13551 and a plurality of second coupling pads 13512 electrically connected through at least one second conductive via 13552.

In an embodiment, at least one first coupling pad 13511 and at least one second coupling pad 13512 may be disposed on the same layer of the PCB 1350, relative to a first direction T of the PCB 1350. In an embodiment, the first coupling pad 13511 and the second coupling pad 13512 disposed on the same layer may each include a plurality of pad portions that are alternately disposed in a direction perpendicular to the first direction T of the PCB 1350. For example, the first coupling pad 13511 may include a 1-1 pad portion 13511a extending in a +V direction and a 1-2 pad portion 13511b extending in a +U direction. The second coupling pad 13512 may include a 2-1 pad portion 13512a extending in a −V direction and a 2-2 pad portion 13512b extending in a −U direction. In an embodiment, the pad portions of the first coupling pad 13511 and the pad portions of the second coupling pad 13512 may be alternately disposed at least partially along a direction perpendicular to the first direction T of the PCB 1350, while being separated by the dielectric 1352. For example, the 1-2-pad portion 13511b of the first coupling pad 13511 and the 2-2-pad portion 13512b of the second coupling pad 13512 may be alternately disposed along the direction perpendicular to the first direction T of the PCB 1350, for example, the V-axis direction. In an embodiment, a capacitance may be formed, in the V-axis direction, between the 1-2-pad portion 13511b and the 2-2-pad portion 13512b disposed adjacent to each other. In an embodiment, a capacitance may be formed, in the U-axis direction, between the 1-1 pad portion 13511a and the 2-2 pad portion 13512b disposed adjacent to each other. A capacitance may be formed, in the U-axis direction, between the 2-1 pad portion 13512a and the 1-2 pad portion 13511b disposed adjacent to each other.

In an embodiment, when a plurality of first conductive vias 13551 are connected to the first coupling pads 13511 and a plurality of second conductive vias 13552 are connected to the second coupling pads 13512, a capacitance may be formed between a first conductive via 13551 and a second conductive via 13552 disposed adjacent to each other along the direction perpendicular to the first direction T of the PCB 1350.

Although it is shown in FIG. 13 that the first coupling pads 13511 and the second coupling pads 13512 are disposed only on a surface layer (e.g., a surface facing a +W direction) of the PCB 1350 for ease of description, the PCB 1350 may have a plurality of first coupling pads 13511 and a plurality of second coupling pads 13512 disposed on layers of the PCB 1350 along the first direction T. In an embodiment, a first coupling pad 13511 and a second coupling pad 13512 disposed on the same layer of the PCB 1350 may form the same pattern and may be disposed along the first direction T of the PCB 1350.

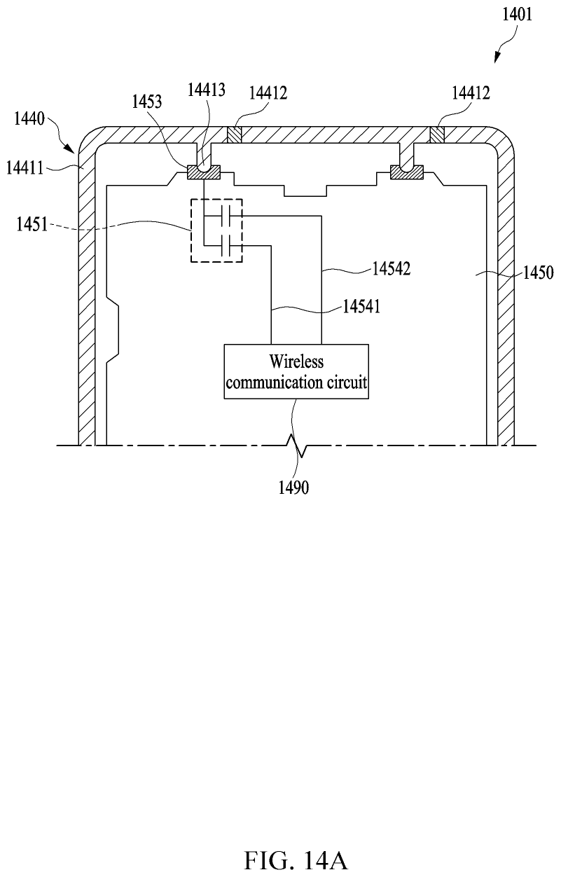

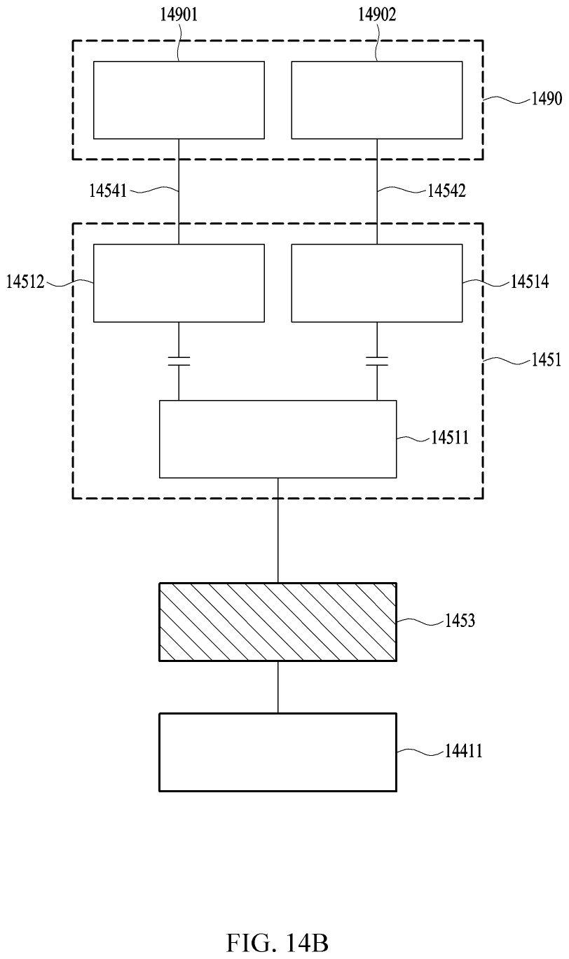

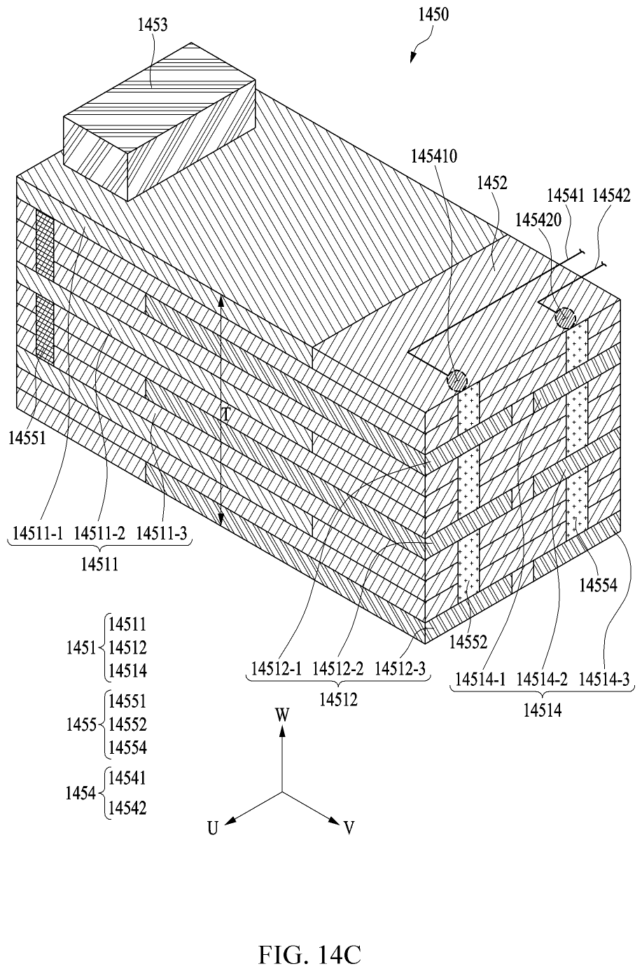

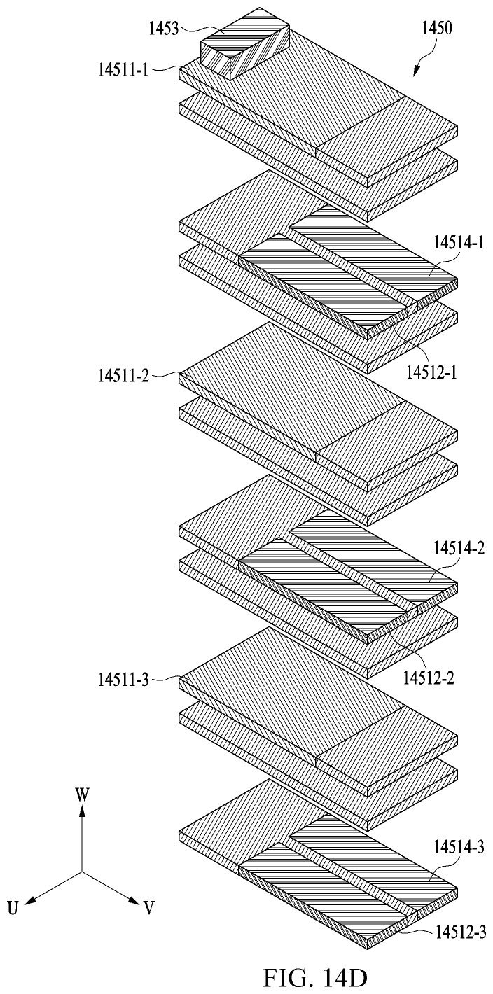

FIG. 14A is a diagram schematically illustrating a connection structure of a side member and a PCB in an electronic device according to an embodiment of the present disclosure. FIG. 14B is a diagram schematically illustrating a circuit connection structure of a side member, a PCB, and a wireless communication circuit according to an embodiment of the present disclosure. FIG. 14C is a partial perspective view of a PCB according to an embodiment of the present disclosure. FIG. 14D is an exploded perspective view illustrating a layer structure of a portion of a PCB according to an embodiment of the present disclosure.

Referring to FIGS. 14A and 14B, according to an embodiment, an electronic device 1401 may include a housing (e.g., the housing 210 in FIG. 2A), a PCB 1450 (e.g., the PCBs 251 and 252 in FIG. 3), and a wireless communication circuit 1490.

In an embodiment, the housing may include a front surface (e.g., the front surface 210a in FIG. 2A), a rear surface (e.g., the rear surface 210b in FIG. 2B) opposite the front surface, and a side (e.g., the side 211c in FIG. 2A) enclosing an inner space between the front surface and the rear surface. In an embodiment, the housing may include a side member 1440 (e.g., the side member 240 in FIG. 3) that forms at least a portion of the side and encloses the inner space. In an embodiment, the side member 1440 may include a conductive portion 14411 formed of a conductive material. In an embodiment, the conductive portion 14411 may function as a radiator of an antenna through which electrical signals flow. In an embodiment, the side member 1440 may include at least one connective portion 14413 formed on the conductive portion 14411 and electrically connected to the PCB 1450. In an embodiment, the connective portion 14413 may function as a feeder to which an electrical signal to be applied to the conductive portion 14411 is applied or as a ground to which the electrical signal applied to the conductive portion 14411 escapes.

In an embodiment, the PCB 1450 may be disposed in the inner space of the housing. In an embodiment, the PCB 1450 may include at least one electrical connection member 1453 electrically connected to the conductive portion 14411. In an embodiment, the PCB 1450 may be electrically connected to the wireless communication circuit 1490. The PCB 1450 may include a plurality of signal lines 14541 and 14542 connected to the wireless communication circuit 1490. For example, the PCB 1450 may include a first signal line 14541 and a second signal line 14542 each connected to the wireless communication circuit 1490. The plurality of signal lines 14541 and 14542 may be connected to different wireless communication circuits 1490, respectively, or may be independently connected to one wireless communication circuit 1490 to transmit and receive separate electrical signals, respectively. In an embodiment, the PCB 1450 may form a plurality of electrical paths leading from the electrical connection member 1453 connected to one conductive portion 14411 to the wireless communication circuit 1490 via the respective signal lines 14541 and 14542. For example, the PCB 1450 may form a first electrical path from the electrical connection member 1453 to the first signal line 14541 and a second electrical path from the electrical connection member 1453 to the second signal line 14542.

In an embodiment, the PCB 1450 may include a plurality of coupling pads 1451 disposed on the electrical paths. The plurality of coupling pads 1451 may electrically connect the electrical connection member 1453 and the signal lines 14541 and 14542 connected to the wireless communication circuit 1490 by a non-contact coupled feeding structure. In an embodiment, the plurality of coupling pads 1451 may include a first coupling pad 14511 connected to the electrical connection member 1453, a second coupling pad 14512 coupled to the first coupling pad 14511 and connected to the first signal line 14541, and a fourth coupling pad 14514 coupled to the first coupling pad 14511 and connected to the second signal line 14542. For example, the second coupling pad 14512 and the fourth coupling pad 14514 may each be coupled to the first coupling pad 14511 to form a capacitance therebetween, respectively, and may thereby form an electrical path between the electrical connection member 1453 and the first signal line 14541 and an electrical path between the electrical connection member 1453 and the second signal line 14542. In an embodiment, the electronic device 1401 may selectively transfer electrical signals to the one electrical connection member 1453 via the first signal line 14541 and the second signal line 14542, to use the one conductive portion 14411 connected to the electrical connection member 1453 as an antenna for different frequency bands. In an embodiment, the wireless communication circuit 1490 may include a first circuit 14901 and a second circuit 14902 connected to the first signal line 14541 and the second signal line 14542, respectively. In an embodiment, the wireless communication circuit 1490 may selectively transmit and receive electrical signals via one of the first signal line 14541 and the second signal line 14542 through switching operations of the first circuit 14901 and the second circuit 14902.

Referring to FIGS. 14C and 14D, according to an embodiment, a PCB 1450 may include a plurality of coupling pads 1451 disposed separately to be electrically insulated via a dielectric 1452, an electrical connection member 1453 adapted to be connected to a conductive portion 14411 of a side member 1440, a first signal line 14541 and a second signal line 14542 connected to a wireless communication circuit 1490, and a plurality of conductive vias 1455.

In an embodiment, the plurality of coupling pads 1451 may include a plurality of first coupling pads 14511, a plurality of second coupling pads 14512, and a plurality of fourth coupling pads 14514. In an embodiment, the plurality of first coupling pads 14511 may be connected to the electrical connection member 1453 to form an electrical path. In an embodiment, the plurality of second coupling pads 14512 may be connected to the wireless communication circuit 1490 via the first signal line 14541 to form an electrical path. In an embodiment, the plurality of fourth coupling pads 14514 may be connected to the wireless communication circuit 1490 via the second signal line 14542 to form an electrical path.

In an embodiment, relative to a first direction T of the PCB 1450, at least one of the plurality of second coupling pads 14512 may be disposed between a pair of first coupling pads 14511. With the PCB 1450 viewed in the first direction T, a second coupling pad 14512 may at least partially overlap adjacent first coupling pads 14511. In an embodiment, relative to the first direction T of PCB 1450, at least one of the plurality of fourth coupling pads 14514 may be disposed between a pair of first coupling pads 14511. With the PCB 1450 viewed in the first direction T, a fourth coupling pad 14514 may at least partially overlap adjacent first coupling pads 14511.

In an embodiment, the plurality of first coupling pads 14511 and the plurality of second coupling pads 14512 may be alternately disposed along the first direction T of the PCB 1450. For example, the plurality of first coupling pads 14511 may include a 1-1 coupling pad 14511-1, a 1-2 coupling pad 14511-2, and a 1-3 coupling pad 14511-3, and the plurality of second coupling pads 14512 may include a 2-1 coupling pad 14512-1, a 2-2 coupling pad 14512-2, and a 2-3 coupling pad 14512-3 disposed alternately with the first coupling pads 14511-1, 14511-2, and 14511-3, respectively. In an embodiment, the plurality of first coupling pads 14511 and the plurality of fourth coupling pads 14514 may be alternately disposed along the first direction T of the PCB 1450. For example, the plurality of fourth coupling pads 14514 may include a 4-1 coupling pad 14514-1, a 4-2 coupling pad 14514-2, and a 4-3 coupling pad 14514-3, and may be alternately disposed along the first direction T of the PCB 1450 with the 1-1 coupling pad 14511-1, the 1-2 coupling pad 14511-2, and the 1-3 coupling pad 14511-3. In an embodiment, a first coupling pad 14511 and a second coupling pad 14512 that are adjacent to each other may at least partially overlap, with the PCB 1450 viewed in the first direction T, and form a capacitance therebetween for an indirect electrical signal delivery or transfer between the electrical connection member 1453 and the first signal line 14541. In an embodiment, a first coupling pad 14511 and a fourth coupling pad 14514 that are adjacent to each other may at least partially overlap, with the PCB 1450 viewed in the first direction T, and form a capacitance therebetween for an indirect electrical signal delivery or transfer between the electrical connection member 1453 and the second signal line 14542.

In an embodiment, the second coupling pads 14512 and the fourth coupling pads 14514 may be separated by being insulated from each other via the dielectric 1452. In an embodiment, the second coupling pads 14512 and the fourth coupling pads 14514 may be disposed on the same layer, as shown in FIG. 14D. For example, the 2-1 coupling pad 14512-1 and the 4-1 coupling pad 14514-1 may be disposed on the same layer, the 2-2 coupling pad 14512-2 and the 4-2 coupling pad 14514-2 may be disposed on the same layer, and the 2-3 coupling pad 14512-3 and the 4-3 coupling pad 14514-3 may be disposed on the same layer. However, this is provided only as an example, and at least one second coupling pad 14512 and at least one fourth coupling pad 14514 may not be disposed on the same layer. In an embodiment, a second coupling pad 14512 and a fourth coupling pad 14514 disposed on the same layer may have different overlap areas with respect to an adjacent first coupling pad 14511. In this case, for the same first coupling pad 14511, capacitances formed respectively by the second coupling pad 14512 and the fourth coupling pad 14514 may be different.

In an embodiment, the plurality of conductive vias 1455 may include at least one first conductive via 14551 electrically connecting the plurality of first coupling pads 14511, at least one second conductive via 14552 electrically connecting the plurality of second coupling pads 14512, and at least one fourth conductive via 14554 electrically connecting the plurality of fourth coupling pads 14514. The first conductive via 14551, the second conductive via 14552, and the fourth conductive via 14554 may be electrically insulated from each other. For example, the plurality of conductive vias 1455 may not directly connect the first coupling pads 14511, the second coupling pads 14512, and the fourth coupling pads 14514.

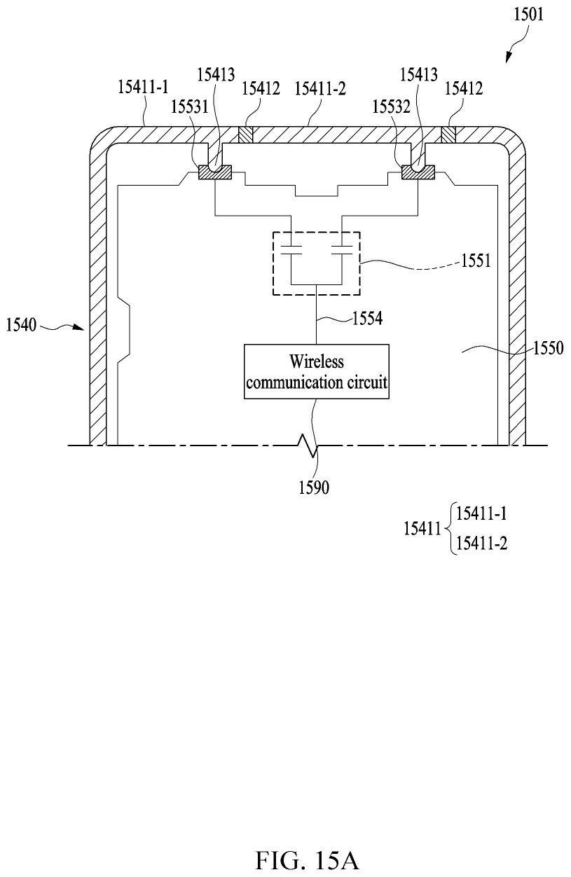

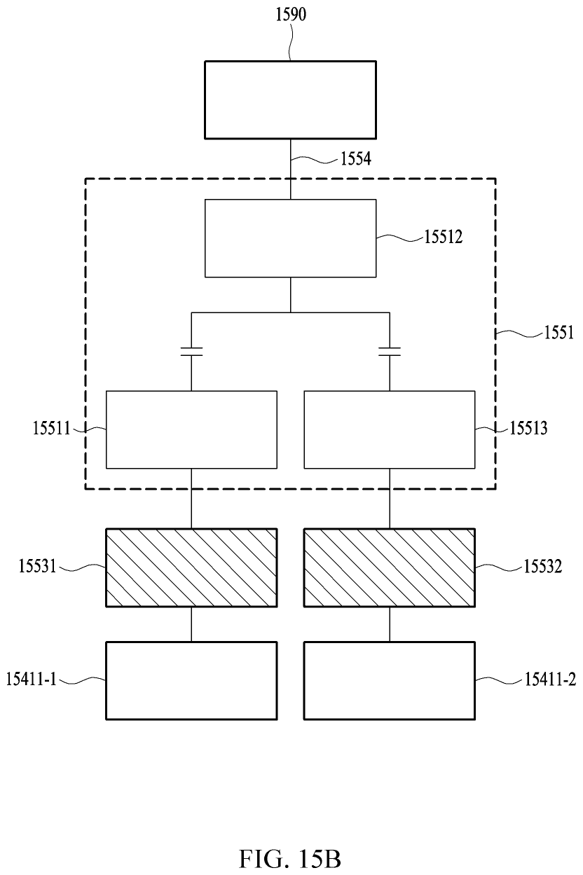

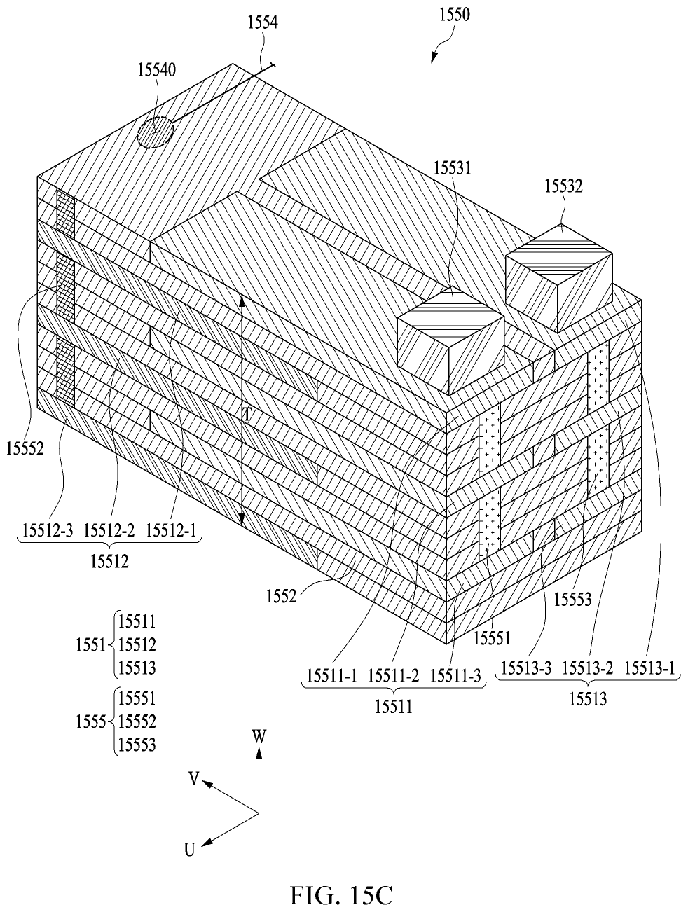

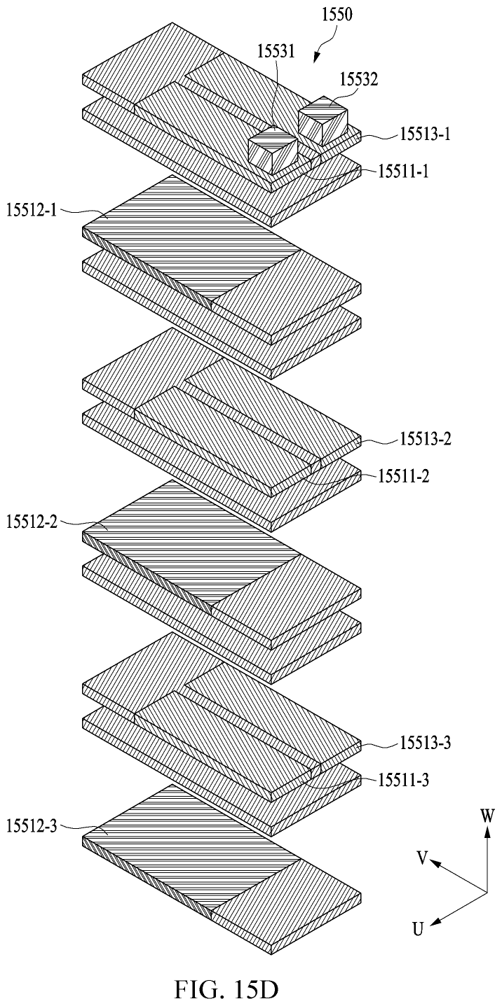

FIG. 15A is a diagram schematically illustrating a connection structure of a side member and a PCB in an electronic device according to an embodiment of the present disclosure. FIG. 15B is a diagram schematically illustrating a circuit connection structure of a side member, a PCB, and a wireless communication circuit according to an embodiment of the present disclosure. FIG. 15C is a partial perspective view of a PCB according to an embodiment of the present disclosure. FIG. 15D is an exploded perspective view illustrating a layer structure of a portion of a PCB according to an embodiment of the present disclosure.

Referring to FIGS. 15A through 15D, according to an embodiment, an electronic device 1501 may include a housing (e.g., the housing 210 in FIG. 2A), a PCB 1550 (e.g., the PCBs 251 and 252 in FIG. 3), and a wireless communication circuit 1590.

In an embodiment, the housing may include a front surface (e.g., the front surface 210a in FIG. 2A), a rear surface (e.g., the rear surface 210b in FIG. 2B) opposite the front surface, and a side (e.g., the side 211c in FIG. 2A) enclosing an inner space between the front surface and the rear surface. In an embodiment, the housing may include a side member 1540 (e.g., the side member 440 in FIG. 4A) that forms at least a portion of the side and encloses the inner space. In an embodiment, the side member 1540 may include a plurality of conductive portions 15411 formed of a conductive material. The plurality of conductive portions 15411 may be physically separated by insulative portions 15412 along the side. For example, the side member 1540 may include a first conductive portion 15411-1 and a second conductive portion 15411-2 that are physically separated by the insulative portions 15412. In an embodiment, the conductive portions 15411-1 and 15411-2 may each function as a radiator of an antenna through which electrical signals flow. In an embodiment, the side member 1540 may include one or more connective portions 15413 formed on the respective conductive portions 15411-1 and 15411-2 and electrically connected to the PCB 1550. In an embodiment, the connective portions 15413 may function as a feeder to which an electrical signal to be applied to the conductive portions 15411 corresponding to the connective portions 15413 is applied or as a ground to which the electrical signal applied to the conductive portions 15411 escapes.

In an embodiment, the PCB 1550 may be disposed in the inner space of the housing. In an embodiment, the PCB 1550 may include a plurality of electrical connection members 15531 and 15532 that are electrically connected to the first conductive portion 15411-1 and the second conductive portion 15411-2, respectively. For example, the plurality of electrical connection members 15531 and 15532 may include a first electrical connection member 15531 electrically connected to the first conductive portion 15411-1 and a second electrical connection member 15532 electrically connected to the second conductive portion 15411-2.

In an embodiment, the PCB 1550 may be electrically connected to the wireless communication circuit 1590. The PCB 1550 may include a signal line 1554 connected to the wireless communication circuit 1590. In an embodiment, the PCB 1550 may form a plurality of electrical paths leading to the wireless communication circuit 1590 from the electrical connection members 15531 and 15532 respectively connected to the plurality of conductive portions 15411-1 and 15411-2. For example, the PCB 1550 may form a first electrical path leading to the signal line 1554 from the first electrical connection member 15531 connected to the first conductive portion 15411-1 and a second electrical path leading to the signal line 1554 from the second electrical connection member 15532 connected to the second conductive portion 15411-2.

In an embodiment, the PCB 1550 may include a plurality of coupling pads 1551 disposed on the electrical paths. The plurality of coupling pads 1551 may electrically connect the electrical connection members 1553 and the signal line 1554 connected to the wireless communication circuit 1590 by a non-contact coupled feeding structure. In an embodiment, the plurality of coupling pads 1551 may include a first coupling pad 15511 connected to the first electrical connection member 15531, a third coupling pad 15513 connected to the second electrical connection member 15532, and a second coupling pad 15512 coupled to the first coupling pad 15511 and the third coupling pad 15513 and connected to the signal line 1554. For example, the second coupling pad 15512 may be coupled to the first coupling pad 15511 and the third coupling pad 15513, respectively, to form independent capacitances therebetween, and may thus form the electrical path between the first electrical connection member 15531 and the signal line 1554 and the electrical path between the second electrical connection member 15532 and the signal line 1554, respectively. In an embodiment, the electronic device 1501 may selectively use any of the first conductive portion 15411-1 to which the first electrical connection member 15531 is connected and the second conductive portion 15411-2 to which the second electrical connection member 15532 is connected as an antenna by selectively transmitting electrical signals to the plurality of electrical connection members 15531 and 15532 via the one signal line 1554.

Referring to FIGS. 15C and 15D, according to an embodiment, a PCB 1550 may include a plurality of coupling pads 1551 disposed separately to be electrically insulated via a dielectric 1552, electrical connection members 15531 and 15532 adapted to be connected to conductive portions 15411 of a side member 1540, a signal line 1554 connected to a wireless communication circuit 1590, and a plurality of conductive vias 1555.

In an embodiment, the plurality of coupling pads 1551 may include a plurality of first coupling pads 15511, a plurality of third coupling pads 15513, and a plurality of second coupling pads 15512. In an embodiment, the plurality of first coupling pads 15511 may be electrically connected to a first electrical connection member 15531. In an embodiment, a plurality of third coupling pads 15513 may be electrically connected to a second electrical connection member 15532. In an embodiment, the plurality of second coupling pads 15512 may be electrically connected to the signal line 1554.

In an embodiment, relative to a first direction T of the PCB 1550, at least one of the plurality of second coupling pads 15512 may be disposed between a pair of first coupling pads 15511. With the PCB 1550 viewed in the first direction T, a second coupling pad 15512 may at least partially overlap adjacent first coupling pads 15511. In an embodiment, relative to the first direction T of the PCB 1550, at least one of the plurality of second coupling pads 15512 may be disposed between a pair of third coupling pads 15513. With the PCB 1550 viewed in the first direction T, a second coupling pad 15512 may at least partially overlap adjacent third coupling pads 15513.

In an embodiment, the plurality of first coupling pads 15511 and the plurality of second coupling pads 15512 may be alternately disposed along the first direction T of the PCB 1550. For example, the plurality of first coupling pads 15511 may include a 1-1 coupling pad 15511-1, a 1-2 coupling pad 15511-2, and a 1-3 coupling pad 15511-3, and the plurality of second coupling pads 15512 may include a 2-1 coupling pad 15512-1, a 2-2 coupling pad 15512-2, and a 2-3 coupling pad 15512-3, alternately disposed with the first coupling pads 15511, respectively. In an embodiment, the plurality of third coupling pads 15513 and the plurality of second coupling pads 15512 may be alternately disposed along the first direction T of the PCB 1550. For example, the plurality of third coupling pads 15513 may include a 3-1 coupling pad 15513-1, a 3-2 coupling pad 15513-2, and a 3-3 coupling pad 15513-3, and may be alternately disposed along the first direction T of the PCB 1550 with the 2-1 coupling pad 15512-1, the 2-2 coupling pad 15512-2, and the 2-3 coupling pad 15512-3. In an embodiment, a first coupling pad 15511 and a second coupling pad 15512 that are adjacent to each other may at least partially overlap, with the PCB 1550 viewed in the first direction T, and may form a capacitance therebetween for an indirect electrical signal delivery or transfer between the first electrical connection member 15531 and the signal line 1554. In an embodiment, a third coupling pad 15513 and a second coupling pad 15512 that are adjacent to each other may at least partially overlap, with the PCB 1550 viewed in the first direction T, and may form a capacitance therebetween for an indirect electrical signal delivery or transfer between the second electrical connection member 15532 and the signal line 1554.

In an embodiment, the first coupling pads 15511 and the third coupling pads 15513 may be separated while insulated from each other via the dielectric 1552. In an embodiment, the first coupling pads 15511 and the third coupling pads 15513 may be disposed on the same layer, respectively, as shown in FIG. 15D. For example, the 1-1 coupling pad 15511-1 and the 3-1 coupling pad 15513-1 may be disposed on the same layer, the 1-2 coupling pad 15511-2 and the 3-2 coupling pad 15513-2 may be disposed on the same layer, and the 1-3 coupling pad 15511-3 and the 3-3 coupling pad 15513-3 may be disposed on the same layer. However, this is provided only as an example, and the first coupling pads 15511 and the third coupling pads 15513 may not be disposed on the same layer. In an embodiment, a first coupling pad 15511 and a third coupling pad 15513 that are disposed on the same layer may have different overlap areas with respect to an adjacent second coupling pad 15512. In this case, for the same second coupling pad 15512, capacitances formed respectively by the first coupling pad 15511 and the third coupling pad 15513 may be different.

In an embodiment, the plurality of conductive vias 1555 may include at least one first conductive via 15551 electrically connecting the plurality of first coupling pads 15511, at least one second conductive via 15552 electrically connecting the plurality of second coupling pads 15512, and at least one third conductive vias 15553 electrically connecting the plurality of third coupling pads 15513. The first conductive via 15551, the second conductive via 15552, and the third conductive via 15553 may be electrically insulated from each other. For example, the plurality of conductive vias 1555 may not directly connect the first coupling pads 15511, the second coupling pads 15512, and the third coupling pads 15513.

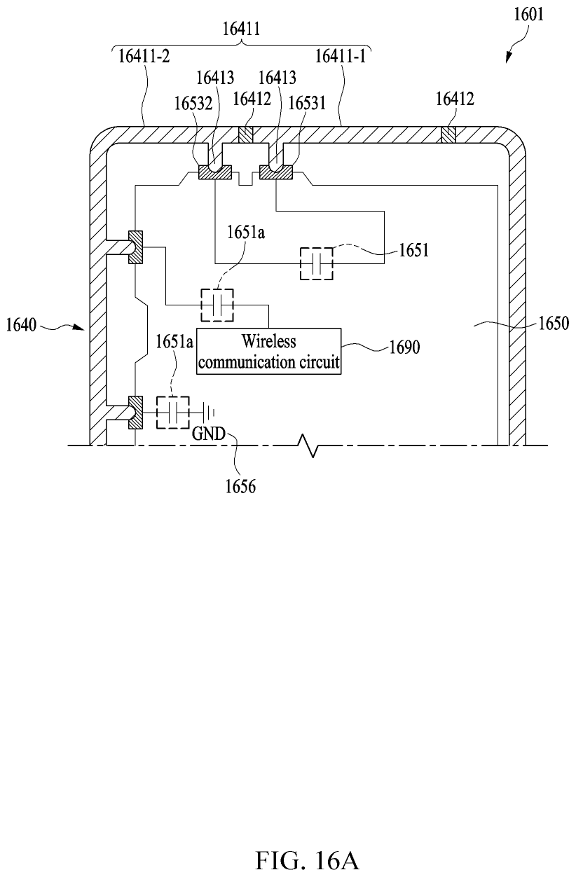

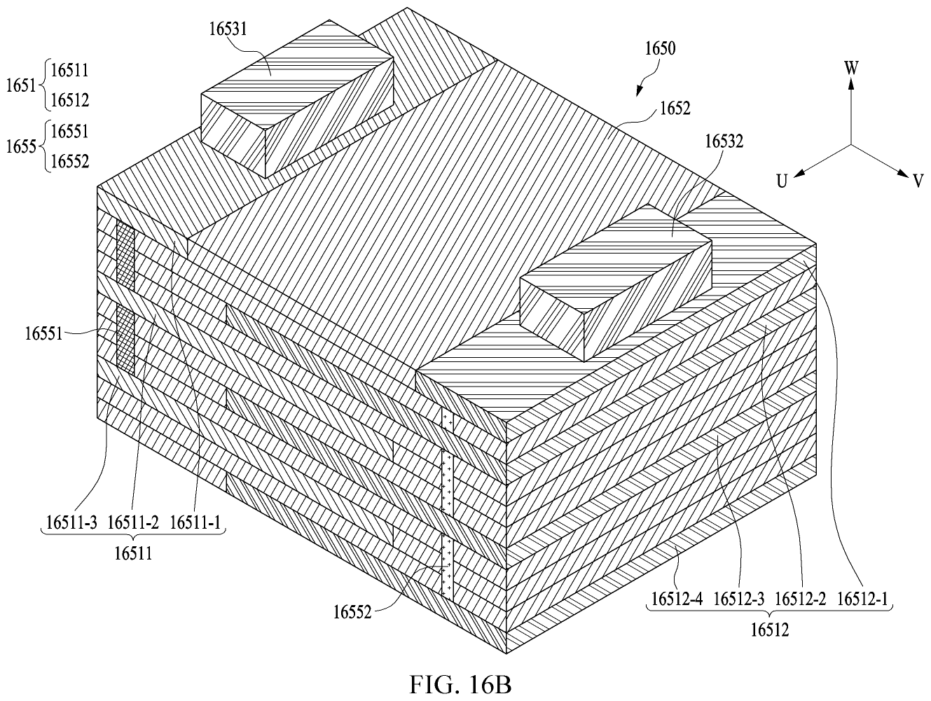

FIG. 16A is a diagram schematically illustrating a connection structure of a side member and a PCB in an electronic device according to an embodiment of the present disclosure. FIG. 16B is a partial perspective view of a PCB according to an embodiment of the present disclosure.

Referring to FIGS. 16A and 16B, according to an embodiment, an electronic device 1601 may include a housing (e.g., the housing 210 in FIG. 2A), a PCB 1650 (e.g., the PCBs 251 and 252 in FIG. 3), and a wireless communication circuit (e.g., the wireless communication circuit 490 in FIG. 4).

In an embodiment, the housing may include a front surface (e.g., the front surface 210a in FIG. 2A), a rear surface (e.g., the rear surface 210b in FIG. 2B) opposite the front surface, and a side (e.g., the side 211c in FIG. 2A) enclosing an inner space between the front surface and the rear surface. In an embodiment, the housing may include a side member 1640 (e.g., the side member 440 in FIG. 4A) that forms at least a portion of the side and encloses the inner space. In an embodiment, the side member 1640 may include a plurality of conductive portions 16411 formed of a conductive material. The plurality of conductive portions 16411 may be physically separated by insulative portions 16412 along the side. For example, the side member 1640 may include a first conductive portion 16411-1 and a second conductive portion 16411-2 that are physically separated. In an embodiment, the conductive portions 16411-1 and 16411-2 may each function as a radiator of an antenna through which electrical signals flow. For example, the conductive portions 16411-1 and 16411-2 may each function as a radiator of an antenna that transmits and receives wireless (or radio) signals in a frequency band corresponding to a length of electrical paths in the conductive portions 16411-1 and 16411-2 through which applied electrical signals flow. In an embodiment, the side member 1640 may include one or more connective portions 16413 formed on the conductive portions 16411-1 and 16411-2 and electrically connected to the PCB 1650.

In an embodiment, the PCB 1650 may be disposed in the inner space of the housing. In an embodiment, the PCB 1650 may include a plurality of electrical connection members 16531 and 16532 that are electrically connected to different conductive portions 1641, respectively. For example, the plurality of electrical connection members 16531 and 16532 may include a first electrical connection member 16531 electrically connected to the first conductive portion 16411-1 and a second electrical connection member 16532 electrically connected to the second conductive portion 16411-2.

In an embodiment, the PCB 1650 may include a plurality of coupling pads 1651 and 1651a for an indirect electrical signal delivery (or transfer) between the first conductive portion 16411-1 and the second conductive portion 16411-2. In an embodiment, the plurality of coupling pads 1651 and 1651a may be disposed separately on the PCB 1650 by being spaced apart from each other by a dielectric 1652. In an embodiment, the plurality of coupling pads 1651 may electrically connect the first conductive portion 16411-1 and the second conductive portion 16411-2 by a non-contact coupled feeding structure. In an embodiment, the plurality of coupling pads 1651a provided separately from the plurality of coupling pads 1651 connecting the first conductive portion 16411-1 and the second conductive portion 16411-2 may connect the first conductive portion 16411-1 or the second conductive portion 16411-2 to the wireless communication circuit 1690 or to a ground 1656.

In an embodiment, the plurality of coupling pads 1651 may include one or more first coupling pads 16511 connected to the first electrical connection member 16531 and one or more second coupling pads 16512 connected to the second electrical connection member 16532. For example, the first coupling pads 16511 may include a 1-1 coupling pad 16511-1, a 1-2 coupling pad 16511-2, and a 1-3 coupling pad 16511-3. The second coupling pads 16512 may include a 2-1 coupling pad 16512-1, a 2-2 coupling pad 16512-2, and a 2-3 coupling pad 16512-3. The plurality of first coupling pads 16511 may be electrically connected by a first conductive via 16551. The plurality of second coupling pads 16512 may be electrically connected by a second conductive via 16552. In an embodiment, the PCB 1650 may further include other coupling pads for connecting the conductive portions 16411 to the wireless communication circuit 1690 or for connecting the conductive portions 16411 to the ground 1656.

In an embodiment, relative to a first direction T of the PCB 1650, at least one of the plurality of second coupling pads 16512 may be disposed between a pair of first coupling pads 16511. In an embodiment, the plurality of first coupling pads 16511 and the plurality of second coupling pads 16512 may be disposed alternately along the first direction T of the PCB 1650. In an embodiment, a first coupling pad 16511 and a second coupling pad 16512 that are adjacent to each other may at least partially overlap, with the PCB 1650 viewed in the first direction T, and may form a capacitance therebetween for an indirect electrical signal delivery (or transfer) between the first electrical connection member 16531 and the second electrical connection member 16532.

In an embodiment, the plurality of coupling pads 1651 may connect the first conductive portion 16411-1 to which the first electrical connection member 16531 is connected and the second conductive portion 16411-2 to which the second electrical connection member 16532 is connected, in a non-contact manner, through the capacitance formed between the first coupling pads 16511 and the second coupling pads 16512. For example, when an electrical signal is applied to the first conductive portion 16411-1, the PCB 1650 may transfer the electrical signal applied to the first conductive portion 16411-1 to the second conductive portion 16411-2 through a coupled connection structure of the first coupling pads 16511 and the second coupling pads 16512. In this case, the first conductive portion 16411-1 and the second conductive portion 16411-2 may be used as a single radiator.

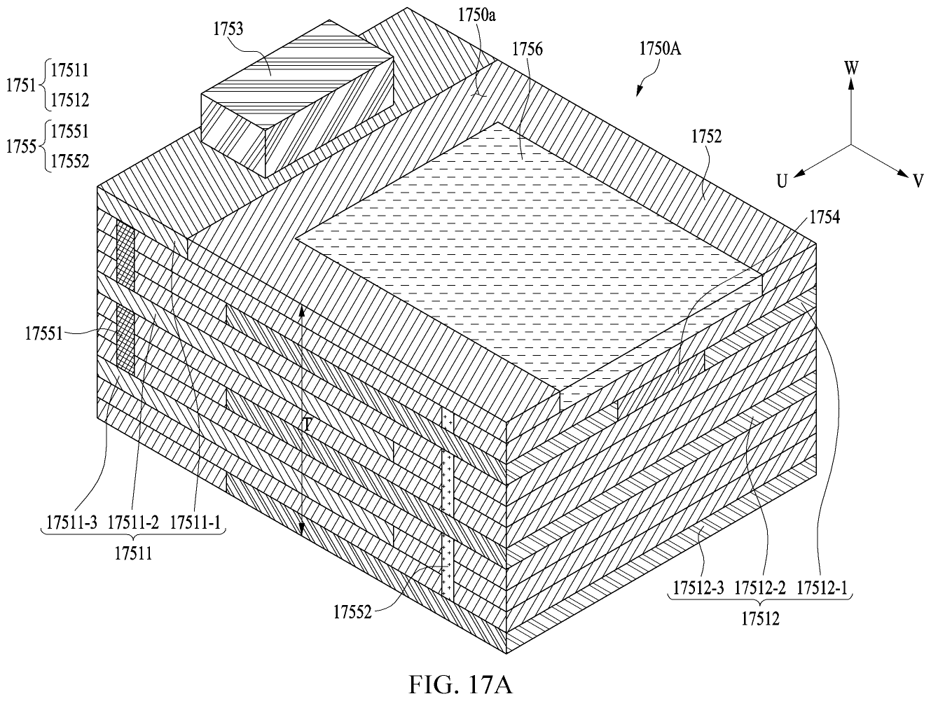

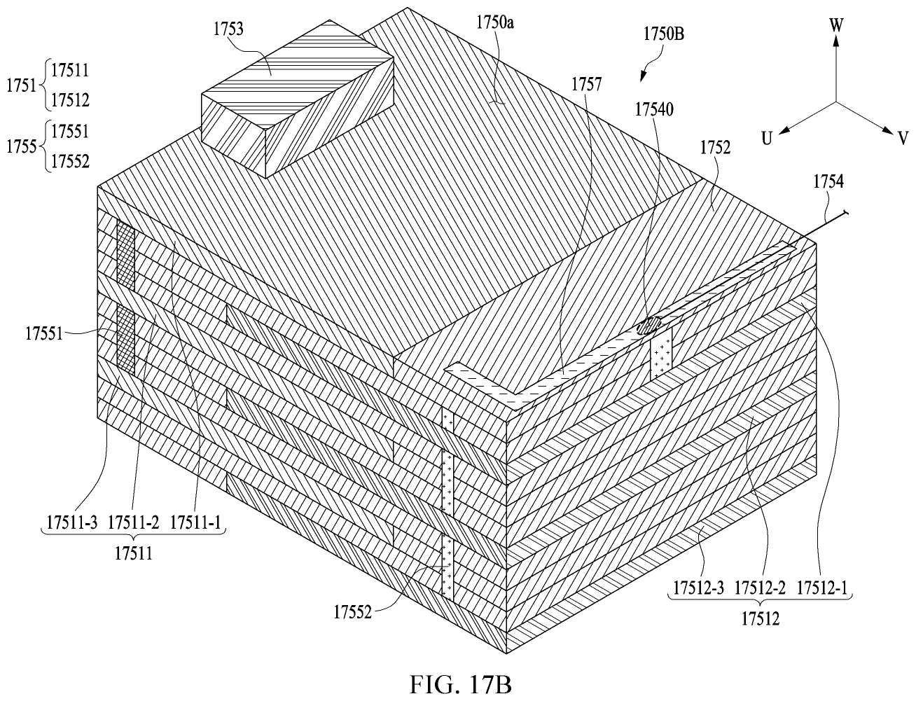

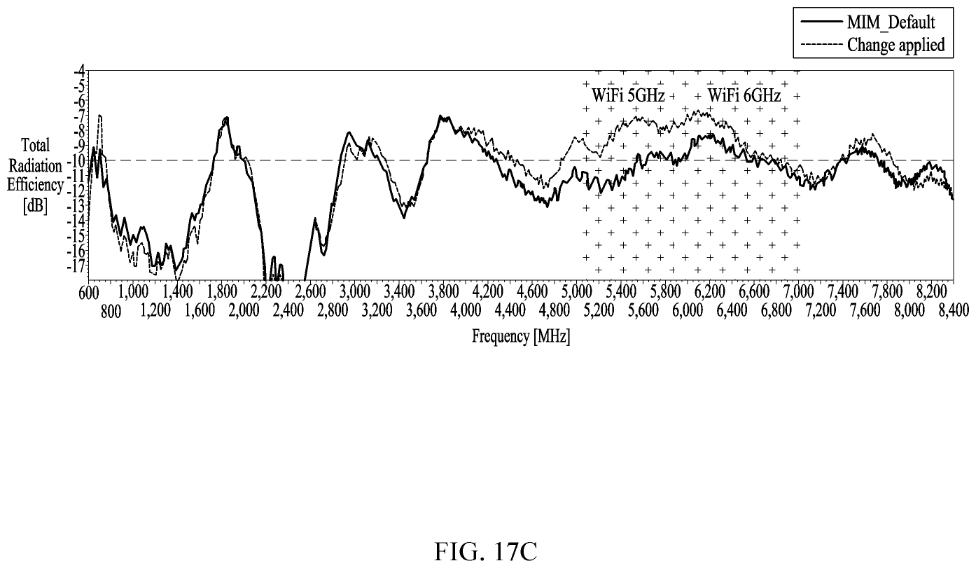

FIG. 17A is a partial perspective view of a PCB according to an embodiment of the present disclosure. FIG. 17B is a partial perspective view of a PCB according to an embodiment of the present disclosure. FIG. 17C is a graph illustrating a change in radiation efficiency of an antenna with and without a radiation member on a PCB according to an embodiment of the present disclosure.

Referring to FIG. 17A, according to an embodiment, a PCB 1750A (e.g., the PCB 450 in FIG. 4A) may include a plurality of coupling pads 1751 (e.g., the coupling pads 451 in FIG. 4A) disposed separately to be electrically insulated via a dielectric 1752, an electrical connection member 1753 (e.g., the electrical connection member 453 in FIG. 4A) adapted to be connected to a conductive portion (e.g., the conductive portions 4411 in FIG. 4A) of a side member, a line 1754 connected to a wireless communication circuit (e.g., the wireless communication circuit 490 in FIG. 4A), a plurality of conductive vias 1755, and a radiation member 1756.

In an embodiment, the plurality of coupling pads 1751 may include a plurality of first coupling pads 17511 electrically connected through at least one first conductive via 17551 and connected to the electrical connection member 1753, and a plurality of second coupling pads 17512 electrically connected through at least one second conductive via 17552 and connected to the signal line 1754. In an embodiment, the plurality of first coupling pads 17511 may be disposed separately along a first direction T of the PCB 1750A. For example, the plurality of first coupling pads 17511 may include a 1-1 coupling pad 17511-1, a 1-2 coupling pad 17511-2, and a 1-3 coupling pad 17511-3. In an embodiment, the plurality of second coupling pads 17512 may be disposed separately along the first direction T of the PCB 1750A. For example, the plurality of second coupling pads 17512 may include a 2-1 coupling pad 17512-1, a 2-2 coupling pad 17512-2, and a 2-3 coupling pad 17512-3.

In an embodiment, at least one of the second coupling pads 17512 may be disposed between two of the first coupling pads 17511 and may overlap at least partially with the adjacent two, with the PCB 1750A (or a PCB 1750B) viewed in the first direction T. In an embodiment, the plurality of first coupling pads 17511 and the plurality of second coupling pads 17512 may be disposed alternately along the first direction T of the PCB 1750A or 1750B. In an embodiment, a capacitance for an indirect electrical signal delivery (or transfer) may be formed between a first coupling pad 17511 and a second coupling pad 17512 that are adjacent to each other.

In an embodiment, the radiation member 1756 may be formed of a conductive material. In an embodiment, the radiation member 1756 may be physically spaced apart from the plurality of coupling pads 1751 via the dielectric 1752. In an embodiment, the radiation member 1756 may be disposed overlappingly with a second coupling pad 17512, with the PCB 1750A viewed in the first direction T. For example, the radiation member 1756 may be disposed to at least partially overlap the 2-1 coupling pad 17512-1. In an embodiment, the radiation member 1756 and the second coupling pad 17512 may be adapted to be coupled through an overlap area in the first direction T of the PCB 1750A. For example, a capacitance may be formed between the radiation member 1756 and the 2-1 coupling pad 17512-1 in the first direction T of the PCB 1750A. In this case, when an electrical signal is applied to the second coupling pad 17512 via the signal line 1754, the radiation member 1756 may receive the electrical signal indirectly from the second coupling pad 17512. The radiation member 1756 may function as a radiator of an antenna that forms a radiation pattern by the electrical signal received from the second coupling pad 17512.

Referring to FIG. 17B, according to an embodiment, a PCB 1750B (e.g., the PCB 450 in FIG. 4A) may include a plurality of coupling pads 1751 (e.g., the coupling pads 451 in FIG. 4A) physically separated via a dielectric 1752, an electrical connection member 1753 (e.g., the electrical connection member 453 in FIG. 4A) adapted to be connected to a conductive portion (e.g., the conductive portions 4411 in FIG. 4A) of a side member, a signal line 1754 connected to a wireless communication circuit (e.g., the wireless communication circuit 490 in FIG. 4A), a plurality of conductive vias 1755, and a radiation member 1757. In an embodiment, the plurality of coupling pads 1751 may include a plurality of first coupling pads 17511 electrically connected through at least one first conductive via 17551 and connected to the electrical connection member 1753, and a plurality of second coupling pads 17512 electrically connected through at least one second conductive via 17552 and connected to the signal line 1754. For example, the plurality of first coupling pads 17511 may include a 1-1 coupling pad 17511-1, a 1-2 coupling pad 17511-2, and a 1-3 coupling pad 17511-3 disposed separately along a first direction T of the PCB 1750B (or 1750A). In an embodiment, the plurality of second coupling pads 17512 may be disposed separately along the first direction T of the PCB 1750B. For example, the plurality of second coupling pads 17512 may include a 2-1 coupling pad 17512-1, a 2-2 coupling pad 17512-2, and a 2-3 coupling pad 17512-3. In an embodiment, at least one of the second coupling pads 17512 may be disposed between two of the first coupling pads 17511 and may overlap at least partially with the adjacent two, with the PCB 1750B viewed in the first direction T. In an embodiment, the plurality of first coupling pads 17511 and the plurality of second coupling pads 17512 may be disposed alternately along the first direction T of the PCB 1750B. In an embodiment, a capacitance for an indirect electrical signal delivery (or transfer) may be formed between a first coupling pad 17511 and a second coupling pad 17512 that are adjacent to each other.

In an embodiment, the radiation member 1757 may include a conductive pattern. For example, the radiation member 1757 may be a PCB embedded antenna (PEA) with a radiation pattern formed on its surface. In an embodiment, the radiation member 1757 may be directly connected to the signal line 1754. The radiation member 1757 may function as a radiator of the antenna that receives an electrical signal from the wireless communication circuit via the signal line 1754 and radiates the electrical signal.

In an embodiment, in a case where the radiation member 1757 is disposed on the PCB 1750B, the radiation efficiency of the antenna may be improved in transmitting and receiving electrical signals of a specific frequency band. FIG. 17C is a graph showing the radiation efficiency of an antenna with and without the connection of the radiation member 1757 having a conductive pattern, when applying an electrical signal to use the same conductive portion as the antenna. In FIG. 17C, a horizontal axis represents a frequency band, and a vertical axis represents a total radiation efficiency. A solid line represents the radiation efficiency of the antenna by frequency when the radiation member 1757 is used, and a dashed line represents the radiation efficiency of the antenna by frequency when the radiation member 1757 is not used.

Referring to FIG. 17C, it is verified that the radiation efficiency of the antenna obtained when the radiation member 1757 is used has a significant radiation efficiency in a certain frequency band (e.g., a Wi-Fi band from 5 GHz to 6 GHz), compared to one obtained when the radiation member 1757 is not used. For example, it is verified that the radiation efficiency of the antenna may be improved by additionally using a radiation member having a corresponding radiation pattern, for example, when transmitting and receiving electrical signals in a certain frequency band through a conductive portion.

FIG. 18A is a partial perspective view of a PCB according to an embodiment of the present disclosure. FIG. 18B is a partial cross-sectional view of a PCB according to an embodiment of the present disclosure.

Referring to FIGS. 18A and 18B, according to an embodiment, a PCB 1850 (e.g., the PCB 450 in FIG. 4A) may include a plurality of coupling pads 1851 (e.g., the coupling pads 451 in FIG. 4A) physically separated via a dielectric 1852, an electrical connection member 1853 (e.g., the electrical connection member 453 in FIG. 4A) adapted to be connected to a conductive portion (e.g., the conductive portions 4411 in FIG. 4A) of a side member, a signal lines 1854 (e.g., the signal line 454 in FIG. 4A) connected to a wireless communication circuit (e.g., the wireless communication circuit 490 in FIG. 4A), and a plurality of conductive vias 1855.

In an embodiment, the plurality of coupling pads 1851 may include a plurality of first coupling pads 18511 connected to the electrical connection member 1853, and a plurality of second coupling pads 18512 connected to the signal line 1854. For example, the plurality of first coupling pads 18511 may include a 1-1 coupling pad 18511-1, a 1-2 coupling pad 18511-2, and a 1-3 coupling pad 18511-3, and the plurality of second coupling pads 18512 may include a 2-1 coupling pad 18512-1, a 2-2 coupling pad 18512-2, and a 2-3 coupling pad 18512-3. In an embodiment, at least one second coupling pad 18512 may be disposed between a pair of first coupling pads 18511 and may overlap at least partially with the adjacent first coupling pads 18511, with the PCB 1850 viewed in a first direction T. In an embodiment, the plurality of first coupling pads 18511 and the plurality of second coupling pads 18512 may be disposed alternately along the first direction T (e.g., a W-axis direction) of the PCB 1850. In an embodiment, a capacitance for an indirect electrical signal delivery (or transfer) may be formed between overlap areas of a first coupling pad 18511 and a second coupling pad 18512 that are adjacent to each other.

In an embodiment, at least one first conductive vias 18551 may penetrate the PCB 1850 in the first direction T and electrically connect the plurality of first coupling pads 18511. At least one second conductive via 18552 may penetrate the PCB 1850 in the first direction T and electrically connect the plurality of second coupling pads 18512.

In an embodiment, at least one conductive via of the plurality of conductive vias 1855 may be connected to a switch 1859 adapted to selectively disconnect an electrical connection between coupling pads via the conductive via. For example, as shown in FIG. 18B, the first conductive via 18551 may be connected to a plurality of switches 1859 to selectively disconnect respective electrical connections to the 1-1 coupling pad 18511-1, the 1-2 coupling pad 18511-2, and the 1-3 coupling pad 18511-3. Also, the second conductive via 18552 may be connected to a plurality of switches 1859 to selectively disconnect respective electrical connections to the 2-1 coupling pad 18512-1, the 2-2 coupling pad 18512-2, and the 2-3 coupling pad 18512-3. For example, the plurality of switches 1859 may be disposed on one surface (e.g., the first board surface 550a in FIG. 5A) of the PCB 1850. In an embodiment, the plurality of switches 1859 may be implemented as a switch module 18590. For example, based on the embodiment shown in FIG. 18B, in a case where the switches 1859 are operated to connect only the first conductive via 18551 and the 1-1 coupling pad 18511-1 and to connect only the second conductive via 18552 and the 2-1 coupling pad 18512-1, electrical signals may be transmitted and received through a capacitance formed between the 1-1 coupling pad 18511-1 and the 2-1 coupling pad 18512-1 among the plurality of first coupling pads 18511 and the plurality of second coupling pads 18512, in a process for an indirect electrical signal delivery or transfer. For example, in a case where the plurality of first coupling pads 18511 and the plurality of second coupling pads 18512 are included, a selective operation of the switches 1859 may selectively change a total capacitance formed between the plurality of coupling pads 1851.

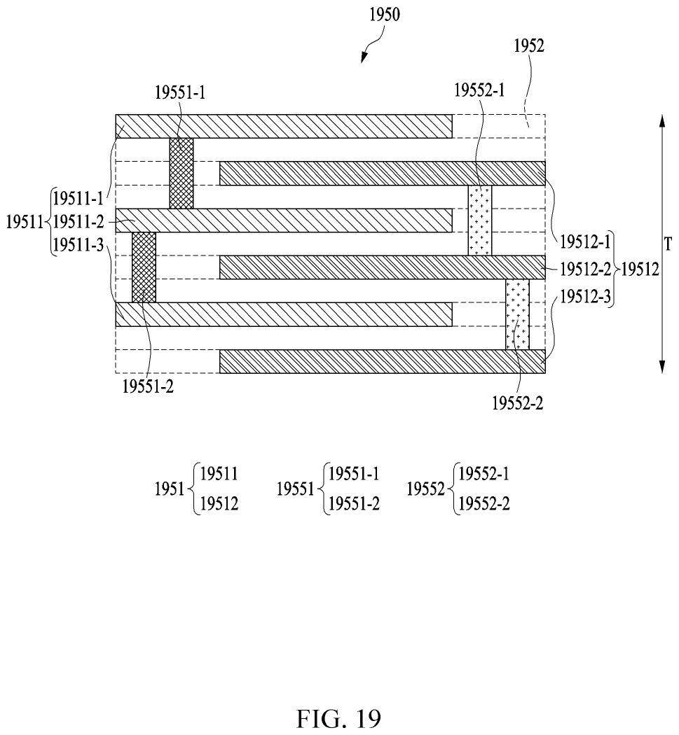

FIG. 19 is a partial cross-sectional view of a PCB according to an embodiment of the present disclosure.

Referring to FIG. 19, according to an embodiment, a PCB 1950 (e.g., the PCB 450 in FIG. 4A) may include a plurality of coupling pads 1951 (e.g., the coupling pads 451 in FIG. 4A) physically separated via a dielectric 1952, an electrical connection member (e.g., the electrical connection member 453 in FIG. 4A) adapted to be connected to a conductive portion (e.g., the conductive portions 4411 in FIG. 4A) of a side member, a signal line (e.g., the signal line 454 in FIG. 4A) connected to a wireless communication circuit (e.g., the wireless communication circuit 490 in FIG. 4A), a plurality of first conductive vias 19551, and a plurality of second conductive vias 19552.

In an embodiment, the plurality of coupling pads 1951 may include a plurality of first coupling pads 19511 electrically connected through the plurality of first conductive vias 19551 and a plurality of second coupling pads 19512 electrically connected through the plurality of second conductive vias 19552. In an embodiment, the first coupling pads 19511 may be connected to the electrical connection member. The second coupling pads 19512 may be connected to the wireless communication circuit via the signal line. In an embodiment, the plurality of first coupling pads 19511 may be disposed separately along a first direction T of the PCB 1950. For example, the plurality of first coupling pads 19511 may include a 1-1 coupling pad 19511-1, a 1-2 coupling pad 19511-2, and a 1-3 coupling pad 19511-3. In an embodiment, the plurality of second coupling pads 19512 may be disposed separately along the first direction T of the PCB 1950. For example, the plurality of second coupling pads 19512 may include a 2-1 coupling pad 19512-1, a 2-2 coupling pad 19512-2, and a 2-3 coupling pad 19512-3. In an embodiment, the first coupling pads 19511 and the second coupling pads 19512 may be disposed overlappingly along the first direction T. A capacitance for an electrical signal delivery (or transfer) may be formed between overlap areas of a first coupling pad 19511 and a second coupling pad 19512 in the first direction T.

In an embodiment, adjacent first coupling pads 19511 may be connected through respective first conductive vias 19551. For example, the first conductive vias 19551 may include a first conductive via 19551-1 electrically connecting the 1-1 coupling pad 19511-1 and the 1-2 coupling pad 19511-2 along the first direction T of the PCB 1950, and a second conductive via 19551-2 electrically connecting the 1-2 coupling pad 19511-2 and the 1-3 coupling pad 19511-3. In an embodiment, adjacent second coupling pads 19512 may be connected through respective second conductive vias 19552. For example, the respective first conductive vias 19551 may respectively connect adjacent first coupling pads 19511 to each other, and the respective second conductive vias 19552 may respectively connect adjacent second coupling pads 19512 to each other. For example, the second conductive vias 19552 may include a 2-1 conductive via 19552-1 electrically connecting the 2-1 coupling pad 19512-1 and the 2-2 coupling pad 19512-2 along the first direction T of the PCB 1950, and a 2-2 conductive via 19552-2 electrically connecting the 2-2 coupling pad 19512-2 and the 2-3 coupling pad 19512-3.

In an embodiment, the plurality of first conductive vias 19551 may be disposed on different layers of the PCB 1950. The plurality of second conductive vias 19552 may be disposed on different layers of the PCB 1950. This structure may tune (e.g., cut) any one of the conductive vias 19551 and 19552 connecting a pair of coupling pads 1951 to disconnect or adjust an electrical connection between the corresponding coupling pads 1951, thereby changing a capacitance formed between the plurality of coupling pads 1951. Accordingly, readily adjusting a set value of the capacitance through the conductive vias 1955 may readily compensate for an error in the capacitance that may occur due to design changes or manufacturing of the PCB 1950.

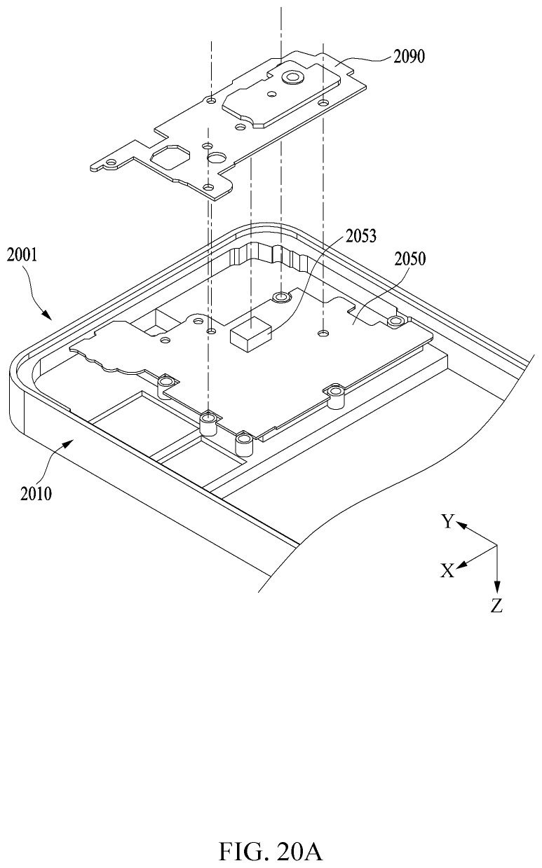

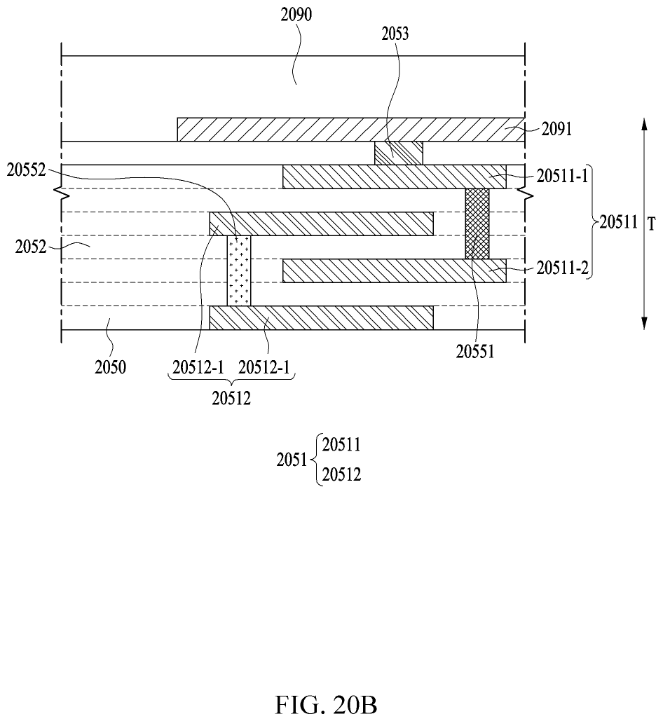

FIG. 20A is a partial exploded perspective view of an electronic device according to an embodiment of the present disclosure. FIG. 20B is a partial cross-sectional view illustrating a connection structure of a PCB and a rear frame according to an embodiment of the present disclosure.

Referring to FIG. 20A, according to an embodiment, an electronic device 2001 (e.g., the electronic device 201 in FIG. 2A) may include a housing 2010 (e.g., the housing 210 in FIG. 2A), a rear frame 2090, and a PCB 2050 (e.g., the PCB 251 in FIG. 3).

In an embodiment, the housing 2010 may form the exterior of the electronic device 2001. The housing 2010 may include a front surface (e.g., a surface facing a +Z direction), a rear surface (e.g., a surface facing a −Z direction), and a side (e.g., the side 211c in FIG. 2A) enclosing an inner space between the front surface and the rear surface.

In an embodiment, the rear frame 2090 may be disposed in the inner space of the electronic device 2001. In an embodiment, the rear frame 2090 may support components or parts (e.g., the PCB 2050) inside the electronic device 2001. In an embodiment, the rear frame 2090 may include a conductive portion 2091 exposed to at least a portion of its surface. For example, the rear frame 2090 may be formed of a non-conductive material, such as, a synthetic resin (e.g., polycarbonate (PC)), and the conductive portion 2091 may be formed as a metallic patterned layer on a surface of the rear frame 2090 facing the PCB 2050 (e.g., a surface facing the +Z direction). For example, the conductive portion 2091 may be formed on the surface of the rear frame 2090 through a laser direct structuring (LDS) pattern plating process, but the method of forming the conductive portion 2091 is not limited thereto. In an embodiment, the rear frame 2090 may be disposed inside the electronic device 2001 such that at least a portion of the conductive portion 2091 is in contact with or indirectly connected to the PCB 2050 via another connecting member.

In an embodiment, the PCB 2050 may be disposed in the inner space of the electronic device 2001. In an embodiment, the PCB 2050 may include a plurality of coupling pads 2051 physically separated via a dielectric 2052, an electrical connection member 2053 adapted to be connected to the conductive portion 2091 of the rear frame 2090, a signal line (e.g., the signal line 454 in FIG. 4A) connected to a wireless communication circuit (e.g., the wireless communication circuit 490 in FIG. 4A), or a plurality of conductive vias 2055.

In an embodiment, the plurality of coupling pads 2051 may include a plurality of first coupling pads 20511 electrically connected through a first conductive via 20551 and a plurality of second coupling pads 20512 electrically connected through a second conductive via 20552. In an embodiment, the first coupling pads 20511 may be connected to the electrical connection member 2053. In an embodiment, the second coupling pads 20512 may be connected to the wireless communication circuit via the signal line.

In an embodiment, the plurality of first coupling pads 20511 may be disposed separately along a first direction T of the PCB 2050. For example, the plurality of first coupling pads 20511 may include a 1-1 coupling pad 20511-1 and a 1-2 coupling pad 20511-2. The plurality of second coupling pads 20512 may be disposed separately along the first direction T of the PCB 2050. For example, the plurality of second coupling pads 20512 may include a 2-1 coupling pad 20512-2 and a 2-2 coupling pad 20512-2. In an embodiment, the first coupling pads 20511 and the second coupling pads 20512 may be disposed overlappingly along the first direction T. A capacitance for an electrical signal delivery (or transfer) may be formed between overlap areas of the first coupling pads 20511 and the second coupling pads 20512 in the first direction T.

In an embodiment, the plurality of coupling pads 2051 may transfer electrical signals between the conductive portion 2091 of the rear frame 2090 and the wireless communication circuit through the capacitance formed between the first coupling pads 20511 and the second coupling pads 20512. The conductive portion 2091 of the rear frame 2090 may function as an antenna having a radiation performance (or radiation efficiency) by the electrical signals transferred from the wireless communication circuit.

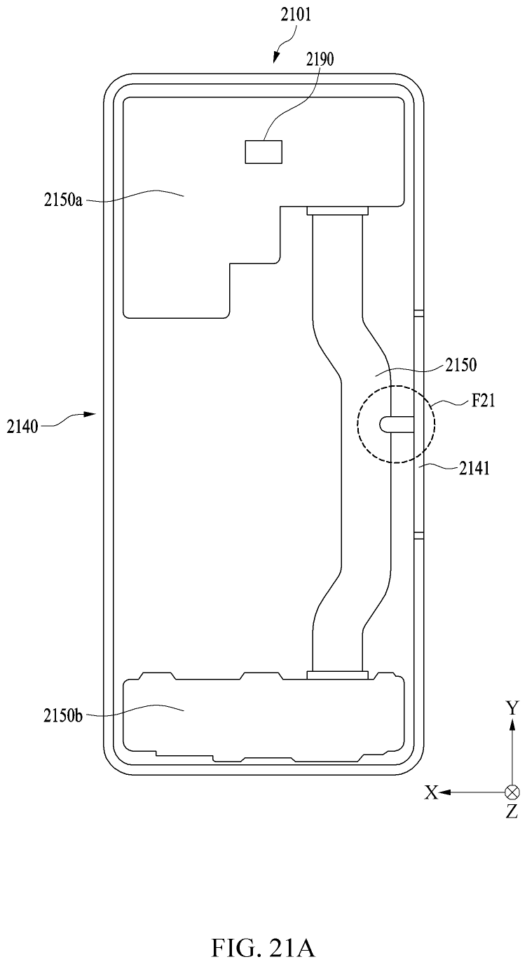

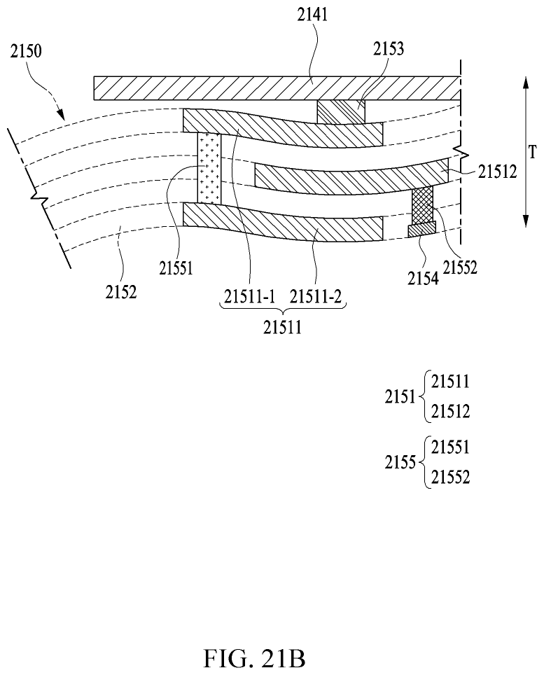

FIG. 21A is a diagram schematically illustrating a connection structure of a side member and a PCB in an electronic device according to an embodiment of the present disclosure. FIG. 21B is a partial cross-sectional view, illustrating area F21 of FIG. 21A.

Referring to FIGS. 21A and 21B, according to an embodiment, an electronic device 2101 may include a housing (e.g., the housing 210 in FIG. 2A), a plurality of PCBs 2150a and 2150b, a connecting PCB 2150 connecting the plurality of PCBs 2150a and 2150b, and a wireless communication circuit 2190 disposed on a first PCB 2150a.

In an embodiment, the housing may include a front surface (e.g., the front surface 210a in FIG. 2A), a rear surface (e.g., the rear surface 210b in FIG. 2B) opposite the front surface, and a side (e.g., the side 211c in FIG. 2A) enclosing an inner space between the front surface and the rear surface. In an embodiment, the side of the housing may include a side member 2140 (e.g., the side member 240 in FIG. 3) that forms at least a portion of the side and encloses the inner space. In an embodiment, the side member 2140 may include a conductive portion 2141 formed of a conductive material. In an embodiment, the conductive portion 2141 may function as a radiator of an antenna through which electrical signals flow.

In an embodiment, the electronic device 2101 may include a feed portion formed on the conductive portion 2141 and adapted to receive an electrical signal, or a ground portion adapted to function as a ground for the electrical signal.

In an embodiment, the plurality of PCBs 2150a and 2150b may be disposed in the inner space of the housing. For example, the plurality of PCBs 2150a and 2150b may include the first PCB 2150a and a second PCB 2150b spaced apart from each other. In an embodiment, the wireless communication circuit 2190 may be disposed on the first PCB 2150a.

In an embodiment, the connecting PCB 2150 may be connected to the first PCB 2150a and the second PCB 2150b to electrically connect the first PCB 2150a and the second PCB 2150b. In an embodiment, the connecting PCB 2150 may be at least partially connected to the conductive portion 2141. For example, the connecting PCB 2150 may be connected to a connective portion formed in the conductive portion 2141.

In an embodiment, the connecting PCB 2150 may be formed as a flexible PCB (FPCB). The connecting PCB 2150 may be at least partially bendable. In an embodiment, the connecting PCB 2150 may form an electrical path for an electrical signal delivery or transfer between the conductive portion 2141 and the wireless communication circuit 2190.

In an embodiment, the connecting PCB 2150 may include an electrical connection member 2153 electrically connected to the conductive portion 2151, and a signal line 2154 electrically connected to the wireless communication circuit 2190. The connecting PCB 2150 may include a plurality of coupling pads 2151 adapted to transfer electrical signals between the electrical connection member 2153 and the signal line 2154, and a plurality of conductive vias 2155 adapted to electrically connect the plurality of coupling pads 2151.

In an embodiment, the plurality of coupling pads 2151 may be disposed separately on layers of the connecting PCB 2150 via a dielectric 2152. In an embodiment, the plurality of coupling pads 2151 may include one or more first coupling pads 21511 connected to the electrical connection member 2153, and one or more second coupling pads 21512 connected to the signal line 2154. In an embodiment, the one or more first coupling pads 21511 and the one or more second coupling pads 21512 may be disposed to at least partially overlap along a first direction T of the connecting PCB 2150 to form a capacitance therebetween. For example, along the first direction T of the connecting PCB 2150, a second coupling pad 21512 may be disposed to at least partially overlap between a 1-1 coupling pad 21511-1 and a 1-2 coupling pad 21511-2. In an embodiment, the 1-1 coupling pad 21511-1 and the 1-2 coupling pad 21511-2 may be electrically connected through a first conductive via 21551. The second coupling pads 21512 may be directly connected to the signal line 2154 or may be connected thereto through a second conductive via 21552.

In an embodiment, the connecting PCB 2150 may be connected to the wireless communication circuit 2190 disposed on the first PCB 2150a via the signal line 2154 and may transfer electrical signals between the conductive portion 2141 and the signal line 2154 through a capacitance formed between the plurality of coupling pads 2151.

Hereinafter, embodiments of various forms of electronic devices will be described. In describing the various forms of electronic devices, it will be apparent to those of ordinary skill in the art that the structures of PCBs, for example, a method of connecting a conductive portion functioning as an antenna and a wireless communication circuit through the PCBs to which a coupled feeding structure (or coupled connection structure) by coupling pads is applied according to various embodiments described above, are applicable to the various forms of electronic devices to be described below. For example, it is to be noted that the structures of the PCBs and the methods for signal delivery between a conductive portion and a wireless communication circuit through the PCBs according to various embodiments described above with reference to FIGS. 4A through 21B are applicable to embodiments to be described below by readily changing, modifying, and combining the structures and methods by those of ordinary skill in the art.

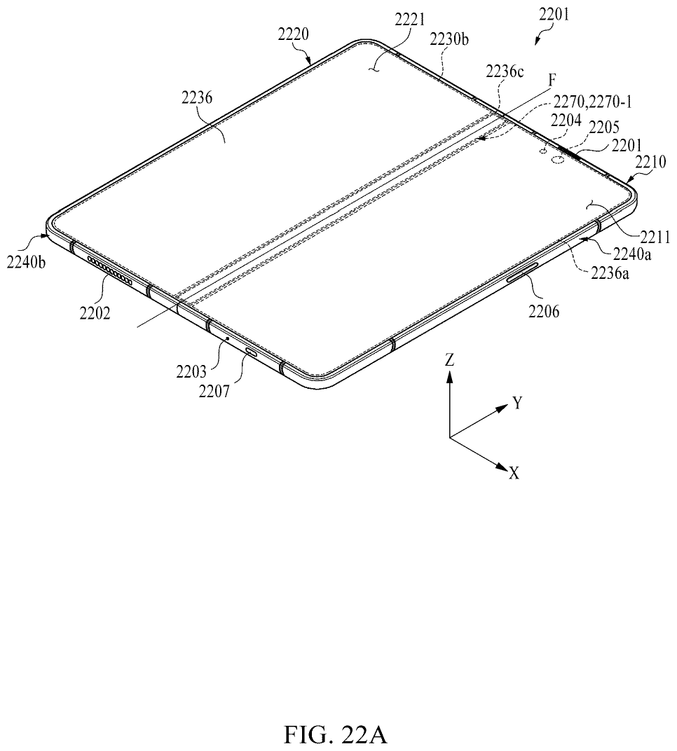

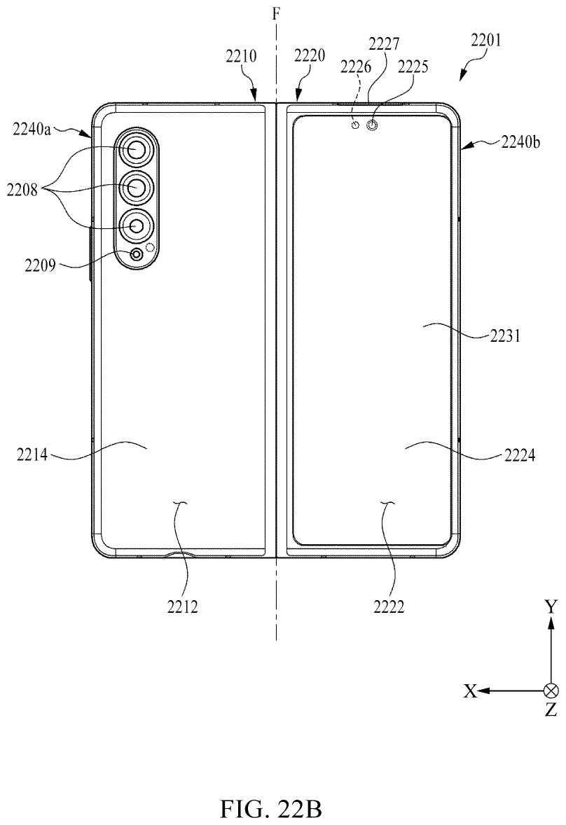

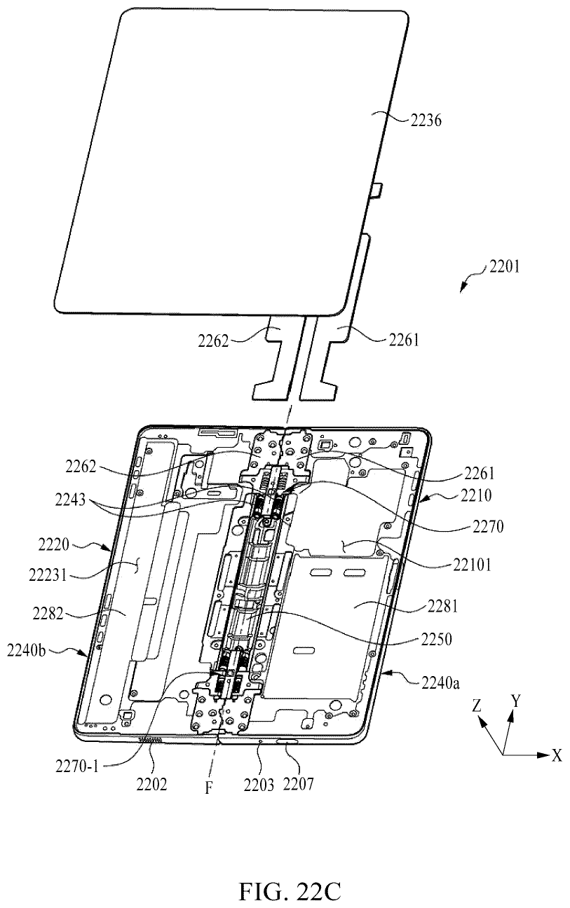

FIG. 22A is a front perspective view of an electronic device according to an embodiment of the present disclosure. FIG. 22B is a rear perspective view of an electronic device according to an embodiment of the present disclosure. FIG. 22C is an exploded perspective view of an electronic device according to an embodiment of the present disclosure.

Referring to FIGS. 22A, 22B, and 22C, according to an embodiment, an electronic device 2201 may include a first housing 2210 (e.g., a first housing structure 2210) and a second housing 2220 (e.g., a second housing structure 2220) that are foldable with respect to each other via at least one hinge device 2270 and 2270-1 (e.g., a hinge module or hinge structure) about a folding axis F. For example, the first housing 2210 and the second housing 2220 may be provided as a foldable housing (e.g., a foldable housing structure). In an embodiment, the first housing 2210 may include a first surface 2211 and a second surface 2212 facing an opposite direction (e.g., a −Z direction in FIG. 22A) to the first surface 2211. The second housing 2220 may include a third surface 2221 and a fourth surface 2222 facing an opposite direction (e.g., the −Z direction in FIG. 22A) to the third surface 2221. In an embodiment, the first housing 2210 may include a first side formed between the first surface 2211 and the second surface 2212. The second housing 2220 may include a second side formed between the third surface 2221 and the fourth surface 2222.

In an embodiment, the first housing 2210 may include a first side member 2240a (e.g., a first side bezel) that forms at least a portion of the first side. The first side member 2240a may include a conductive portion. In an embodiment, the first housing 2210 may include a first rear cover 2214 that is coupled to the first side member 2240a and forms the second surface 2212. In an embodiment, the second housing 2220 may include a second side member 2240b (e.g., a second side bezel) that forms at least a portion of the second side. The second side member 2240b may include a conductive portion. In an embodiment, the second housing 2220 may include a second rear cover 2224 that is coupled to the second side member 2240b and forms the fourth surface 2222.

In an embodiment, the electronic device 2201 may change its shape as relative angles of the first housing 2210 and the second housing 2220 change about the folding axis F. For example, the electronic device 2201 may change the shape between a first state (e.g., an unfolded or unfolding state) in which the first surface 2211 and the second surface 2212 are fully unfolded such that they are substantially on the same plane and a second state (e.g., a folded or folding state) in which the first surface 2211 and the second surface 2212 are fully folded inwardly such that they face each other or are fully folded outwardly such that they face in opposite directions. In an embodiment, the electronic device 2201 may be operable to have the shape of a third state (e.g., an intermediately unfolded state) between the first state and the second state.

In an embodiment, the electronic device 2201 may include a first receiver 2200 disposed through the first surface 2211 of the first housing 2210, at least one first sensor module 2204 (e.g., an illuminance sensor), and/or at least one first camera module 2205 (e.g., an under-display camera (UDC)). In an embodiment, the electronic device 2201 may include at least one button 2206 formed on the first side member 2240a. In an embodiment, the electronic device 2201 may include at least one second camera module 2208 and/or a flash 2209 disposed through the second surface 2212 (e.g., the first rear cover 2214) of the first housing 2210.

In an embodiment, the electronic device 2201 may include a first display 2236 (e.g., a flexible, foldable, or main display 2236) supported by the first housing 2210 and the second housing 2220 and disposed to be visually visible through the first surface 2211 and the third surface 2221.

In an embodiment, the first display 2236 may include a first area 2236a (e.g., a first flat portion) corresponding to at least a portion of the first surface 2211, a second area 2236b (e.g., a second flat portion) corresponding to at least a portion of the third surface 2221, and a folding area 2236c (e.g., a folding portion) connecting the first area 2236a and the second area 2236b and changing in shape in a folding process of the electronic device 2201. In an embodiment, the folding area 2236c may be disposed at a position at which it overlaps at least partially with the at least one hinge device 2270 and 2270-1 when the first display 2236 is viewed from above (e.g., in the +Z direction in FIG. 22A). For example, the first display 2236 may be disposed such that it is not visible from the outside in the second state of the electronic device 2201 in which the first surface 2211 and the third surface 2221 face each other (e.g., in the case of an in-folding type). For example, the first display 2236 may be disposed such that it is visible to the outside in the second state of the electronic device 2201 in which the first surface 2211 and the third surface 2221 face opposite directions (e.g., in the case of an out-folding type).

In an embodiment, the electronic device 2201 may include a second display 2231 (e.g., a secondary display), at least one third camera module 2225, at least one second sensor module 2226, and/or a second receiver 2227 disposed through the fourth surface 2222 of the second housing 2220. For example, the second display 2231 may be disposed to be externally visible through at least a portion of the second rear cover 2224. In an embodiment, the electronic device 2201 may include a speaker 2202 disposed through the second side member 2240b, and a microphone 2203 and/or a connector port 2207 disposed through the first side member 2240a. At least some of the components described above may be repositioned and/or modified between the first housing 2210 and/or the second housing 2220.

In an embodiment, the at least one hinge device 2270 and 2270-1 may be disposed under the first display 2236 (e.g., in a −Z direction in FIG. 22C) and may connect the first housing 2210 and the second housing 2220. For example, the at least one hinge device 2270 and 2270-1 may include a first hinge device 2270 disposed along the folding axis F and a second hinge device 2270-1 spaced apart from the first hinge device 2270. In an embodiment, the first hinge device 2270 may be formed in a substantially symmetrical or substantially identical configuration with respect to the second hinge device 2270-1. For example, the at least one hinge device 2270 and 2270-1 may be supported by a first support member 2281 extending from the first side member 2240a to a first space 22101 of the first housing 2210 and by a second support member 2282 extending from the second side member 2240b to a second space 22201 of the second housing 2220. In an embodiment, the at least one hinge device 2270 and 2270-1 may be covered by a hinge housing 2250, between the first housing 2210 and the second housing 2220, such that it is not visible from the outside.

In an embodiment, the hinge device (e.g., 2270 or 2270-1) may include gear assembly 2243 that connects a first rotating member 2251 (e.g., a first arm or first rotator) disposed on the first support member 2281 of the first housing and a second rotating member 2242 (e.g., a second arm or second rotator) disposed on the second support member 2282 of the second housing 2220 to rotate symmetrically with respect to each other. For example, the gear assembly 2243 may include a plurality of gears (e.g., spur gears and/or worm gears) that are geared with respect to each other. For example, the gear assembly 2243 may include a cam coupling structure and/or spring structure to press the first housing 2210 and the second housing 2220 at a certain angle relative to each other, in a direction for a transition from the first state to the second state or in a direction for a transition from the second state to the first state.

In an embodiment, the electronic device 2201 may include at least one detent module adapted to interlock with the at least one hinge device 2270 and 2270-1 and provide a stop at various folding angles of the electronic device 2201. For example, the at least one hinge device 2270 and 2270-1 and/or the detent module may form substantially the same plane as the first support member 2281 and the second support member 2282 when the electronic device 2201 is in the first state.

In an embodiment, the electronic device 2201 may include a first hinge plate 2261 connected to the first support member 2281 and/or the first rotating member 2251. The electronic device 2201 may include a second hinge plate 2262 connected to the second support member 2282 and/or the second rotating member 2252. For example, the at least one hinge device 2270 and 2270-1, the first rotating member 2251, the second rotating member 2252, the first hinge plate 2261, and the second hinge plate 2262 may form substantially the same plane with the first support member 2281 and the second support member 2282 when the electronic device 2201 is in the first state.

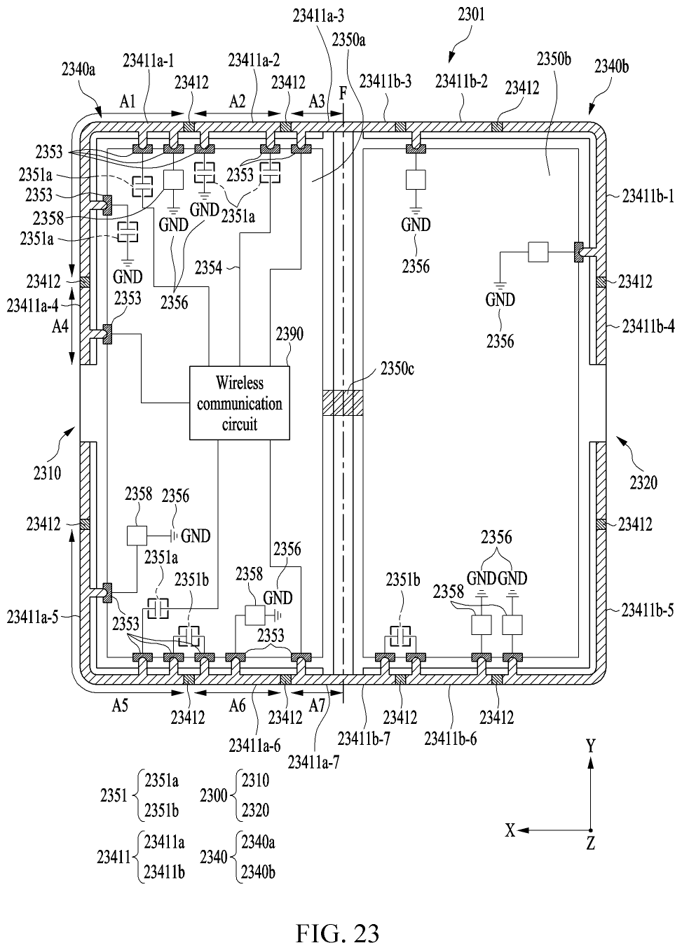

FIG. 23 is a diagram schematically illustrating a connection structure of a side member and a PCB in an electronic device according to an embodiment of the present disclosure.

Referring to FIG. 23, according to an embodiment, an electronic device 2301 (e.g., the electronic device 2201 in FIG. 22A through 22C) may include a housing structure 2300 including a first housing 2310 and a second housing 2320 mutually rotatable about a folding axis F, a first PCB 2350a disposed in the first housing 2310, a second PCB 2350b disposed in the second housing 2320, a connecting PCB 2350c (e.g., an FPCB) connecting the first PCB 2350a and the second PCB 2350b across the folding axis F, and a wireless communication circuit 2390.

In an embodiment, the first housing 2310 and the second housing 2320 may be mutually rotatable about the folding axis F. In an embodiment, the housing structure 2300 may include side members 2340 enclosing an inner space of the electronic device 2301. For example, the first housing 2310 and the second housing 2320 may include a first side member 2340a and a second side member 2340b, respectively, which form respective sides enclosing the inner space of the electronic device 2301. In an embodiment, the first side member 2340a and the second side member 2340b may each include a plurality of conductive portions 23411 including a conductive material. In an embodiment, at least some of the conductive portions 23411 may function as a radiator through which electrical signals flow. In an embodiment, the conductive portions 23411 may include first conductive portions 23411a disposed on the first housing 2310 and second conductive portions 23411b disposed on the second housing 2320. In an embodiment, the first side member 2340a and the second side member 2340b may include insulative portions 23412 formed of an insulative material. The insulative portions 23412 may physically separate adjacent conductive portions 23411 from each other. The conductive portions 23411 that are physically separated by the insulative portions 23412 may form an electrical path through which electrical signals flow. In an embodiment, the first side member 2340a and the second side member 2340b may include one or more connective portions formed on each of the conductive portions 23411 and adapted to be connected to the PCBs 2350a and 2350b.

In an embodiment, at least some of the plurality of conductive portions 23411 may be connected to the wireless communication circuit 2390 via the PCBs 2350a and 2350b and may each form an antenna region for transmitting and receiving wireless (or radio) signals in a frequency band corresponding to a length of a path through which electrical signal flows. For example, the first conductive portions 23411a formed on the first side member 2340a may be connected to the wireless communication circuit 2390 to function as an antenna, and the second conductive portions 23411b formed on the second side member 2340b may not be connected to the wireless communication circuit 2390. However, it is to be noted that this is provided only as an example and that at least some of the second conductive portions 23411b may be connected to the wireless communication circuit 2390 to form an antenna region.

Hereinafter, an example of using some of the conductive portions 23411 of the electronic device 2301 as an antenna through a connection structure of the conductive portions 23411 and the wireless communication circuit 2390 shown in FIG. 23 will be described for ease of description, but it is to be noted that the length and arrangement of each of the conductive portions 23411 formed on the electronic device 2301, and a connection structure thereof with the wireless communication circuit 2390 and a ground 2356 are not limited to the example.

In an embodiment, the first conductive portions 23411a formed on the first side member 2340a may include a 1-1 conductive portion 23411a-1, a 1-2 conductive portion 23411a-2, a 1-3 conductive portion 23411a-3, a 1-4 conductive portion 23411a-4, a 1-5 conductive portion 23411a-5, a 1-6 conductive portion 23411a-6, and/or a 1-7 conductive portion 23411a-7. In an embodiment, the second conductive portions 23411b formed on the second side member 2340b may include a 2-1 conductive portion 23411b-1, a 2-2 conductive portion 23411b-2, a 2-3 conductive portion 23411b-3, a 2-4 conductive portion 23411b-4, a 2-5 conductive portion 23411b-5, a 2-6 conductive portion 23411b-6, and/or a 2-7 conductive portion 23411b-7.

In an embodiment, the lengths and arrangements of the first conductive portions 23411a formed on the first side member 2340a and the second conductive portions 23411b formed on the second side member 2340b may be formed to be mutually symmetrical about the folding axis F. For example, at least some of the first conductive portions 23411a and the second conductive portions 23411b that face each other in a folded state of the electronic device 2301 may be formed to have substantially the same length such that they are mutually symmetrical about the folding axis F. For example, the 1-1 conductive portion 23411a-1 and the 2-1 conductive portion 23411b-1 may be mutually symmetrical about the folding axis F. For example, the 1-2 conductive portion 23411a-2 and the 2-2 conductive portion 23411b-2 may be mutually symmetrical about the folding axis F. For example, the 1-3 conductive portion 23411a-3 and the 2-3 conductive portion 23411b-3 may be mutually symmetrical about the folding axis F. For example, the 1-4 conductive portion 23411a-4 and the 2-4 conductive portion 23411b-4 may be mutually symmetrical about the folding axis F. For example, the 1-5 conductive portion 23411a-5 and the 2-5 conductive portion 23411b-5 may be mutually symmetrical about the folding axis F. For example, the 1-6 conductive portion 23411a-6 and the 2-6 conductive portion 23411b-6 may be mutually symmetrical about the folding axis F. For example, the 1-7 conductive portion 23411a-7 and the 2-7 conductive portion 23411b-7 may be mutually symmetrical about the folding axis F.

In an embodiment, in a case where at least some of the first conductive portions 23411a and the second conductive portions 23411b are formed symmetrically about the folding axis F, the antenna performance degradation of the symmetrical conductive portions due to electrical signals introduced into conductive portions that do not function as an antenna may be reduced or prevented. For example, as shown in FIG. 23, assuming that the 1-1 conductive portion 23411a-1 and the 2-1 conductive portion 23411b-1 are mutually symmetrical about the folding axis F, and the 1-1 conductive portion 23411a-1 is connected to the wireless communication circuit 2390 and the 2-1 conductive portion 23411b-1 is not connected to the wireless communication circuit 2390, a frequency band of an electrical path formed by electrical signals (e.g., unintended electrical signals) introduced into the 2-1-conductive portion 23411b-1 may be formed to be similar to a frequency band of an electrical path formed by electrical signals applied to the 1-1-conductive portion 23411a-1, and it may thus be possible to reduce the antenna performance degradation through the 1-1 conductive portion 23411a-1. Additionally, in a case where a first conductive portion (e.g., the 1-1 conductive portion 23411a-1) and a second conductive portion (e.g., the 2-1 conductive portion 23411b-1) that face each other have mutually symmetrical lengths and arrangements, while the electronic device 2301 is used in the folded state, a change in an electrical path through which electrical signals flow may be minimized or prevented even when an electrical signal applied to the first conductive portion (e.g., the 1-1 conductive portion 23411a-1) is transferred to the corresponding second conductive portion (e.g., the 2-1 conductive portion 23411b-1), and it may thus be possible to minimize or prevent the electrical signal applied to the second conductive portion (e.g., the 2-1 conductive portion 23411b-1) from degrading the antenna performance through the first conductive portion (e.g., the 1-1 conductive portion 23411a-1). It is to be noted that, although the preceding example is described with the 1-1 conductive portion 23411a-1 and the 2-1 conductive portion 23411b-1, this is provided for ease of description and may be applied substantially equally to the first conductive portions 23411a and the second conductive portions 23411b that are mutually symmetrical to each other.

In an embodiment, the wireless communication circuit 2390 may be disposed on the first PCB 2350a (e.g., a main PCB), but may alternatively be disposed on the second PCB 2350b or on another PCB. Alternatively, the wireless communication circuit 2390 may be disposed on both the first PCB 2350a and the second PCB 2350b.

In an embodiment, the first PCB 2350a and/or the second PCB 2350b may include at least one electrical connection member 2353. In an embodiment, the first PCB 2350a may be electrically connected to the connective portion 2353 formed on the first conductive portions 23411a via the electrical connection member 2353, and may thereby be electrically connected to the first conductive portions 23411a. The second PCB 2350b may be electrically connected to the connective portion 2353 formed on the second conductive portions 23411b via the electrical connection member 2353, and may thereby be electrically connected to the second conductive portions 23411b.

In an embodiment, a PCB (e.g., 2350a and 2350b) may include one or more coupled feeding structures 2351 (or coupling connection structures) for electrical signal delivery. In an embodiment, the coupled feeding structures 2351 may include one or more first coupling pads (e.g., the first coupling pads 5511 in FIG. 5A) and one or more second coupling pads (e.g., the second coupling pads 5512 in FIG. 5B) disposed on different layers of the PCB and separated from each other. In an embodiment, the coupled feeding structures 2351 may transfer electrical signals through a capacitance formed between the first coupling pads and the second coupling pads. In an embodiment, the coupled feeding structures 2351 may be implemented by the arrangements and connection structures of a plurality of coupling pads described above according to various embodiments with reference to FIGS. 4A through 21B.

In an embodiment, the coupled feeding structures 2351 may include a first coupled feeding structure 2351a for forming an electrical path between the conductive portions 23411 and the wireless communication circuit 2390, and/or a second coupled feeding structure 2351b for forming an electrical path between a pair of adjacent conductive portions 23411.

In an embodiment, the first coupled feeding structure 2351a may form the electrical path with the conductive portions 23411 through at least one first coupling pad and the electrical path with the wireless communication circuit 2390 or the ground 2356 through at least one second coupling pad. In an embodiment, the first coupled feeding structure 2351a may transfer electrical signals between the conductive portions 23411 and the wireless communication circuit 2390 or between the conductive portions 23411 and the ground 2356, through a capacitance formed between the at least one first coupling pad and the at least one second coupling pad. In an embodiment, the first coupled feeding structure 2351a may prevent a direct electrical signal delivery (or transfer) between the conductive portions 23411 and the wireless communication circuit 2390 and may thereby implement an ESD blocking function that prevents or reduces a delivery or transfer of electrostatic or noise signals from the conductive portions 23411 to the wireless communication circuit 2390. In an embodiment, the first coupled feeding structure 2351a may include a discharge inductive portion (e.g., the discharge inductive portion 557D in FIG. 5D) adapted to induce electrostatic or noise signals transferred from the conductive portions 23411 to a first coupling pad to be discharged to the ground 2356. In an embodiment, the discharge inductive portion may be implemented by the arrangements and structures of a discharge inductive portion described above according to various embodiments with reference to FIGS. 5A through 5H.

In an embodiment, the second coupled feeding structure 2351b (e.g., the coupled feeding structure 1651 in FIG. 16A) may form an electrical path for electrical signals to move between a pair of adjacent conductive portions 23411 separated from each other via an insulative portion 23412. For example, the second coupled feeding structure 2351b may form an electrical path with one conductive portion (e.g., the 1-5 conductive portion 23511a-5) of the pair of adjacent conductive portions (e.g., the 1-5 conductive portion 23511a-5 and the 1-6 conductive portion 23511a-6) through at least one first coupling pad, and form an electrical path with the other conductive portion (e.g., the 1-6 conductive portion 23511a-6) through at least one second coupling pad. In an embodiment, the second coupled feeding structure 2351b may transfer electrical signals between the pair of adjacent conductive portions (e.g., the 1-5 conductive portion 23511a-5 and the 1-6 conductive portion 23511a-6) through a capacitance formed between the first coupling pad and the second coupling pad. For example, the second coupled feeding structure 2351b may use, as a single radiator, the pair of conductive portions (e.g., the 1-5 conductive portion 23511a-5 and the 1-6 conductive portion 23511a-6) that are separated from each other.

In an embodiment, each of the first conductive portions 23411a formed on the first side member 2340a may be connected to the wireless communication circuit 2390 and form antenna regions through which electrical signals corresponding to different frequency bands flow. For example, the 1-1 conductive portion 23411a-1 may form a first antenna region A1. The 1-2 conductive portion 23411a-2 may form a second antenna region A2. The 1-3 conductive portion 23411a-3 may form a third antenna region A3. The 1-4 conductive portion 23411a-4 may form a fourth antenna region A4. The 1-5 conductive portion 23411a-5 may form a fifth antenna region A5. The 1-6 conductive portion 23411a-6 may form a sixth antenna region A6. The 1-7 conductive portion 23411a-7 may form a seventh antenna region A7.

In an embodiment, of the plurality of antenna regions, some antenna regions, for example, A1, A2, and A5, may be used to transmit and receive wireless (or radio) signals in a specific frequency band (e.g., a frequency band of 3 GHz or above). For example, the first antenna region A1, the second antenna region A2, and the fifth antenna region A5 may function as an antenna for transmitting and receiving wireless signals in an UHB (e.g., a frequency band from 6 GHz to 10 GHz). In an embodiment, the 1-1 conductive portion 23411a-1 forming the first antenna region A1, the 1-2 conductive portion 23411a-2 forming the second antenna region A2, and the 1-5 conductive portion 23411a-5 forming the fifth antenna region A5 may be connected to the wireless communication circuit 2390 or the ground 2356 via the first coupled feeding structure 2351a. In an embodiment, applying electrical signals to conductive portions (e.g., 23411a-1, 23411a-2, and 23411a-5) via the first coupled feeding structure 2351a, or grounding electrical signals from the conductive portions (e.g., 23411a-1, 23411a-2, and 23411a-5), may minimize or reduce a loss of electrical signals that may occur in a high-frequency band (e.g., UHB) and omit an additional element (e.g., an ESD protection element 2358) for removing an ESD during an electrical signal delivery (or transfer).

In an embodiment, the conductive portions (e.g., 23411a-1, 23411a-2, and 23411a-5) forming the antenna regions (e.g., A1, A2, and A5) that are connected to the wireless communication circuit 2390 via the first coupled feeding structure 2351a may be disposed more on an upper side (e.g., a portion of the first side member 2340a adjacent to a +Y direction) of the electronic device 2301 than on a lower side (e.g., a portion of the first side member 2340a adjacent to a −Y direction) of the electronic device 2301 based on a usage state of the electronic device 2301. In an embodiment, the antenna regions connected to the wireless communication circuit 2390 via the first coupled feeding structure 2351a may be disposed adjacent to a housing region (e.g., the first housing 2310) in which a main PCB (e.g., the first PCB 2350a) is disposed. For example, the main PCB may be a circuit board on which an application processor (AP), a communication processor (CP), or the like is disposed. For example, in a case where the main PCB is the first PCB 2350a, the antenna regions (e.g., A1, A2, and A5) connected to the wireless communication circuit 2390 via the first coupled feeding structure 2351a may be disposed more on the first side member 2340a of the first housing 2310 compared to the second side member 2340b of the second housing 2320, as shown in FIG. 23. In this case, the antenna regions connected to the wireless communication circuit 2390 via the first coupled feeding structure 2351a may not be disposed on the second side member 2340b of the second housing 2320. In an embodiment, antenna regions connected to the wireless communication circuit 2390 via the first coupled feeding structure 2351a may be disposed adjacent to a camera module (e.g., the second camera module 2208 in FIG. 22B). For example, in a case where, as shown in FIG. 22B, the camera module is disposed adjacent to the upper side (e.g., the portion of the first side member 2340a adjacent to the +Y direction), compared to the lower side (e.g., the portion of the first side member 2340a adjacent to the −Y direction) of the electronic device 2301, more antenna regions to be connected to the wireless communication circuit 2390 via the first coupled feeding structure 2351a may be disposed on the portion of the first side member 2340a adjacent to the upper side compared to the lower side of the electronic device 2301. In this case, the antenna regions connected to the wireless communication circuit 2390 via the first coupled feeding structure 2351a may not be disposed on the portion of the first side member 2340a adjacent to the lower side of the electronic device 2301.

However, the preceding embodiments are provided only as examples, and the arrangement and number of antenna regions (e.g., A1, A2, and A5) connected to the wireless communication circuit 2390 via the first coupled feeding structure 2351a are not limited thereto.

In an embodiment, at least some (e.g., A1 and A5) of the antenna regions (e.g., A1, A2, and A5) connected to the wireless communication circuit 2390 via the first coupled feeding structure 2351a may additionally include a connection path that is directly connected to the wireless communication circuit 2390 or to the ground 2356 to enable transmission and reception of wireless signals of a specific frequency band (e.g., a frequency band of 3 GHz or below). For example, as shown in FIG. 23, the 1-1 conductive portion 23411a-1 forming the first antenna region A1 and the 1-5 conductive portion 23411a-5 forming the fifth antenna region A5 may be directly connected to the wireless communication circuit 2390 or the ground 2356 through a signal deliver path on which the ESD protection element 2358 is disposed, independent of a signal deliver path formed by the first coupled feeding structure 2351a. In this case, the first antenna region A1 or the fifth antenna region A5 may be connected to the wireless communication circuit 2390 or the ground 2356 through the signal deliver path formed by the first coupled feeding structure 2351a or the signal deliver path including the ESD protection element 2358, depending on a frequency band of a wireless signal to be transmitted or received.

In an embodiment, of the plurality of antenna regions, some antenna region (e.g., the antenna region A6) may be connected to the wireless communication circuit 2390 or the ground 2356 through the signal deliver path including the ESD protection element 2358 for transmitting and receiving wireless signals in a specific frequency band (e.g., a frequency band of 3 GHz or below). For example, the 1-6 conductive portion 23411a-6 forming the sixth antenna region A6 may be directly connected to the wireless communication circuit 2390 or the ground 2356 through the signal deliver path on which the ESD protection element 2358 is disposed.

In an embodiment, some (e.g., 23411a-3, 23411a-4, and 23411a-7) of conductive portions 23411a forming the antenna regions may be connected to a ground (e.g., ground of the electronic device) by contacting a conductive structure (e.g., the support member 2282 or the hinge plate 2262 in FIG. 22C, etc.) of the electronic device 2301. For example, the 1-3 conductive portion 23411a-3 forming the third antenna region A3, and the 1-7 conductive portion 23411a-7 forming the seventh antenna region A7 may be in contact with a hinge plate to be connected to the ground without a separate signal deliver path leading to the first PCB 2350a. For example, the 1-4 conductive portion 23411a-4 forming the fourth antenna region A4 may be in contact with a support member (e.g., the support member 2282) to be connected to the ground without a separate signal deliver path leading to the first PCB 2350a. In an embodiment, the conductive portions 23411a-3, 23411a-4, and 23411a-7 forming the antenna regions A3, A4, and A7 that are directly connected to the ground may be connected to the wireless communication circuit 2390 through a signal deliver path with the ESD protection element 2358 omitted therefrom.

In an embodiment, the 1-5 conductive portion 23411a-5 forming the fifth antenna region A5 and the 1-6 conductive portion 23411a-6 forming the sixth antenna region A6 may be connected to transmit and receive electrical signals through the second coupled feeding structure 2351b. In this case, the 1-5 conductive portion 23411a-5 and the 1-6 conductive portion 23411a-6 may function as a single radiator through the second coupled feeding structure 2351b. For example, an electrical signal applied to the 1-5 conductive portion 23411a-5 may move through the second coupled feeding structure 2351b to the 1-6 conductive portion 23411a-6 to form an electrical path that flows at least a portion of the 1-5 conductive portion 23411a-5 and at least a portion of the 1-6 conductive portion 23411a-6.

In an embodiment, the second conductive portions 23411b may not be connected to the wireless communication circuit 2390. At least some (e.g., 23411b-1, 23411b-2, 23411b-5, and 23411b-6) of the second conductive portions 23411b may transfer an applied electrical signal or noise signal to the ground 2356 through the signal deliver path including the ESD protection element 2358. At least some (e.g., 23411b-3, 23411b-4, and 23411b-7) of the second conductive portions 23411b may be connected to the ground by contacting a conductive structure (e.g., the support member 2282 or the hinge plate 2262 in FIG. 22C, etc.) of the electronic device 2301.

In an embodiment, at least one pair of conductive portions adjacent to each other among the plurality of second conductive portions 23411b may be connected to transfer electrical signals via the second coupled feeding structure 2351b. For example, the 2-6 conductive portion 23411b-6 and the 2-7 conductive portion 23411b-7 may be electrically connected via the second coupled feeding structure 2351b. In this case, an electrical signal (e.g., a noise signal) applied to a portion of the 2-6 conductive portion 23411b-6 adjacent to the 2-7 conductive portion 23411b-7 may be transferred to the 2-6 conductive portion 23411b-6 through the second coupled feeding structure 2351b to escape to the ground. The electrical signal (e.g., the noise signal) applied to the 2-6 conductive portion 23411b-6 adjacent to the 2-5 conductive portion 23411b-5 may escape to the ground 2356 through the signal deliver path on which the ESD protection element 2358 is disposed.

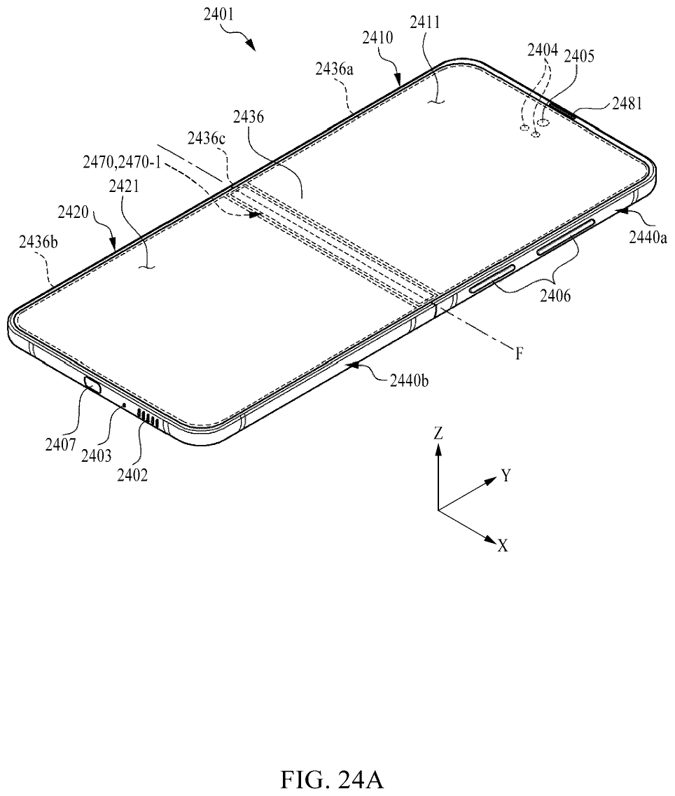

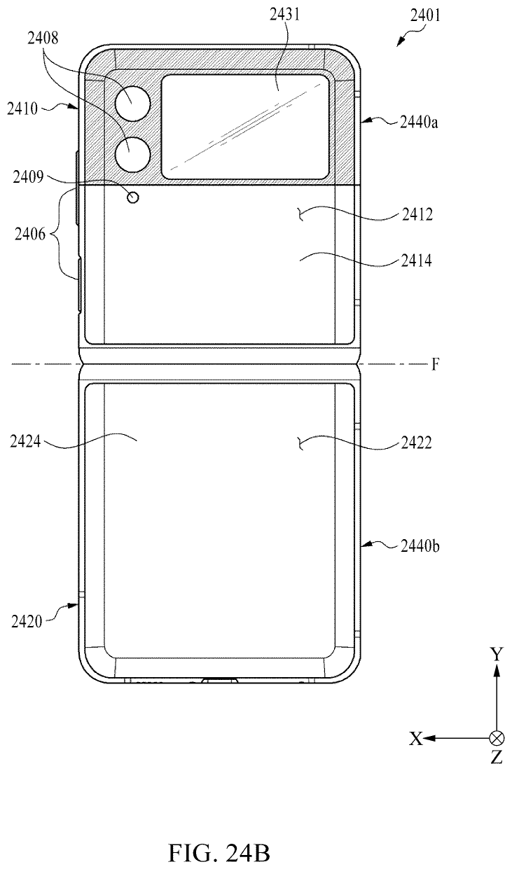

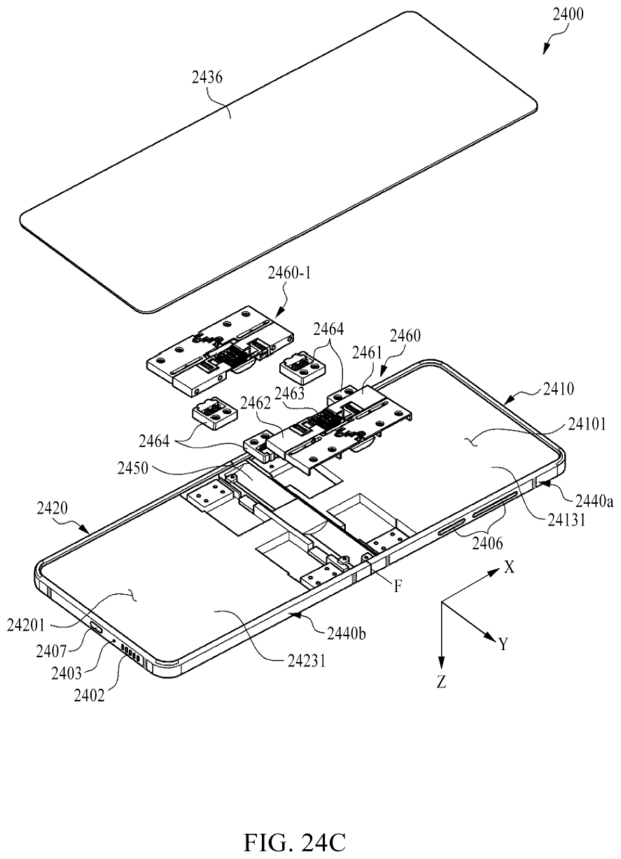

FIG. 24A is a front perspective view of an electronic device according to an embodiment of the present disclosure. FIG. 24B is a rear perspective view of an electronic device according to an embodiment of the present disclosure. FIG. 24C is an exploded perspective view of an electronic device according to an embodiment of the present disclosure.

Referring to FIGS. 24A, 24B, and 24C, according to an embodiment, an electronic device 2401 may include a first housing 2410 (e.g., a first housing structure) and a second housing 2420 (e.g., a second housing structure) that are foldable with respect to each other via at least one hinge device 2460 and 2460-1 (e.g., a hinge module or hinge structure) about a folding axis F. For example, the first housing 2410 and the second housing 2420 may be implemented as a foldable housing (e.g., a housing structure). In an embodiment, the first housing 2410 may include a first surface 2411 and a second surface 2412 facing an opposite direction to the first surface 2411 (e.g., a −Z direction in FIG. 22A). The second housing 2420 may include a third surface 2421 and a fourth surface 2422 facing an opposite direction to the third surface 2421 (e.g., the −Z direction in FIG. 22A). In an embodiment, the first housing 2410 may include a first side formed between the first surface 2411 and the second surface 2412. The second housing 2420 may include a second side formed between the third surface 2421 and the fourth surface 2422.

In an embodiment, the first housing 2410 may include a first side member 2440a (e.g., a first side bezel) forming at least a portion of the first side. The first side member 2440a may include a conductive portion. In an embodiment, the first housing 2410 may include a first rear cover 2414 connected to the first side member 2440a and forming the second surface 2412. In an embodiment, the second housing 2420 may include a second side member 2440b (e.g., a second side bezel) forming at least a portion of the second side. The second side member 2440b may include a conductive portion. In an embodiment, the second housing 2420 may include a second rear cover 2424 connected to the second side member 2440b and forming the fourth surface 2422.

In an embodiment, the electronic device 2401 may change in shape as relative angles of the first housing 2410 and the second housing 2420 change about the folding axis F. For example, the electronic device 2401 may change in shape between a first state (e.g., an unfolded or unfolding state) in which the first surface 2411 and the second surface 2412 are fully unfolded such that the first surface 2411 and the second surface 2412 are substantially on the same plane, and a second state (e.g., a folded or folding state) in which the first surface 2411 and the second surface 2412 are fully folded inwardly such that the first surface 2411 and the second surface 2412 face each other or are fully folded outwardly such that they face in opposite directions. In an embodiment, the electronic device 2401 may operate to have a shape of a third state (e.g., an intermediately unfolded state) between the first state and the second state.

In an embodiment, the electronic device 2401 may include a first receiver 2481 disposed through the first surface 2411 of the first housing 2410, at least one first sensor module 2404 (e.g., an illuminance sensor), and/or at least one first camera module 2405 (e.g., an UDC). In an embodiment, the electronic device 2401 may include at least one button 2406 formed on the first side member 2440a. In an embodiment, the electronic device 2401 may include at least one second camera module 2408 and/or a flash 2409 disposed through the second surface 2412 (e.g., the first rear cover 2414) of the first housing 2410.

In an embodiment, the electronic device 2401 may include a first display 2436 (e.g., a flexible, foldable, or main display 2436) supported by the first housing 2410 and the second housing 2420 and disposed to be visually visible through the first surface 2411 and the third surface 2421.

In an embodiment, the first display 2436 may include a first area 2436a (e.g., a first flat portion) corresponding to at least a portion of the first surface 2411, a second area 2436b (e.g., a second flat portion) corresponding to at least a portion of the third surface 2421, and a folding area 2436c (e.g., a folding portion) connecting the first area 2436a and the second area 2436b and changing in shape in a folding process of the electronic device 2401. In an embodiment, the folding area 2436c may be disposed at a position where it at least partially overlaps the at least one hinge device 2460 and 2460-1, when the first display 2436 is viewed from above (e.g., in the +Z direction in FIG. 22A). For example, the first display 2436 may be disposed not to be visible from the outside, in the second state of the electronic device 2401 in which the first surface 2411 and the third surface 2421 face each other (e.g., in the case of an in-folding type). For example, the first display 2436 may be disposed to be visible to the outside, in the second state of the electronic device 2401 in which the first surface 2411 and the third surface 2421 face opposite directions (e.g., in the case of an out-folding type).

In an embodiment, the electronic device 2401 may include a second display 2431 (e.g., a secondary display), at least one third camera module 2408, at least one second sensor module 2409, and/or a second receiver, which are disposed through the third surface 2421 of the first housing 2410. For example, the second display 2431 may be disposed to be externally visible through at least a portion of the first rear cover 2414. In an embodiment, the electronic device 2401 may include a speaker 2402 disposed through the second side member 2440b, and a microphone 2403 and/or a connector port 2407 disposed through the first side member 2440a. At least some of the components described above may be repositioned and/or modified between the first housing 2410 and/or the second housing 2420.

In an embodiment, at least one hinge device 2460 and 2460-1 may be disposed under the first display 2436 (e.g., in a −Z direction in FIG. 24C) and may connect the first housing 2410 and the second housing 2420. For example, the at least one hinge device 2460 and 2460-1 may include a first hinge device 2460 disposed along the folding axis F and a second hinge device 2460-1 spaced apart from the first hinge device (e.g., 2460 or 2460-1). In an embodiment, the first hinge device 2460 may be formed in a substantially symmetrical or substantially identical configuration to the second hinge device 2460-1. For example, the at least one hinge device 2460 and 2460-1 may be supported by a first support member 24131 extending from the first side member 2440a to a first space 24101 of the first housing 2410 and a second support member 24231 extending from the second side member 2440b to a second space 24201 of the second housing 2420. In an embodiment, the at least one hinge device 2460 and 2460-1 may be covered by a hinge housing 2450, between the first housing 2410 and the second housing 2420, such that it is not visible from the outside.

In an embodiment, the hinge devices (e.g., 2460 or 2460-1) may include a gear assembly 2463 that connect a first rotating member 2461 (e.g., a first arm or first rotator) disposed in the first support member 24131 of the first housing 2410 and a second rotating member 2462 (e.g., a second arm or second rotator) disposed in the second support member 24231 of the second housing 2420 to rotate symmetrically with respect to each other. For example, the gear assembly 2463 may include a plurality of gears (e.g., spur gears and/or worm gears) that are geared with respect to each other. For example, the gear assembly 2463 may include a cam coupling structure and/or spring structure to press the first housing 2410 and the second housing 2420 at a certain angle relative to each other, in a direction for a transition from the first state to the second state or in a direction for a transition from the second state to the first state.

In an embodiment, the electronic device 2401 may include at least one detent module 2464 adapted to interlock with the at least one hinge device 2460 and 2460-1 and provide a stop at various folding angles of the electronic device 2401. For example, the at least one hinge device 2460 and 2460-1 and/or the detent module 2464 may form substantially the same plane as the first support member and the second support member when the electronic device 2401 is in the first state.

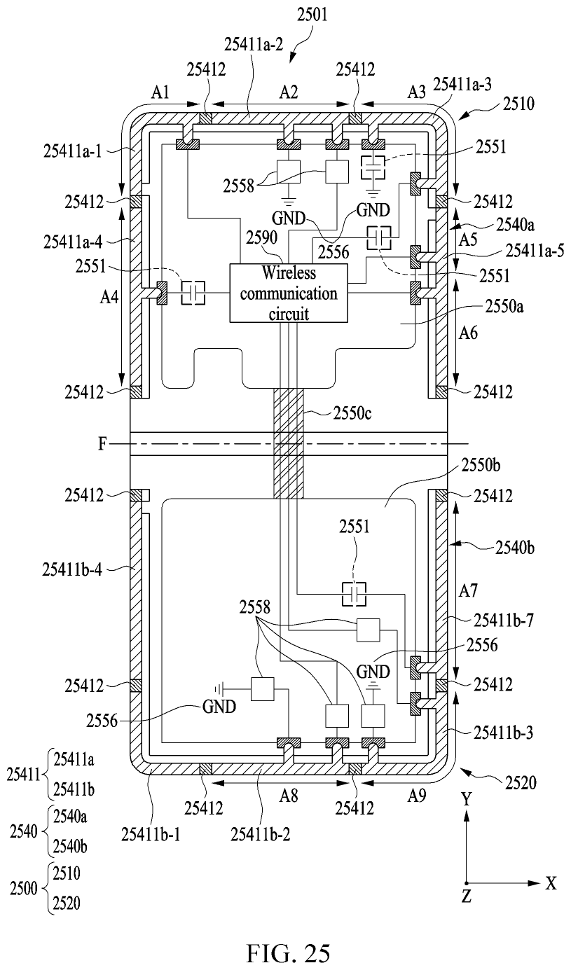

FIG. 25 is a diagram schematically illustrating a connection structure of a side member and a PCB in an electronic device according to an embodiment of the present disclosure. Referring to FIG. 25, according to an embodiment, an electronic device 2501 (e.g., the electronic device 2401 in FIG. 24) may include a housing structure 2500 including a first housing 2510 and a second housing 2520 mutually rotatable about a folding axis F, a first PCB 2550a disposed in the first housing 2510, a second PCB 2550b disposed in the second housing 2520, a connecting PCB 2550c (e.g., FPCB) connecting the first PCB 2550a and the second PCB 2550b, and a wireless communication circuit 2590.

In an embodiment, the first housing 2510 and the second housing 2520 may mutually rotate about the folding axis F. In an embodiment, the housing structure 2500 may include side members 2540 enclosing an inner space. For example, the first housing 2510 and the second housing 2520 may include a first side member 2540a and a second side member 2540b, respectively, that form respective sides enclosing the inner space. In an embodiment, the first side member 2540a and the second side member 2540b may each include a plurality of conductive portions 25411 including a conductive material. In an embodiment, at least some of the conductive portions 25411 may function as a radiator through which electrical signals flow. In an embodiment, the conductive portions 25411 may include first conductive portions 25411a disposed on the first housing 2510 and second conductive portions 25411b disposed on the second housing 2520. In an embodiment, the first side member 2540a and the second side member 2540b may include insulative portions 25412 formed of an insulative material. The insulative portions 25412 may physically separate adjacent conductive portions 25411 from each other. The conductive portions 25411 that are physically separated by the insulative portions 25412 may form an electrical path through which electrical signals flow. In an embodiment, the first side member 2540a and the second side member 2540b may include one or more connective portions formed on at least a portion of the conductive portions 25411 and adapted to be connected to the PCBs 2550a and 2550b.

In an embodiment, a portion of the plurality of conductive portions 25411 may be connected to the wireless communication circuit 2590 via the PCBs 2550a and 2550b and form antenna regions for transmitting and receiving wireless (or radio) signals in a frequency band corresponding to a length of a path through which electrical signal flows. Another portion of the plurality of conductive portions 25411 may not be connected to the wireless communication circuit 2590. Hereinafter, an example of using some of the conductive portions 25411 of the electronic device 2501 as an antenna based on a connection structure of the conductive portions 25411 and the wireless communication circuit 2590 shown in FIG. 25 will be described for ease of description, but it is to be noted that the length and arrangement of each of the conductive portions 25411 formed on the electronic device 2501, and a connection structure thereof with the wireless communication circuit 2590 and a ground 2556 are not limited to the example.

In an embodiment, the first conductive portions 25411a formed on the first side member 2540a may include a 1-1 conductive portion 25411a-1, a 1-2 conductive portion 25411a-2, a 1-3 conductive portion 25411a-3, a 1-4 conductive portion 25411a-4, and/or a 1-5 conductive portion 25411a-5. In an embodiment, the second conductive portions 25411b formed on the second side member 2540b may include a 2-1 conductive portion 25411b-1, a 2-2 conductive portion 25411b-2, a 2-3 conductive portion 25411b-3, a 2-4 conductive portion 25411b-4, and/or a 2-5 conductive portion 25411b-5.

In an embodiment, the length and arrangements of the first conductive portions 25411a formed on the first side member 2540a and the second conductive portions 25411b formed on the second side member 2540b may be formed to be mutually symmetrical about the folding axis F. For example, at least some of the first conductive portions 25411a and at least some of the second conductive portions 25411b that face each other in a folded state of the electronic device 2501 may be formed to have substantially the same length such that they are mutually symmetrical about the folding axis F. For example, the 1-1 conductive portion 25411a-1 and the 2-1 conductive portion 25411b-1 may be mutually symmetrical about the folding axis F. For example, the 1-2 conductive portion 25411a-2 and the 2-2 conductive portion 25411b-2 may be mutually symmetrical about the folding axis F. For example, the 1-3 conductive portion 25411a-3 and the 2-3 conductive portion 25411b-3 may be mutually symmetrical about the folding axis F. For example, the 1-4 conductive portion 25411a-4 and the 2-4 conductive portion 25411b-4 may be mutually symmetrical about the folding axis F. For example, the 1-5 conductive portion 25411a-5 and the 2-5 conductive portion 25411b-5 may be mutually symmetrical about the folding axis F. Although the first conductive portions 25411a and the second conductive portions 25411b are shown as being respectively symmetrical about the folding axis F, examples are not limited thereto.

In an embodiment, the wireless communication circuit 2590 may be disposed on the first PCB 2550a (e.g., a main PCB), but may alternatively be disposed on the second PCB 2550b or another PCB. Alternatively, the wireless communication circuit 2590 may be disposed on both the first PCB 2550a and the second PCB 2550b.

In an embodiment, the first PCB 2550a and the second PCB 2550b may each include at least one electrical connection member 2553. In an embodiment, the first PCB 2550a may be connected to the connective portions formed on the first conductive portions 25511a via the electrical connection member 2553 to form a signal deliver path with the first conductive portions 25411a. The second PCB 2550b may be connected to the connective portions formed on the second conductive portions 25411b via the electrical connection member 2553 to form a signal deliver path with a portion of the second conductive portions 25411b.

In an embodiment, a PCB (e.g., 2550a and 2550b) may include at least one coupled feeding structure 2551 (or coupling connection structure) for an electrical signal delivery or transfer. In an embodiment, the coupled feeding structure 2551 may include one or more first coupling pads (e.g., the first coupling pads 5511 in FIG. 5A) and one or more second coupling pads (e.g., the second coupling pads 5512 in FIG. 5B) disposed on different layers of the PCB (e.g., 2550a and 2550b) and separated from each other. In an embodiment, the coupled feeding structure 2551 may transfer electrical signals through a capacitance formed between the first coupling pads and the second coupling pads. In an embodiment, the coupled feeding structure 2551 may be implemented through the arrangements and connection structures of a plurality of coupling pads described above according to various embodiments with reference to FIGS. 4A through 21B.

In an embodiment, the coupled feeding structure 2551 may form an electrical path with the conductive portions 25411 through the one or more first coupling pads and an electrical path with the wireless communication circuit 2590 or the ground 2556 through the one or more second coupling pads. In an embodiment, the coupled feeding structure 2551 may transfer electrical signals between the conductive portions 25411 and the wireless communication circuit 2590 or between the conductive portions 25411 and the ground 2556, through a capacitance formed between the one or more first coupling pads and the one or more second coupling pads. In an embodiment, the coupled feeding structure 2551 may prevent a direct electrical signal delivery (or transfer) between the conductive portions 25411 and the wireless communication circuit 2590 and may thereby implement an ESD blocking function that prevents or reduces a delivery or transfer of electrostatic or noise signals from the conductive portions 25411 to the wireless communication circuit 2590. In an embodiment, the coupled feeding structure 2551 may include a discharge inductive portion (e.g., the discharge inductive portion 557D in FIG. 5D) adapted to induce electrostatic or noise signals transferred from the conductive portions 25411 to the first coupling pads to be discharged to the ground 2556. In an embodiment, the discharge inductive portion may be implemented through the arrangements and structures of a discharge inductive portion described above according to various embodiments with reference to FIGS. 5A through 5H.

In an embodiment, some of the conductive portions 25411 may be connected to the wireless communication circuit 2590 and form antenna regions through which electrical signals corresponding to various frequency bands flow. For example, the 1-1 conductive portion 25411a-1 may form a first antenna region A1. The 1-2 conductive portion 25411a-2 may form a second antenna region A2. The 1-3 conductive portion 25411a-3 may form a third antenna region A3. The 1-4 conductive portion 25411a-4 may form a fourth antenna region A4. The 1-5 conductive portion 25411a-5 may form a fifth antenna region A5 or a sixth antenna region A6. The 2-5 conductive portion 25411b-5 may form a seventh antenna region A7. The 2-2 conductive portion 25411b-2 may form an eighth antenna region A8. The 2-3 conductive portion 25411b-3 may form a ninth antenna region A9.

In an embodiment, of the plurality of antenna regions, some antenna regions, for example, A3, A4, and A7, may be used to transmit and receive wireless (or radio) signals in a specific frequency band (e.g., a frequency band of 3 GHz or above). For example, the third antenna region A3, the fourth antenna region A4, and the seventh antenna region A7 may function as an antenna for transmitting and receiving wireless signals in an UHB (e.g., a frequency band from 6 GHz to 10 GHz). In an embodiment, the 1-3 conductive portion 25411a-3 forming the third antenna region A3, the 1-4 conductive portion 25411a-4 forming the fourth antenna region A4, and the 2-5 conductive portion 25411b-5 forming the seventh antenna region A7 may be connected to the wireless communication circuit 2590 or the ground 2556 via the coupled feeding structure 2551. In an embodiment, using the coupled feeding structure 2551 to transfer electrical signals between the wireless communication circuit 2590 and the conductive portions 25411a-3, 25411a-4, and 25411b-5 may minimize or reduce a loss of electrical signals that may occur in a high-frequency band (e.g., UHB) and omit a separate element (e.g., an ESD protection element 2558) for removing an ESD during an electrical signal delivery or transfer.

In an embodiment, the antenna regions A3, A4, and A7 connected to the wireless communication circuit 2590 via the coupled feeding structure 2551 may be disposed more on an upper side (e.g., the first side member 2540a adjacent to a +Y direction) of the electronic device 2501 than on a lower side (e.g., the second side member 2540b adjacent to a −Y direction) of the electronic device 2501, based on a usage state of the electronic device 2501.

In an embodiment, the antenna regions connected to the wireless communication circuit 2590 via the coupled feeding structure 2551 may be disposed adjacent to a housing region (e.g., the first housing 2510) in which a main PCB (e.g., the first PCB 2550a) is disposed. For example, the main PCB may be a circuit board on which an AP, a CP, or the like is disposed. For example, in a case where the main PCB is the first PCB 2550a, the antenna regions A3, A4, and A7 connected to the wireless communication circuit 2590 via the coupled feeding structure 2551 may be disposed more on the first side member 2540a of the first housing 2510 compared to the second side member 2540b of the second housing 2520, as shown in FIG. 25. In this case, the antenna regions connected to the wireless communication circuit 2590 via the coupled feeding structure 2551 may not be disposed on the second side member 2540b of the second housing 2520. In an embodiment, the antenna regions connected to the wireless communication circuit 2590 via the coupled feeding structure 2551 may be disposed adjacent to a camera module (e.g., the second camera module 2408 in FIG. 24B). For example, in a case where the camera module is disposed adjacent to the upper side (e.g., a portion of the first side member 2540a adjacent to the +Y direction) compared to the lower side (e.g., a portion of the first side member 2540a adjacent to the −Y direction) of the electronic device 2501, more antenna regions to be connected to the wireless communication circuit 2590 via the coupled feeding structure 2551 may be disposed on the portion of the first side member 2540a adjacent to the upper side compared to the lower side of the electronic device 2501. In this case, the antenna regions connected to the wireless communication circuit 2590 via the coupled feeding structure 2551 may not be disposed on the portion of the first side member 2540a adjacent to the lower side of the electronic device 2501.

However, the preceding embodiments are provided only as examples, and the arrangement and number of antenna regions (e.g., A3, A4, and A7) connected to the wireless communication circuit 2590 via the coupled feeding structure 2551 are not limited thereto.

In an embodiment, of the plurality of antenna regions, some antenna regions A2, A8, and A9 may be connected to the wireless communication circuit 2590 or the ground 2556 through a signal deliver path including the ESD protection element 2558 to transmit and receive wireless (or radio) signals in a specific frequency band (e.g., a frequency band of 3 GHz or below). For example, the 1-2 conductive portion 25411a-2 forming the second antenna region A2, the 2-2 conductive portion 25411b-2 forming the eighth antenna region A8, and the 2-3 conductive portions 25411b-3 forming the ninth antenna region A9 may be directly connected to the wireless communication circuit 2590 or the ground 2556 through the signal deliver path in which the ESD protection element 2558 is disposed.

In an embodiment, some (e.g., 25411a-1 and 25411a-5) of the conductive portions 25411 forming the antenna regions may be directly connected to a ground by contacting a conductive structure (e.g., a support member or a hinge plate, etc.) of the electronic device 2501 without a separate signal deliver path leading to a PCB (e.g., 2550a). For example, the 1-1 conductive portion 25411a-1 forming the first antenna region A1 and the 1-5 conductive portion 25411a-5 forming the fifth antenna region A5 and the sixth antenna region A6 are directly connected to the ground to be connected to the wireless communication circuit 2590 through a signal deliver path with the ESD protection element 2558 omitted. In an embodiment, the 1-5 conductive portion 25411a-5 may have a plurality of grounds/feeders formed thereon. Depending on a path through which electrical signals applied to the 1-5 conductive portion 25411a-5 flow, the 1-5 conductive portion may function as the fifth antenna region A5 or the sixth antenna region A6.

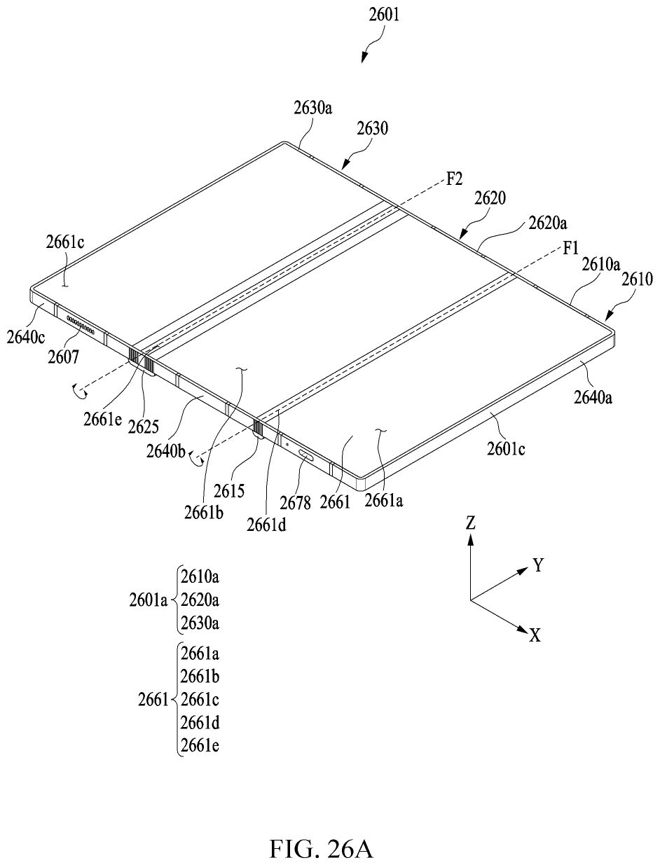

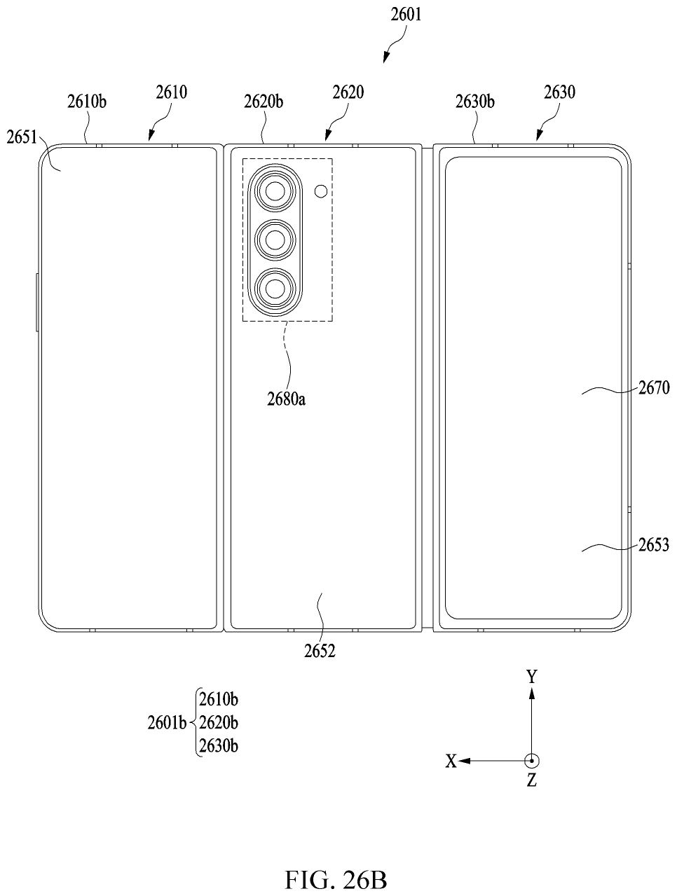

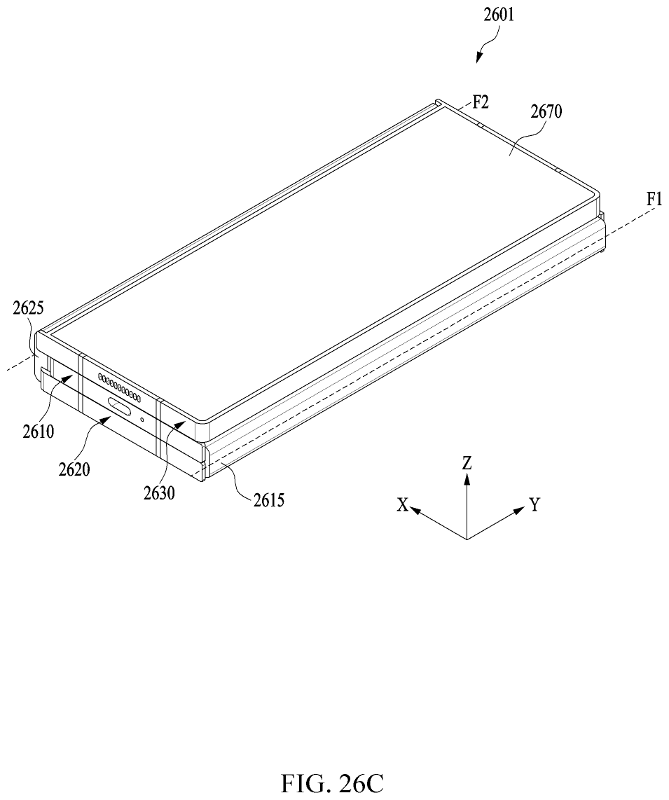

FIG. 26A is a front perspective view of an electronic device in an unfolded state according to an embodiment of the present disclosure. FIG. 26B is a rear view of an electronic device in an unfolded state according to an embodiment of the present disclosure. FIG. 26C is a perspective view of an electronic device in a folded state according to an embodiment of the present disclosure.

Referring to FIGS. 26A, 26B, and 26C, according to an embodiment, an electronic device 2601 may change in shape depending on a usage state indicating how it is used. For example, the electronic device 2601 may be provided in a foldable type that may be folded or unfolded depending on the usage state. In an embodiment, the electronic device 2601 may include a first housing 2610, a second housing 2620, a third housing 2630, a display 2661, a first hinge housing 2615, and a second hinge housing 2625.

Hereinafter, in describing embodiments with reference to FIGS. 26A through 26C, for ease of description, a surface of the display 2661 that is visually visible to the outside will be referred to as a front surface 2601a (e.g., a surface facing a +Z direction in FIG. 26A) of the electronic device 2601, a surface opposite the front surface 2601a will be referred to as a rear surface 2601b (e.g., a surface facing a −Z direction in FIG. 26A) of the electronic device 2601, and an outer surface of the electronic device 2601 that encloses an inner space between the front surface 2601a and the rear surface 2601b will be referred to as a side 2601c.

In an embodiment, the first housing 2610, the second housing 2620, and the third housing 2630 may form the exterior of the electronic device 2601. In an embodiment, the first housing 2610 may include a first front surface 2610a and a first rear surface 2610b. The second housing 2620 may include a second front surface 2620a and a second rear surface 2620b. The third housing 2630 may include a third front surface 2630a and a third rear surface 2630b. In an embodiment, the first front surface 2610a of the first housing 2610, the second front surface 2620a of the second housing 2620, and the third front surface 2630a of the third housing 2630 may form the front surface 2601a of the electronic device 2601 based on an unfolded state of the electronic device 2601 as shown in FIG. 26A. In an embodiment, the front surface 2601a of the electronic device 2601 may be formed such that most areas thereof are opened to allow the display 2661 to be visually visible to the outside. In an embodiment, the first rear surface 2610b of the first housing 2610, the second rear surface 2620b of the second housing 2620, and the third rear surface 2630b of the third housing 2630 may form the rear surface 2601b of the electronic device 2601 based on the unfolded state of the electronic device 2601 as shown in FIG. 26B. In an embodiment, the first housing 2610, the second housing 2620, and the third housing 2630 may form the side 2601c that encloses an inner space between the front surface 2601a and the rear surface 2601b of the electronic device 2601.

In an embodiment, the first housing 2610 may include a first side member 2640a that forms a portion of the side 2601c of the electronic device 2601. The first side member 2640a may include a conductive portion. In an embodiment, the second housing 2620 may include a second side member 2640b that forms a portion of the side 2601c of the electronic device 2601. The second side member 2640b may include a conductive portion. In an embodiment, the third housing 2630 may include a third side member 2640c that forms a portion of the side 2601c of the electronic device 2601. The third side member 2640c may include a conductive portion.

In an embodiment, a first rear cover 2651 may be disposed on the first rear surface 2610b of the first housing 2610. At least a portion of an edge of the first rear cover 2651 may be enclosed by the first housing 2610. In an embodiment, a second rear cover 2652 may be disposed on the second rear surface 2620b of the second housing 2620. At least a portion of an edge of the second rear cover 2652 may be enclosed by the second housing 2620. In an embodiment, a third rear cover 2653 may be disposed on the third rear surface 2630b of the third housing 2630. At least a portion of an edge of the third rear cover 2653 may be enclosed by the third housing 2630. In an embodiment, the first rear cover 2651, the second rear cover 2652, and the third rear cover 2653 may be integrally formed with the first housing 2610, the second housing 2620, and the third housing 2630, respectively.

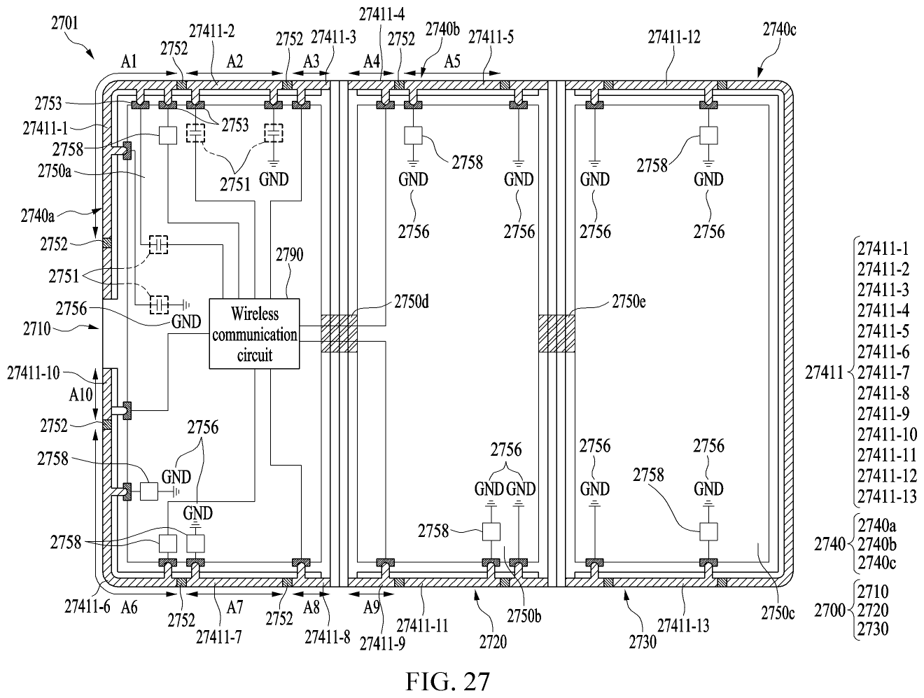

In an embodiment, the first housing 2610, the second housing 2620, the third housing 2630, the first rear cover 2651, the second rear cover 2652, and the third rear cover 2653 may be coupled together to form a space in which various components (e.g., PCBs 2750a, 2750b, and 2750c in FIG. 27, etc.) of the electronic device 2601 are disposed. In an embodiment, at least one component may be disposed on the rear surface 2601b of the electronic device 2601 to be visually visible. For example, at least one component (e.g., a proximity sensor, a rear camera module, and/or a flash) may be visually visible to the outside through a second rear area 2652a of the second rear cover 2652. In an embodiment, at least a portion of a sub-display 2670 may be visually exposed through a third rear area 2653a of the third rear cover 2653.

In an embodiment, the first hinge housing 2615 may rotatably connect the first housing 2610 and the second housing 2620 about a first folding axis F1. In an embodiment, the second hinge housing 2625 may rotatably connect the second housing 2620 and the third housing 2630 about a second folding axis F2. In an embodiment, the first folding axis F1 and the second folding axis F2 may be parallel to each other.

In an embodiment, the display 2661 may be deformable in at least some areas such that the display 2661 may change in shape in response to the electronic device 2601 changing its shape (e.g., an opening or closing operation of the electronic device 2601) between a first state (e.g., an unfolded state or a fully open state) shown in FIG. 26A and a second state (e.g., a folded state or a fully closed state) shown in FIG. 26C. In an embodiment, the display 2661 may be supported by the first housing 2610, the second housing 2620, the third housing 2630, the first hinge housing 2615, and the second hinge housing 2625, and may be disposed to be visually visible to the outside through the front surface 2601a of the electronic device 2601.

In an embodiment, the display 2661 may include a first flat portion 2661a corresponding to the first housing 2610, a second flat portion 2661b corresponding to the second housing 2620, and a third flat portion 2661c corresponding to the third housing 2630, a first folding portion 2661d connecting the first flat portion 2661a and the second flat portion 2661b and corresponding to the first hinge housing 2615, and a second folding portion 2661e connecting the second flat portion 2661b and the third flat portion 2661c and corresponding to the second hinge housing 2625. In an embodiment, the first folding portion 2661d and the second folding portion 2661e may be at least partially bent in response to a change in shape of the electronic device 2601.

In an embodiment, the electronic device 2601 may include a sound output module 2655 including a connector port 2678 (e.g., the connecting terminal 178 in FIG. 1) disposed through the side 2601c and at least one hole formed on the side 2601c.

FIG. 27 is a diagram schematically illustrating a connection structure of a side member and a PCB in an electronic device according to an embodiment of the present disclosure.

Referring to FIG. 27, according to an embodiment, an electronic device 2701 (e.g., the electronic device 2601 in FIG. 26) may include a housing structure 2700 including a first housing 2710, a second housing 2720, and a third housing 2730, and a first PCB 2750a disposed in the first housing 2710, a second PCB 2750b disposed in the second housing 2720, a third PCB 2750c disposed in the third housing 2730, a first connecting PCB 2750d connecting the first PCB 2750a and the second PCB 2750b, a second connecting PCB 2750e connecting the second PCB 2750b and the third PCB 2750c, and/or a wireless communication circuit 2790.

In an embodiment, the first housing 2710 and the second housing 2720 may be mutually rotatable about a first folding axis F1. The second housing 2720 and the third housing 2730 may be mutually rotatable about a second folding axis F2.

In an embodiment, the housing structure 2700 may include side members 2740 that form sides enclosing an inner space. For example, the first housing 2710, the second housing 2720, and the third housing 2730 may include a first side member 2740a, a second side member 2740b, and a third side member 2740c, respectively, that form the sides enclosing the inner space. In an embodiment, the first side member 2740a, the second side member 2740b, and the third side member 2740c may include a plurality of conductive portions 27411 including a conductive material. In an embodiment, at least some of the conductive portions 27411 may function as a radiator through which electrical signals flow. In an embodiment, the first side member 2740a, the second side member 2740b, and the third side member 2740c may include insulative portions 27412 that are disposed between the plurality of conductive portions 27411 and electrically separate adjacent conductive portions 27411. For example, the first side member 2740a, the second side member 2740b, and the third side member 2740c may include one or more connective portions formed on the conductive portions 27411 and adapted to be connected to a PCB (e.g., 2750a and 2350b).

In an embodiment, a portion of the conductive portions 27411 formed on the first side member 2740a, the second side member 2740b, and the third side member 2740c may be connected to the wireless communication circuit 2790 via the PCBs 2750a, 2750b, and 2750c, and may function as a radiator for transmitting and receiving wireless (or radio) signals in a frequency band corresponding to a length of a path along which electrical signals flow. Another portion of the conductive portions 27411 may not be connected to the wireless communication circuit 2790. Hereinafter, embodiments will be described based on antenna regions shown in the drawings for ease of description, but it is to be noted that the antenna structure and arrangement formed in the electronic device 2701 are not limited thereto.

In an embodiment, the plurality of conductive portions 27411 may include a first conductive portion 27411-1, a second conductive portion 27411-2, a third conductive portion 27411-3, a fourth conductive portion 27411-4, a fifth conductive portion 24711-5, a sixth conductive portion 27411-6, a seventh conductive portion 27411-7, an eighth conductive portion 27411-8, a ninth conductive portion 27411-9, a tenth conductive portion 27411-10, an 11th conductive portion 27411-11, a 12th conductive portion 27411-12, and/or a 13th conductive portion 27411-13. In an embodiment, the first conductive portion 27411-1, the second conductive portion 27411-2, the third conductive portion 27411-3, the sixth conductive portion 27411-6, the seventh conductive portion 27411-7, the eighth conductive portion 27411-8, and/or the tenth conductive portion 27411-10 may be formed on the first side member 2740a. In an embodiment, the fourth conductive portion 27411-4, the fifth conductive portion 27411-5, the ninth conductive portion 27411-9, and/or the 11th conductive portion 27411-11 may be formed on the second side member 2740b. In an embodiment, the 12th conductive portion 27411-12 and/or the 13th conductive portion 27411-13 may be formed on the third side member 2740c.

In an embodiment, of the plurality of conductive portions 27411 formed on the first side member 2740a, the second side member 2740b, and the third side member 2740c, conductive portions 27411 that face each other when the electronic device 2701 is folded may be formed symmetrically about the first folding axis F1 and/or the second folding axis F2. For example, the fifth conductive portion 27411-5 may be formed symmetrically with the second conductive portion 27411-2 about the first folding axis F1 and with the 12th conductive portion 27411-12 about the second folding axis F2. The 11th conductive portion 27411-11 may be formed symmetrically with the seventh conductive portion 27411-7 about the first folding axis F1 and with the 13th conductive portion 27411-13 about the second folding axis F2.

In an embodiment, the wireless communication circuit 2790 may be disposed on the first PCB 2750a but may alternatively be disposed on the second PCB 2750b or the third PCB 2750c, or another PCB.

In an embodiment, the first PCB 2750a, the second PCB 2750b, and the third PCB 2750c may be disposed in the first housing 2710, the second housing 2720, and the third housing 2730, respectively, and may include one or more electrical connection members 2753 that are electrically connected to the conductive portions 27411 of the respective housings. In an embodiment, the electrical connection members 2753 may be connected to the conductive portions 27411 by contacting the connective portions formed on the conductive portions 27411.

In an embodiment, a PCB (e.g., 2750a, 2750b, and 2750c) may include at least one coupled feeding structure 2751 for transferring electrical signals. In an embodiment, the coupled feeding structure 2751 may include at least one first coupling pad (e.g., the first coupling pads 5511 in FIG. 5A) and at least one second coupling pad (e.g., the second coupling pads 5512 in FIG. 5B) disposed on different layers of the PCB (e.g., 2750a, 2750b, and 2750c) and separated from each other. In an embodiment, the coupled feeding structure 2751 may transfer electrical signals through a capacitance formed between the first coupling pad and the second coupling pad. In an embodiment, the coupled feeding structure 2751 may be implemented through the arrangements and connection structures of a plurality of coupling pads described above according to various embodiments with reference to FIGS. 4A through 21B.

In an embodiment, the coupled feeding structure 2751 may form an electrical path with the conductive portions 27411 through the at least one first coupling pad and an electrical path with the wireless communication circuit 2790 or a ground 2756 through the at least one second coupling pad. In an embodiment, the coupled feeding structure 2751 may transfer electrical signals between the conductive portions 27411 and the wireless communication circuit 2790 or between the conductive portions 27411 and the ground 2756, through a capacitance formed between the at least one first coupling pad and the at least one second coupling pad. In an embodiment, the coupled feeding structure 2751 may prevent a direct electrical signal delivery (or transfer) between the conductive portions 27411 and the wireless communication circuit 2790 and may thereby implement an ESD blocking function that prevents or reduces a delivery or transfer of electrostatic or noise signals from the conductive portions 27411 to the wireless communication circuit 2790. In an embodiment, the coupled feeding structure 2751 may include a discharge inductive portion (e.g., the discharge inductive portion 557D in FIG. 5D) adapted to induce electrostatic or noise signals transferred from the conductive portions 27411 to the first coupling pad to be discharged to the ground 2756. In an embodiment, the discharge inductive portion may be implemented through the arrangements and structures of a discharge inductive portion described above according to various embodiments with reference to FIGS. 5A through 5H.

In an embodiment, some of the plurality of conductive portions 27411 may be connected to the wireless communication circuit 2790 and form antenna regions through which electrical signals corresponding to various frequency bands may flow. For example, the first conductive portion 27411-1 may form a first antenna region A1. The second conductive portion 27411-2 may form a second antenna region A2. The third conductive portion 27411-3 may form a third antenna region A3. The fourth conductive portion 27411-4 may form a fourth antenna region A4. The fifth conductive portion 27411-5 may form a fifth antenna region A5. The sixth conductive portion 27411-6 may form a sixth antenna region A6. The seventh conductive portion 27411-7 may form a seventh antenna region A7. The eighth conductive portion 27411-8 may form an eighth antenna region A8. The ninth conductive portion 27411-9 may form a ninth antenna region A9. The tenth conductive portion 27411-10 may form a tenth antenna region A10.

In an embodiment, of the plurality of antenna regions, some antenna regions, for example, A1 and A2, may be used to transmit and receive wireless (or radio) signals in a specific frequency band (e.g., a frequency band of 3 GHz or above). For example, the first antenna region A1 and the second antenna region A2 may function as an antenna for transmitting and receiving wireless signals in an UHB (e.g., a frequency band from 6 GHz to 10 GHz). In an embodiment, the first conductive portion 27411-1 forming the first antenna region A1 and the second conductive portion 27411-2 forming the second antenna region A2 may be connected to the wireless communication circuit 2790 or the ground 2756 via the coupled feeding structure 2751. In an embodiment, using the coupled feeding structure 2751 to transfer electrical signals between the wireless communication circuit 2790 and the conductive portions 27411-1 and 27411-2 may minimize or reduce a loss of electrical signals that may occur in a high-frequency band (e.g., UHB) and omit a separate element (e.g., an ESD protection element 2758) for removing an ESD during an electrical signal delivery or transfer.

In an embodiment, the antenna regions A1 and A2 connected to the wireless communication circuit 2790 via the coupled feeding structure 2751 may be disposed more on an upper side (e.g., a +Y direction) of the electronic device 2701 than on a lower side (e.g., a −Y direction) of the electronic device 2701, based on a usage state of the electronic device 2701. In an embodiment, the antenna regions connected to the wireless communication circuit 2790 via the coupled feeding structure 2751 may be disposed adjacent to a housing region (e.g., the second housing 2720) in which a main PCB (e.g., the second PCB 2750b) is disposed. For example, the main PCB may be a circuit board on which an AP, a CP, or the like is disposed. For example, in a case where the main PCB is the second PCB 2750b, the antenna regions connected to the wireless communication circuit 2790 via the coupled feeding structure 2751 may be disposed more on a side member 2740b of the second housing 2720 compared to the first housing 2710 or the third housing 2730. In this case, the antenna regions connected to the wireless communication circuit 2790 via the coupled feeding structure 2751 may not be disposed on the first housing 2710 or the third housing 2730. In an embodiment, the antenna regions connected to the wireless communication circuit 2790 via the coupled feeding structure 2751 may be disposed adjacent to a camera module (e.g., at least one camera module 2680a disposed on the first rear cover 2652 in FIG. 26B). For example, in a case where the camera module is disposed adjacent to an upper side (e.g., a portion of the second side member 2740b adjacent to a +Y direction) compared to a lower side (e.g., a portion of the second side member 2740b adjacent to a −Y direction) of the electronic device 2701, more antenna regions to be connected to the wireless communication circuit 2790 via the coupled feeding structure 2751 may be disposed on the portion of the second side member 2740b adjacent to the upper side compared to the lower side of the electronic device 2701. For example, the first housing 2710 and the third housing 2730 in which the camera module (e.g., 2680a) is not disposed may have an equal number of antenna regions connected to the wireless communication circuit 2790 via the coupled feeding structure 2751. For example, the antenna regions connected to the wireless communication circuit 2790 via the coupled feeding structure 2751 may not be disposed on the portion of the second side member 2740b adjacent the lower side of the electronic device 2701.

However, the preceding embodiments are provided only as examples, and the arrangement and number of antenna regions connected to the wireless communication circuit 2790 via the coupled feeding structure 2751 are not limited thereto.

In an embodiment, the first antenna region A1 may separately include a signal deliver path that is directly connected to the wireless communication circuit 2790 or the ground 2756 to enable transmission and reception of wireless signals in a frequency band (e.g., a frequency band of 3 GHz or below) different from a frequency band for transmission and reception via the coupled feeding structure 2751. For example, the first conductive portion 27411-1 may be directly connected to the wireless communication circuit 2790 or the ground 2756 via a signal deliver path in which the ESD protection element 2758 is disposed, separate from the signal deliver path formed by the coupled feeding structure 2751. Depending on a path along which an electrical signal applied to the first conductive portion 27411-1 flows, the frequency band of wireless signals transmitted and received through the first antenna region A1 may change.

In an embodiment, of the plurality of antenna regions, some antenna regions A5, A6, and A7 may be connected to the wireless communication circuit 2790 or the ground 2756 via the signal deliver path including the ESD protection element 2758 to transmit and receive wireless signals in a specific frequency band (e.g., a frequency band of 3 GHz or below). For example, the fifth conductive portion 27411-5 forming the fifth antenna region A5, the sixth conductive portion 27411-6 forming the sixth antenna region A6, and the seventh conductive portion 27411-7 forming the seventh antenna region A7 may be directly connected to the wireless communication circuit 2790 or the ground 2756 via the signal deliver path in which the ESD protection element 2758 for removing noise signals is disposed.

In an embodiment, some (e.g., 23411-3, 23411-4, 23411-8, 23411-9, and 23411-10) of the conductive portions 27411 forming the antenna regions may be directly connected to a ground by contacting a conductive structure (e.g., a support member or a hinge plate, etc.) of the electronic device 2701. For example, the third conductive portion 27411-3 forming the third antenna region A3, the fourth conductive portion 27411-4 forming the fourth antenna region A4, the eighth conductive portion 27411-8 forming the eighth antenna region A8, the ninth conductive portion 27411-9 forming the ninth antenna region A9, and/or the tenth conductive portion 27411-10 forming the tenth antenna region A10 may be connected to the ground without a separate signal deliver path leading to the PCBs 2750a, 2750b, and 2750c. In an embodiment, the conductive portions 27411-3, 27411-4, 27411-8, 27411-9, and 27411-10 forming the antenna regions A3, A4, A8, A9, and A10 that are directly connected to the ground may be connected to the wireless communication circuit 2790 via a signal deliver path with the ESD protection element 2758 omitted.

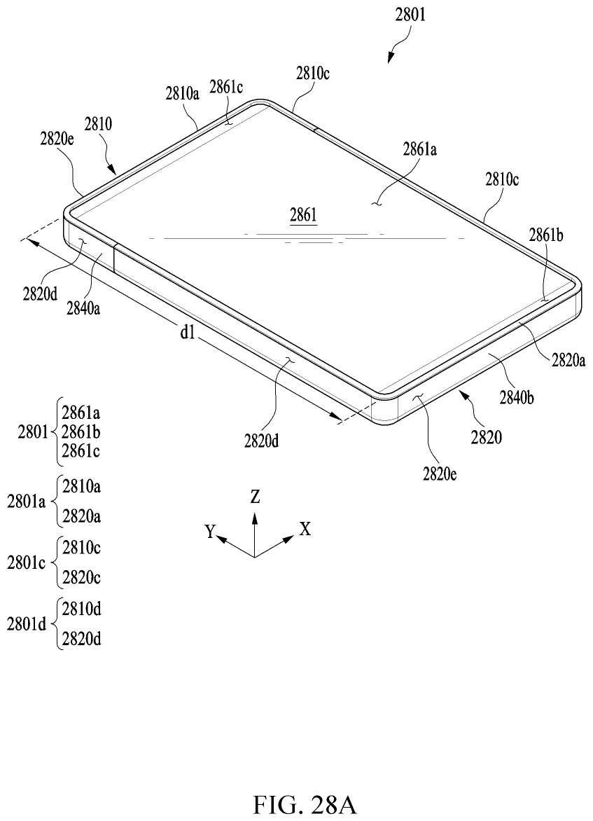

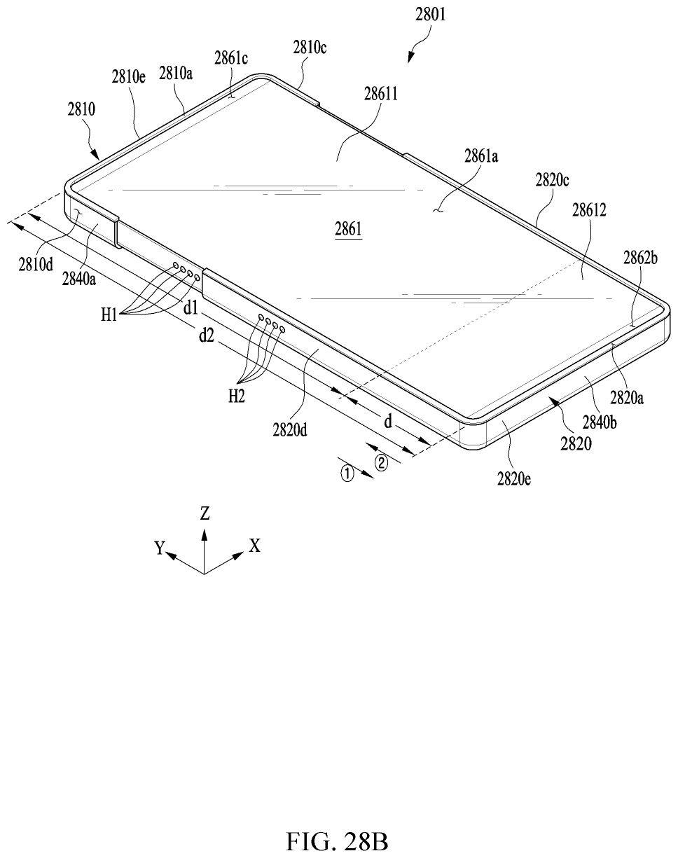

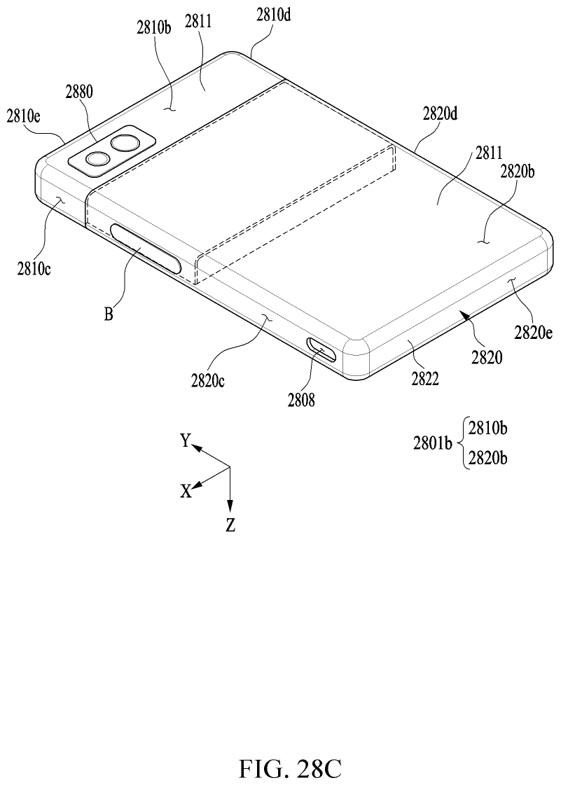

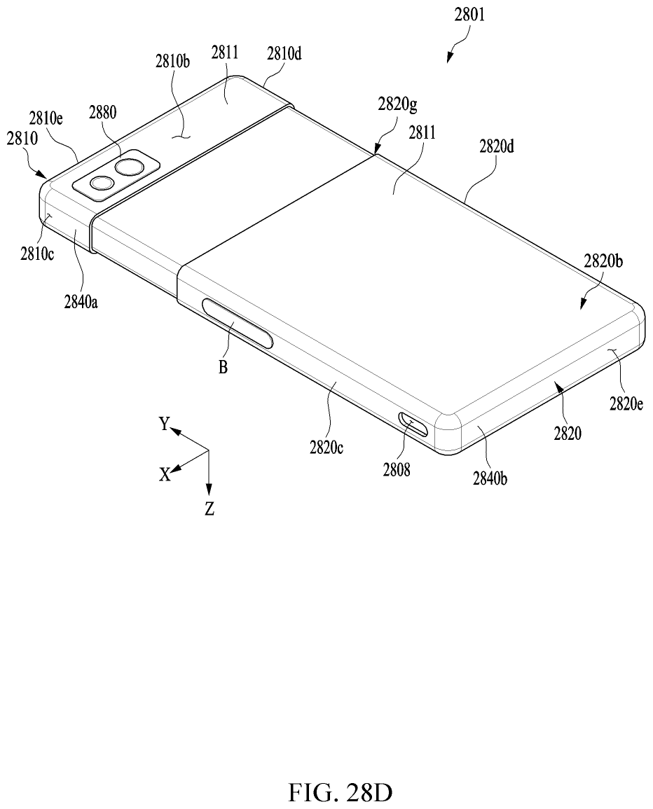

FIG. 28A is a front perspective view of an electronic device in a first state according to an embodiment of the present disclosure. FIG. 28B is a front perspective of an electronic device in a second state according to an embodiment of the present disclosure. FIG. 28C is a rear perspective view of an electronic device in a first state according to an embodiment of the present disclosure. FIG. 28D is a rear perspective of an electronic device in a second state according to an embodiment of the present disclosure.

Referring to FIGS. 28A, 28B, 28C, and 28D, according to an embodiment, an electronic device 2801 (e.g., the electronic device 101 in FIG. 1) may be deformable. In an embodiment, the electronic device 2801 may change in size by expanding and contracting along a movement direction (e.g., a direction parallel to a Y axis in FIG. 28A). For example, the electronic device 2801 may change its state between a first state (e.g., a slide-in state) as shown in FIG. 28A and a second state (e.g., a slide-out state) as shown in FIG. 28B.

In an embodiment, the electronic device 2801 may include housings 2810 and 2820 that form the exterior and house components therein. In an embodiment, the housings 2810 and 2820 may include a first housing 2810 and a second housing 2820 that are movably connected with respect to each other. In an embodiment, the first housing 2810 may be slidably connected to the second housing 2820. For example, the first housing 2810 may move in a first movement direction \textcircled{1} (e.g., a −Y direction) relative to the second housing 2820 or slide in a second movement direction \textcircled{2} (e.g., a +Y direction) opposite the first movement direction \textcircled{1} (e.g., the −Y direction). Although a state change of the electronic device 2801 will be described hereinafter based on a slide-in/out motion of the first housing 2810 relative to the second housing 2820 with reference to FIGS. 28A through 28D, this is intended to describe relative movements of the first housing 2810 and the second housing 2820 relative to each other, and may also be understood as a movement of the second housing 2820 relative to the first housing 2810.

In an embodiment, by a relative movement of the first housing 2810 relative to the second housing 2820, the state of the electronic device 2801 may change between the first state (e.g., the slide-in state) and the second state (e.g., the slide-out state). In an embodiment, the electronic device 2801 may have a minimum exposure area of a display 2861 in the first state, and the electronic device 2801 may have a maximum exposure area of the display 2861 in the second state. In an embodiment, the electronic device 2801 may be used in the first state and the second state but may also be used in an intermediate state between the first state and the second state.

In an embodiment, the first housing 2810 may include a 1-1 surface 2810a (e.g., a first front surface), a 1-2 surface 2810b (e.g., a first rear surface) opposite the 1-1 surface 2810a, a 1-1 side 2810c facing a first side direction (e.g., a +X direction) and formed between the 1-1 surface 2810a and the 1-2 surface 2810b, a 1-2 side 2810d facing a second side direction (e.g., a −X direction) opposite the first side direction and formed between the 1-1 surface 2810a and the 1-2 surface 2810b, and a third side 2810e facing a third side direction (e.g., a +Y direction) intersecting the first side direction and formed between the 1-1 surface 2810a and the 1-2 surface 2810b.

In an embodiment, the first housing 2810 may include a first plate 2811 and a first side member 2840a extending substantially in a thickness direction (e.g., a +Z direction) along an edge of the first plate 2811. In an embodiment, the first plate 2811 may form the 1-2 surface 2810b, and the first side member 2840a may form the sides 2810c, 2810d, and 2810e of the first housing 2810. In an embodiment, the first plate 2811 and the first side member 2840a may be formed integrally or may be coupled after being separately formed. In an embodiment, the first side member 2840a may include a conductive portion.

In an embodiment, the second housing 2820 may include a 2-1 surface 2820a (e.g., a second front surface), a 2-2 surface 2820b (e.g., a second rear surface) opposite the 2-1 surface 2820a, a 2-1 side 2820c facing the first side direction (e.g., the +X direction) and formed between the 2-1 surface 2820a and the 2-2 surface 2820b, a 2-2 side 2820d facing the second side direction (e.g., the −X direction) opposite the first side direction and formed between the 2-1 surface 2820a and the 2-2 surface 2820b, and a fourth side 2820e facing a fourth side surface direction (e.g., a −Y direction) intersecting the first side direction and formed between the 2-1 surface 2820a and the 2-2 surface 2820b.

In an embodiment, the second housing 2820 may include a second plate 2821 and a second side member 2840b extending substantially in a thickness direction (e.g., the +Z direction) along an edge of the second plate 2821. In an embodiment, the second plate 2821 may form the 2-2 surface 2820b, and the second side member 2840b may form the sides 2820c, 2820d, and 2820e of the second housing 2820. In an embodiment, the second plate 2821 and the second side member 2840b may be formed integrally or may be coupled after being separately formed. In an embodiment, the second side member 2840b may include a conductive portion.

In an embodiment, the first housing 2810 and the second housing 2820 may form a first surface 2801a (or a front surface) (e.g., a surface facing +Z) of the electronic device 2801 by the 1-1 surface 2810a and the 2-1 surface 2820a, and form a second surface 2801b (or a rear surface) (e.g., a surface facing-Z) of the electronic device 2801 by the 1-2 surface 2810b and the 2-2 surface 2820b. In an embodiment, the first surface 2801a of the electronic device 2801 may be open to expose the display 2861. In an embodiment, the first housing 2810 and the second housing 2820 may form a first side 2801c (e.g., a surface facing +X) of the electronic device 2801 by the 1-1 side 2810c and the 2-1 side 2820c, and form a second side 2801d (e.g., a surface facing −X) of the electronic device 2801 by the 1-2 side 2810d and the 2-2 side 2820d.

In an embodiment, the first housing 2810 may be retracted or withdrawn with respect to the second housing 2820 while partially inserted into the second housing 2820. In an embodiment, the second housing 2820 may include an open portion 2820g that is openly formed in the fourth side direction (e.g., the +Y direction) opposite the third side direction to allow the first housing 2810 to be inserted. In an embodiment, as the first housing 2810 is inserted into the second housing 2820, at least a portion of the 1-1 side 2810c and the 1-2 side 2810d of the first housing 2810 may be retracted into the second housing 2820 and covered by the 2-1 side 2820c and the 2-2 side 2820d. Thus, the first side 2801c and the second side 2801d of the electronic device 2801 may change in length depending on the state of the electronic device 2801.

In an embodiment, the electronic device 2801 may include the display 2861 (e.g., a flexible or rollable display) for displaying visual information. In an embodiment, the display 2861 may be exposed on the exterior, namely, the front, of the electronic device 2801 via a display region 28610. In an embodiment, the display region 28610 may include a first area 2861a disposed on the 1-1 surface 2810a and the 2-1 surface 2820a, a second area 2861b disposed adjacent to the fourth side 2820e, and a third area 2861c disposed adjacent to the third side 2810e. In an embodiment, the second area 2861b and/or the third area 2861c may form a flexibly curved surface. In an embodiment, the display region 28610 may expand and/or contract in response to a change in size of the first area 2861a. In an embodiment, the display 2861 may display a screen on the display region 28610. In an embodiment, the display 2861 may display a single connected screen through the display region 28610 or may use only a portion of the display region 28610 to display the screen. In an embodiment, the display 2861 may display a plurality of distinct screens on the display region 28610.

In an embodiment, the display 2861 may include a flat portion 28611 that forms at least a portion (e.g., the first area 2861a in the first state of FIG. 28A) of the display region 28610 and is supported by the first housing 2810 and the second housing 2820, and a rolling portion 28612 (or a bending portion) that extends in the first movement direction from the flat portion 28611 and is supported by the second housing 2820. In an embodiment, the flat portion 28611 may be exposed to the first surface 2801a of the housings 2810 and 2820 to form the display region 28610, regardless of a change in the state of the electronic device 2801. In an embodiment, the rolling portion 28612 may be retracted into the inside of the electronic device 2801 or withdrawn to the outside of the electronic device 2801 in response to a movement of the first housing 2810 relative to the second housing 2820. In an embodiment, the rolling portion 28612 withdrawn to the outside of the electronic device 2801 may be disposed on the 2-1 surface 2820a of the second housing 2820 and exposed to the outside of the electronic device 2801 to form the display region 28610 together with the flat portion 28611. For example, an area size of the display region 28610 may change depending on a degree by which the rolling portion 28612 is withdrawn.

In an embodiment, the display 2861 may have the area size of the display region 28610 (e.g., the first area 2861a, the second area 2861b, and the third area 2861c) that changes in response to a change in the state of the electronic device 2801. In an embodiment, the display region 28610 of the display 2861 may form a first area size (e.g., a minimum area size) that is minimally reduced in the first state (e.g., the slide-in state in FIG. 28A) of the electronic device 2801 and a second area size (e.g., a maximum area size) that is maximally expanded in the second state (e.g., the slide-out state in FIG. 28B) of the electronic device 2801. When the electronic device 2801 is in a state between the first state and the second state, the display region 28610 may have an area size between the first area size and the second area size, as a state of the display 2861 changes in response to the state of the electronic device 2801. For example, in a motion by which the state of the electronic device 2801 changes from the first state to the second state, when the first housing 2810 moves by a certain length d in the second movement direction \textcircled{2} with respect to the second housing 2820, a length of the display region 28610 parallel to the second movement direction \textcircled{2} (e.g., a length along the Y axis) may change from a first length d1 to a second length d2 that is increased by the certain length d, and the display region 28610 may thereby expand. For example, when the state of the electronic device 2801 changes from the second state to the first state, the first housing 2810 may move by a certain length d in the first movement direction \textcircled{1} with respect to the second housing 2820, and a length of the display region 28610 parallel to the first movement direction \textcircled{1} (e.g., a length along the Y axis) may change from the second length d2 to the first length d1 that is decreased by the certain length d, and the display region 28610 may thereby contract. In an embodiment, the size of the second area 2861b and the third area 2861c may remain substantially constant regardless of a change in state of the electronic device 2801.

In an embodiment, the electronic device 2801 may include an input button 2850 (e.g., the input module 150 in FIG. 1), a sound output module (e.g., the sound output module 155 in FIG. 1), a camera module 2880 (e.g., the camera module 180 in FIG. 1), and a connector port 2808. In an embodiment, the electronic device 2801 may omit at least one of the components described above or may additionally include other components.

In an embodiment, the input button 2850 may receive an input signal in response to an operation by a user. The input button 2850 may be disposed outside the electronic device 2801 and, when pressed by the user, transfer the input signal to a processor (e.g., the processor 120 in FIG. 1). In an embodiment, the input button 2850 may be formed on a side of the housings 2810 and 2820. For example, the input button 2850 may be formed on at least one of the 2-3 side 2820c or the 2-4 side 2820d of the second housing 2820. Although a single input button 2850 is shown as formed on the 2-3 side 2820c of the second housing 2820 for ease of description, it is to be noted that the arrangement position and number of input button 2850 for the electronic device 2801 are provided only as an example for ease of description and are not limited to what is shown.

In an embodiment, the sound output module may radiate sounds to the outside via sound holes H1 and H2 communicating with the outside of the housings 2810 and 2820. In an embodiment, the sound holes H1 and H2 may include, for example, a first sound hole H1 formed on the second housing 2820 and a second sound hole H2 formed on the first housing 2810. In an embodiment, the first sound hole H1 and the second sound hole H2 may be substantially aligned to communicate with each other in the first state of the electronic device 2801.

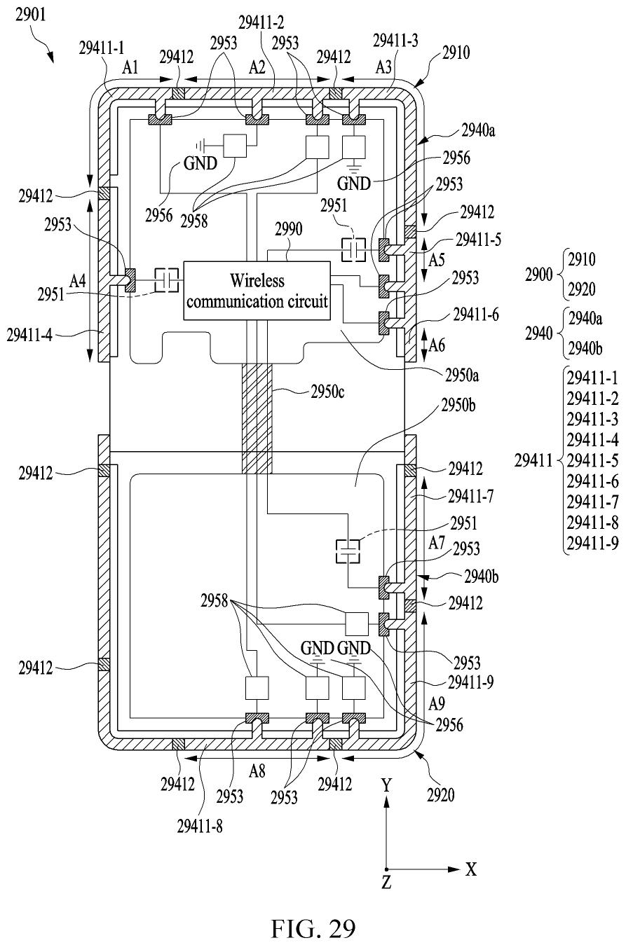

FIG. 29 is a diagram schematically illustrating a connection structure of a side member and a PCB in an electronic device according to an embodiment of the present disclosure.

Referring to FIG. 29, according to an embodiment, an electronic device 2901 (e.g., the electronic device 2801 in FIG. 28A through 28D) may include a first housing 2910 and a second housing 2920 that are slidable relative to each other, a first PCB 2950a disposed in the first housing 2910, a second PCB 2950b disposed in the second housing 2920, a connecting PCB 2950c connecting the first PCB 2950a and the second PCB 2950b, and a wireless communication circuit 2990.

In an embodiment, the first housing 2910 may be retracted into or withdrawn from the second housing 2920 along a sliding direction (e.g., a Y-axis direction in FIG. 29). The first housing 2910 and the second housing 2920 may include a first side member 2940a and a second side member 2940b, respectively, that form a side enclosing an inner space. In an embodiment, the first side member 2940a and the second side member 2940b may each include a plurality of conductive portions 29411 including a conductive material. In an embodiment, the conductive portions 29411 may each function as a radiator through which electrical signals flow. In an embodiment, the first side member 2940a and the second side member 2940b may each include an insulative portion 29412 disposed between the plurality of conductive portions 29411 and electrically separating adjacent conductive portions 29411. The first side member 2940a and the second side member 2940b may each include at least one connective portion formed on the conductive portions 29411 and adapted to be connected to the PCBs 2950a and 2950b.

In an embodiment, a portion of the plurality of conductive portions 29411 formed on the first side member 2940a and the second side member 2940b may be connected to the wireless communication circuit 2990 via the PCBs 2950a and 2950b to function as a radiator for transmitting and receiving a frequency band corresponding to a length of a path along which electrical signals flow. Another portion of the plurality of conductive portions 29411 may not be connected to the wireless communication circuit 2990. Hereinafter, embodiments will be described based on antenna regions shown in the drawings for ease of description, but it is to be noted that the antenna structure and arrangement formed in the electronic device 2901 are not limited thereto.

In an embodiment, the plurality of conductive portions 29411 may include a first conductive portion 29411-1, a second conductive portion 29411-2, a third conductive portion 29411-3, a fourth conductive portion 29411-4, a fifth conductive portion 29411-5, a seventh conductive portion 29411-7, an eighth conductive portion 29411-8, and a ninth conductive portion 29411-9. In an embodiment, the first conductive portion 29411-1, the second conductive portion 29411-2, the third conductive portion 29411-3, the fourth conductive portion 29411-4, and the fifth conductive portion 29411-5 may be formed on the first side member 2940a. In an embodiment, the seventh conductive portion 29411-7, the eighth conductive portion 29411-8, and the ninth conductive portion 29411-9 may be formed on the second side member 2940b. In an embodiment, the wireless communication circuit 2990 may be disposed on the first PCB 2950a, but may alternatively be disposed on the second PCB 2950b or may be disposed on another PCB.

In an embodiment, the first PCB 2950a may be disposed inside the first housing 2910 and may include at least one electrical connection member 2953 electrically connected to the conductive portions 29411 of the first housing 2910. The second PCB 2950b may be disposed inside the second housing 2920 and may include at least one electrical connection member 2953 electrically connected to the conductive portions 29411 of the second housing 2920.

In an embodiment, the electrical connection member 2953 may be connected to the conductive portions 29411 by contacting the connective portion formed on each conductive portion 29411.

In an embodiment, a PCB (e.g., 2950a and 2950b) may include at least one coupled feeding structure 2951 for an electrical signal delivery or transfer. In an embodiment, the coupled feeding structure 2951 may include at least one first coupling pad (e.g., the first coupling pads 5511 in FIG. 5A) and at least one second coupling pad (e.g., the second coupling pads 5512 in FIG. 5B) disposed on different layers of the PCB (e.g., 2950a and 2950b) and separated from each other. In an embodiment, the coupled feeding structure 2951 may transfer electrical signals through a capacitance formed between the first coupling pad and the second coupling pad. In an embodiment, the coupled feeding structure 2951 may be implemented through the arrangements and connection structures of a plurality of coupling pads described above according to various embodiments with reference to FIGS. 4A through 21B.

In an embodiment, the coupled feeding structure 2951 may form an electrical path with the conductive portions 29411 through the at least one first coupling pad and an electrical path with the wireless communication circuit 2990 or a ground 2956 through the at least one second coupling pad. In an embodiment, the coupled feeding structure 2951 may transfer electrical signals between the conductive portions 29411 and the wireless communication circuit 2990 or between the conductive portions 29411 and the ground 2956, through a capacitance formed between the at least one first coupling pad and the at least one second coupling pad. In an embodiment, the coupled feeding structure 2951 may prevent a direct electrical signal delivery (or transfer) between the conductive portions 29411 and the wireless communication circuit 2990 and may thereby implement an ESD blocking function that prevents or reduces a delivery or transfer of electrostatic or noise signals from the conductive portions 29411 to the wireless communication circuit 2990. In an embodiment, the coupled feeding structure 2951 may include a discharge inductive portion (e.g., the discharge inductive portion 557D in FIG. 5D) adapted to induce electrostatic or noise signals transferred from the conductive portions 29411 to the first coupling pad to be discharged to the ground 2956. In an embodiment, the discharge inductive portion may be implemented through the arrangements and structures of a discharge inductive portion described above according to various embodiments with reference to FIGS. 5A through 5H.

In an embodiment, the plurality of conductive portions 29411 may be connected to the wireless communication circuit 2990 and form antenna regions for transmitting and receiving various frequency bands. For example, the first conductive portion 29411-1 may form a first antenna region A1. The second conductive portion 29411-2 may form a second antenna region A2. The third conductive portion 29411-3 may form a third antenna region A3. The fourth conductive portion 29411-4 may form a fourth antenna region A4. The fifth conductive portion 29411-5 may form a fifth antenna region A5 or a sixth antenna region A6. The seventh conductive portion 29411-7 may form a seventh antenna region A7. The eighth conductive portion 29411-8 may form an eighth antenna region A8. The ninth conductive portion 29411-9 may form a ninth antenna region A9.

In an embodiment, of the plurality of antenna regions, some antenna regions, for example, A3, A4, and A7, may be used to transmit and receive wireless (or radio) signals in a specific frequency band (e.g., a frequency band of 3 GHz or above). For example, the third antenna region A3, the fourth antenna region A4, and the seventh antenna region A7 may function as an antenna for transmitting and receiving wireless signals in an UHB (e.g., a frequency band from 6 GHz to 10 GHz). In an embodiment, the third conductive portion 29411-3 forming the third antenna region A3, the fourth conductive portion 29411-4 forming the fourth antenna region A4, and the seventh conductive portion 29411-7 forming the seventh antenna region A7 may be connected to the wireless communication circuit 2990 or the ground 2956 via the coupled feeding structure 2951. In an embodiment, using the coupled feeding structure 2951 to transfer electrical signals between the wireless communication circuit 2990 and the conductive portions 29411-3, 29411-4, and 29411-7 may minimize or reduce a loss of electrical signals that may occur in a high-frequency band (e.g., UHB) and omit a separate element (e.g., an ESD protection element 2958) for removing an ESD during an electrical signal delivery or transfer.

In an embodiment, the antenna regions A3, A4, and A7 connected to the wireless communication circuit 2990 via the coupled feeding structure 2951 may be disposed more on an upper side (e.g., the first side member 2940a adjacent to a +Y direction) of the electronic device 2901 than on a lower side (e.g., the second side member 2940b adjacent to a −Y direction) of the electronic device 2901, based on a usage state of the electronic device 2901. In an embodiment, the antenna regions connected to the wireless communication circuit 2990 via the coupled feeding structure 2951 may be disposed adjacent to a housing region (e.g., the first housing 2910) in which a main PCB (e.g., the first PCB 2950a) is disposed. For example, the main PCB may be a circuit board on which an AP, a CP, or the like is disposed. For example, in a case where the main PCB is the first PCB 2950a, the antenna regions connected to the wireless communication circuit 2990 via the coupled feeding structure 2951 may be disposed more on the first side member 2940a of the first housing 2910 compared to the second housing 2920. In this case, an antenna region connected to the wireless communication circuit 2990 via the coupled feeding structure 2951 may not be disposed on the second housing 2920. In an embodiment, the antenna regions connected to the wireless communication circuit 2990 via the coupled feeding structure 2951 may be disposed adjacent to a camera module (e.g., the camera module 2880 in FIG. 28C). For example, in a case where the camera module is disposed adjacent to the upper side (e.g., a portion of the second side member 2940b adjacent to the +Y direction) compared to the lower side (e.g., a portion of the second side member 2940b adjacent to the −Y direction) of the electronic device 2901, more antenna regions to be connected to the wireless communication circuit 2790 via the coupled feeding structure 2751 may be disposed on the portion of the second side member 2940b adjacent to the upper side compared to the lower side of the electronic device 2901. For example, the first housing 2910 and the second housing 2920 in which the camera module (e.g., 2880) is not disposed may have an equal number of antenna regions connected to the wireless communication circuit 2990 via the coupled feeding structure 2951. For example, the antenna regions connected to the wireless communication circuit 2990 via the coupled feeding structure 2951 may not be disposed on the portion of the second side member 2940b adjacent the lower side of the electronic device 2901.

In an embodiment, the upper side (e.g., the portion of the first side member 2940a adjacent to the +Y direction) may be closer to the first PCB 2950a received in the first housing 2910 or the at least one camera module (e.g., the camera module 2880) disposed at the rear of the first housing 2910, compared to the lower side (e.g., the portion of the first side member 2940a adjacent to the −Y direction). In an embodiment, no coupled feeding structure may be disposed between the lower side (e.g., the portion of the first side member 2940a adjacent to the −Y direction) and a wireless communication circuit. In an embodiment, a conductive portion forming an antenna region connected to the wireless communication circuit via a coupled feeding structure may be disposed more on the first housing 2910 than on the second housing 2920. In an embodiment, no coupled feeding structure may be disposed between the second housing 2920 and a wireless communication circuit. However, the preceding embodiments are provided only as examples, and the arrangement and number of antenna regions (e.g., A3, A4, and A7) connected to the wireless communication circuit 2990 via the coupled feeding structure 2951 are not limited thereto.

In an embodiment, of the plurality of antenna regions, some antenna regions A2, A8, and A9 may be connected to the wireless communication circuit 2990 or the ground 2956 via a signal deliver path including the ESD protection element 2958 to transmit and receive wireless (or radio) signals in a specific frequency band (e.g., a frequency band of 3 GHz or below). For example, the second conductive portion 29411-2 forming the second antenna region A2, the eighth conductive portion 29411-8 forming the eighth antenna region A8, and the ninth conductive portion 29411-9 forming the ninth antenna region A9 may be directly connected to the wireless communication circuit 2990 or the ground 2956 via the signal deliver path in which the ESD protection element 2958 is disposed.

In an embodiment, some (e.g., 29411-1 and 29411-5) of the conductive portions 29411 forming the antenna regions may be directly connected to a ground by contacting a conductive structure (e.g., a structure such as a sliding rail, etc.) of the electronic device 2901 without a separate signal deliver path leading to the PCBs 2950a and 2950b. For example, the first conductive portion 29411-1 forming the first antenna region A1 and the fifth conductive portion 29411-5 forming the fifth antenna region A5 and the sixth antenna region A6 may be directly connected to the ground to be connected to the wireless communication circuit 2990 via a signal deliver path with the ESD protection element 2958 omitted. In an embodiment, the fifth conductive portion 29411-5 may have a plurality of grounds/feeders formed thereon. Depending on a path through which electrical signals applied to the fifth conductive portion 29411-5 flow, the fifth conductive portion 29411-5 may function as the fifth antenna region A5 or the sixth antenna region A6.

According to an embodiment, an electronic device (101; 201; 401; 1401; 1501; 2301; 2501; 2701; 2901) may include: a housing (210; 2300; 2500; 2700; 2900) including a side member forming a portion of an outer side of the electronic device (101; 201; 401; 1401; 1501; 2301; 2501; 2701; 2901) and including a conductive portion (4411; 14411; 15411; 23411; 25411; 27411; 29411); a PCB (450; 550; 650; 750A; 750B; 750C; 750D; 750E; 750F; 750G; 850; 950; 1050; 1150; 1250; 1350; 1450; 1550; 1650; 1750A; 1750B; 1850; 1950; 2350a; 2550a; 2750a; 2950a) disposed in the housing (210; 2310; 2510; 2710; 2910); and a wireless communication circuit (490; 1490; 1590; 2390; 2590; 2790; 2990) electrically connected to the PCB. In an embodiment, the PCB may include: a plurality of first coupling pads (5511; 7511; 8511; 9511; 10511; 11511; 12511; 13511; 14511; 15511; 17511; 18511; 19511) disposed on a plurality of layers of the PCB; at least one second coupling pad (5512; 7512; 8512; 9512; 10512; 11512; 12512; 13512; 14512; 15512; 17512; 18512; 19512) spaced apart from the plurality of first coupling pads; a dielectric (552; 752; 852; 952; 1052; 1152; 1252; 1352; 1452; 1552; 1752; 1852; 1952) disposed between the plurality of first coupling pads and the at least one second coupling pad; and an electrical connection member (453; 553; 653; 753; 853; 953; 1053; 1153; 1253; 1353; 1453; 1553; 1753; 1853) connected to the plurality of first coupling pads to form an electrical path and connected to the conductive portion. In an embodiment, the at least one second coupling pad may be connected to the wireless communication circuit to form an electrical path, and at least a portion of the at least one second coupling pad may be disposed between a pair of first coupling pads among the plurality of first coupling pads.

In an embodiment, the second coupling pad may be provided as a plurality of second coupling pads (5512; 7512), and the plurality of first coupling pads (5511; 7511) and the plurality of second coupling pads (5512; 7512) may be disposed alternately on a plurality of layers of the PCB along a first direction.

In an embodiment, respective capacitances for indirect electrical signal delivery may be formed between the first coupling pads (5511; 7511) and the second coupling pads (5512; 7512) adjacent to each other. In an embodiment, a total sum of the respective capacitances formed on the PCB may be greater than or equal to 10 picofarads (pF).

In an embodiment, the plurality of first coupling pads (5511; 7511) and the plurality of second coupling pads (5512; 7512) may have substantially the same overlap area in the first direction.

In an embodiment, the PCB may further include: at least one first conductive via (5551; 7551; 8551; 9551; 10551; 11551; 12551; 13551; 14551; 15551; 17551; 18551; 19551) connected to the plurality of first coupling pads to form an electrical path; and at least one second conductive via (5512; 7552; 8552; 9552; 10552; 11552; 12552; 13552; 14552; 15552; 17552; 18552; 19552) connected to the second coupling pad to form an electrical path.

In an embodiment, the PCB (1050) may include a first board surface (1050a) and a second board surface (1050b) opposite the first board surface. In an embodiment, the dielectric (1052) may be disposed on the first board surface and the second board surface such that the first coupling pads (10511) and the second coupling pad (10512) are not exposed to the outside of the PCB (1050).

In an embodiment, the PCB (350; 450; 1850) may further include: a switch (1859) connected to at least one conductive via of the at least one first conductive via (18551) and the at least one second conductive via (18552), and configured to selectively block an electrical path formed by the conductive via.

In an embodiment, the PCB (550; 550D; 550E; 550F; 550G; 550H) may further include: a ground (556) disposed separately from the first coupling pads (5511) and the second coupling pad (5512); and a discharge inductive portion (557) configured to induce an electrical signal discharge from the first coupling pads (5511) to the ground (556).

In an embodiment, at least one first coupling pad (5511; 5511D; 5511E; 5511F; 5511G) may be disposed on the same layer of the PCB as the ground (556). In an embodiment, the discharge inductive portion (557) may include at least one first discharge member (5571) that is directly connected to the first coupling pad (5511D; 5511F; 5511G) disposed on the same layer as the ground (556) and protrudes toward the ground (556).

In an embodiment, the discharge inductive portion (557) may further include at least one second discharge member (5572) that is connected to the ground (556) and protrudes toward the first coupling pad (5511; 5511D; 5511E; 5511F; 5511G) disposed on the same layer as the ground (556).

In an embodiment, one of the plurality of first coupling pads (7511) and one of the at least one second coupling pad (7512) that are disposed adjacent to each other along the first direction may form a coupling pad set. In an embodiment, a distance (d1) in the first direction between the one of the plurality of first coupling pads and the one of the at least one second coupling pad that form the coupling pad set may be less than a distance (d2) in the first direction between an adjacent coupling pad sets.

In an embodiment, at least one first coupling pad (12511; 13511) and at least one second coupling pad (12512; 13512) may be disposed on the same layer relative to a first direction of the PCB (1250; 1350). In an embodiment, each of one (12511-1; 13511) of the plurality of first coupling pads and one (12512-1; 13512) of the at least one second coupling pad disposed on the same layer may include a plurality of pad portions (12511a; 12512a; 13511a; 13512a) disposed alternately in a second direction of the PCB perpendicular to the first direction.

In an embodiment, the PCB (1550) may further include: a third coupling pad (15513) electrically insulated from the first coupling pad (15511) and the second coupling pad (15512) via the dielectric (1552). In an embodiment, the third coupling pad (15513) and the second coupling pad (15512) may overlap at least partially in the first direction of the PCB (1550). In an embodiment, the electrical connection member (1553) may include: a first electrical connection member (15531) connected to the first coupling pad (15511) to form an electrical path; and a second electrical connection member (15532) connected to the third coupling pad (15513) to form an electrical path.

In an embodiment, the side member (1540) may include a first conductive portion (15411-1) and a second conductive portion (15411-2) electrically separated along the side. In an embodiment, the first electrical connection member (15531) and the second electrical connection member (15532) may be connected to the first conductive portion (15411-1) and the second conductive portion (15411-2), respectively.

In an embodiment, the PCB (1450) may further include: a fourth coupling pad (14514) electrically insulated from the first coupling pad (14511) and the second coupling pad (14512) via the dielectric (1452) and connected to the wireless communication circuit (1490) to form an electrical path. In an embodiment, the first coupling pad (14511) and the fourth coupling pad (14514) may overlap at least partially in the first direction of the PCB (1450).

In an embodiment, the PCB (1750A; 1750B) may further include: a radiation member (1756; 1757) including a conductive material or conductive pattern. In an embodiment, the radiation member (1756; 1757) may be disposed to overlap the second coupling pad (17512) in the first direction of the PCB (1750A; 1750B) or may be electrically connected to the wireless communication circuit (490).

According to an embodiment, an electronic device (101; 201; 401; 1401; 1501; 2301; 2501; 2701; 2901) may include: a housing (210; 410; 2300; 2500; 2700; 2900) including a side member (440; 1440; 1540; 2340; 2540; 2740; 2940) forming a portion of an outer side of the electronic device (201; 401; 1401; 1501; 2301; 2501; 2701; 2901) and including a conductive portion (4411; 14411; 15411; 23411; 25411; 27411; 29411); a PCB (450; 550; 650; 750A; 750B; 750C; 750D; 750E; 750F; 750G; 850; 950; 1050; 1150; 1250; 1350; 1450; 1550; 1650; 1750A; 1750B; 1850; 1950; 2350a; 2550a; 2750a; 2950a) disposed in the housing (210; 2310; 2510; 2710; 2910); and a wireless communication circuit (490; 1490; 1590; 2390; 2590; 2790; 2990) electrically connected to the PCB. In an embodiment, the PCB may include: a first coupling pad (5511; 7511; 8511; 9511; 10511; 11511; 12511; 13511; 14511; 15511; 17511; 18511; 19511); a second coupling pad (5512; 7512; 8512; 9512; 10512; 11512; 12512; 13512; 14512; 15512; 17512; 18512; 19512) spaced apart from the first coupling pad and connected to the wireless communication circuit to form an electrical path; a dielectric (552; 752; 852; 952; 1052; 1152; 1252; 1352; 1452; 1552; 1752; 1852; 1952) configured to electrically insulate the first coupling pad and the second coupling pad; an electrical connection member (453; 553; 653; 753; 853; 953; 1053; 1153; 1253; 1353; 1453; 1553; 1753; 1853) connected to the first coupling pad to form an electrical path and connected to the conductive portion; a ground (456; 556; 656; 2356; 2556; 2756; 2956) disposed to be electrically separated from the first coupling pad and the second coupling pad; and a discharge inductive portion (557D; 557E; 557F; 557G; 557H; 657) configured to induce an electrical signal discharge from the first coupling pad to the ground. In an embodiment, the first coupling pad and the second coupling pad may overlap at least partially along a first direction of the PCB.

In an embodiment, the ground (456; 556; 656) may be disposed on a surface of the PCB (450; 550; 650). In an embodiment, at least one first coupling pad (5511; 5511D; 5511E; 5511F; 5511G; 6511) may be disposed on the same layer as the ground (556; 656). In an embodiment, the discharge inductive portion (557D; 557E; 557F; 557G; 557H; 657) may be disposed between the first coupling pad (5511; 5511D; 5511E; 5511F; 5511G; 6511) and the ground (556; 656) disposed on the same layer.

In an embodiment, the discharge inductive portion (557D; 557E; 557F; 557G; 557H; 657) may include: a first discharge member (5571) connected to the first coupling pad (5511; 5511D; 5511F; 5511G; 6511) and extending toward the ground (556; 656); or a second discharge member (5572) connected to the ground (556) and extending toward the first coupling pad (5511; 5511E; 5511F; 5511G). In an embodiment, when facing the ground (556; 656), a gap (G) may be formed between the first discharge member (5571) and the ground (556) and between the second discharge member (5572) and the first coupling pad (5511; 6511), in which the dielectric (552; 652) is disposed.

According to an embodiment, an electronic device (101; 201; 1501) may include: a housing including a side member (1540) forming a portion of an outer side of the electronic device (201; 1501) and including a first conductive portion (15411-1) and a second conductive portion (15411-2) that are electrically separable; a PCB (1550) disposed in the housing; and a wireless communication circuit (1590) electrically connected to the PCB (1550). In an embodiment, the PCB (1550) may include: a first coupling pad (15511); a second coupling pad (15512) spaced apart from the first coupling pad (15511) and connected to the wireless communication circuit (1590) to form an electrical path; a third coupling pad (15513) spaced apart from the first coupling pad (15511) and the second coupling pad (15512); a dielectric (1552) configured to electrically insulate each of the first coupling pad (15511), the second coupling pad (15512), and the third coupling pad (15513); a first electrical connection member (15531) connected to the first coupling pad (15511) to form an electrical path and connected to the first conductive portion (15411-1); and a second electrical connection member (15532) connected to the third coupling pad (15513) to form an electrical path and connected to the second conductive portion (15411-2). In an embodiment, the first coupling pad (15511) and the third coupling pad (15513) may each overlap at least partially the second coupling pad (15512) along a first direction of the PCB (1550).

According to an embodiment, an electronic device (101; 201; 1401) may include: a housing including a side member (1440) forming a portion of an outer side of the electronic device (201; 1501) and including a conductive portion (14411); a PCB (1450) disposed in the housing; and a wireless communication circuit (1490) electrically connected to the PCB (1450). In an embodiment, the PCB (1450) may include: a first coupling pad (14511); a second coupling pad (14512) spaced apart from the first coupling pad (14511) and connected to the wireless communication circuit (1490) via a first signal line (14541); a fourth coupling pad (14514) spaced apart from the first coupling pad (14511) and the second coupling pad (14512), and connected to the wireless communication circuit (1490) via a second signal line (14542); a dielectric (1452) configured to electrically insulate each of the first coupling pad (14511), the second coupling pad (14512), and the fourth coupling pad (14514); and an electrical connection member (1453) connected to the first coupling pad (14511) to form an electrical path and connected to the conductive portion (14411). In an embodiment, the second coupling pad (14512) and the fourth coupling pad (14514) may each overlap at least partially the first coupling pad (14511) along a first direction of the PCB (1450).

According to an embodiment, an electronic device (101; 201; 1601) may include: a housing including a side member (1640) forming a portion of an outer side of the electronic device (201; 1601), and including a first conductive portion (16411-1) and a second conductive portion (16411-2) that are electrically separable; and a PCB (1650) disposed in the housing. In an embodiment, the PCB (1650) may include: a first coupling pad (16511); a second coupling pad (16512) spaced apart from the first coupling pad (16511); a dielectric (1652) configured to electrically insulate between the first coupling pad (16511) and the second coupling pad (16512); a first electrical connection member (16531) connected to the first coupling pad (16511) to form an electrical path and connected to the first conductive portion (16411-1); and a second electrical connection member (16532) connected to the second coupling pad (16512) to form an electrical path and connected to the second conductive portion (16411-2). In an embodiment, the first coupling pad (16511) and the second coupling pad (16512) may overlap at least partially along a first direction of the PCB (1650).

According to an embodiment, an electronic device (101; 201; 401) may include: a housing (210; 410) including a side member (440) forming a portion of an outer side of the electronic device (201; 401) and including a conductive portion (4411); a PCB (450; 750G) disposed in the housing (210; 410); and a wireless communication circuit (490) electrically connected to the PCB (450; 750G). In an embodiment, the PCB (450; 750G) may include: a first coupling pad (7511); a plurality of second coupling pads (7512) spaced apart from the first coupling pad (7511); a dielectric (752) configured to electrically insulate each of the first coupling pad (7511) and the plurality of second coupling pads (7512); and an electrical connection member (753) connected to the first coupling pad (7511) to form an electrical path and connected to the conductive portion (4411). In an embodiment, the plurality of second coupling pads (7512) may be connected to the wireless communication circuit (490) to form an electrical path, and at least a portion of the first coupling pad (7511) may be disposed between a pair of second coupling pads (7512-1, 7512-2).

According to an embodiment, an electronic device (101; 201; 401) may include: a housing (210; 410) including a side member (440) forming a portion of an outer side of the electronic device (201; 401) and including a conductive portion (4411); a PCB (750C) disposed in the housing (210; 410); and a wireless communication circuit (490) electrically connected to the PCB (750C). In an embodiment, the PCB (750C) may include: a pair of first coupling pads (7511-1, 7511-2) disposed on different layers of the PCB (750C); a second coupling pad (7512) disposed on a layer disposed between the pair of first coupling pads (7511-1, 7511-2) and spaced apart from the pair of first coupling pads (7511-1, 7511-2); a dielectric (752) configured to electrically insulate each of the pair of first coupling pads (7511-1, 7511-2) and the second coupling pad (7512); and an electrical connection member (753) connected to the pair of first coupling pads (7511-1, 7511-2) to form an electrical path and connected to the conductive portion (4411). In an embodiment, the second coupling pad (7512) may be connected to the wireless communication circuit (490) to form an electrical path, and at least a portion of the second coupling pad (7512) may be disposed to overlap between the pair of first coupling pads (7511-1, 7511-2).

According to an embodiment, an electronic device (101; 301; 401; 1401; 1501) may include: a housing (310) including a front surface (310a), a rear surface (310b) opposite the front surface (310a), and a side (311c) enclosing an inner space between the front surface (310a) and the rear surface (310b), and including a side member (340; 441; 1441; 1541) forming at least a portion of the side (311c) and including a conductive portion (4411; 14411; 15411); a PCB (350; 450; 550; 1450; 1550) disposed in the inner space; and a wireless communication circuit (190; 490; 1490; 1590) electrically connected to the PCB (350; 450; 550; 1450; 1550). In an embodiment, the PCB (350; 450; 550; 1450; 1550) may include: a plurality of coupling pads (451; 551; 1451; 1551) disposed to be separated from each other; a dielectric (452; 552; 1452; 1552) disposed between the plurality of coupling pads (451; 551; 1451; 1551) and configured to electrically insulate each of the plurality of coupling pads (451; 551; 1451; 1551); a ground (456; 556; 1456; 1556) disposed to be separated from the plurality of coupling pads (451; 551; 1451; 1551); and an electrical connection member (453; 553; 1453; 1553) disposed on a surface of the PCB (350; 450; 550; 1450; 1550) and electrically connected to the conductive portion (4411; 14411; 15411). In an embodiment, the plurality of coupling pads (451; 551; 1451; 1551) may include: a plurality of first coupling pads (5511; 14511; 15511) electrically connected to the electrical connection member (453; 553; 1453; 1553); and at least one second coupling pad (5512; 14512; 15512) electrically connected to the wireless communication circuit (190; 490; 1490; 1590). In an embodiment, with the PCB (350; 450; 550; 1450; 1550) viewed in a first direction (T), the at least one second coupling pad (5512; 14512; 15512) may be disposed overlappingly between at least one pair of first coupling pads (5511; 14511; 15511).

In an embodiment, the circuit board (350; 450; 550; 1450; 1550) may include a plurality of second coupling pads (5512; 14512; 15512). In an embodiment, the plurality of first coupling pads (5511; 14511; 15511) and the plurality of second coupling pads (5512; 14512; 15512) may be alternately disposed along the first direction (T) of the PCB (350; 450; 550; 1450; 1550) and may at least partially overlap each other along the first direction (T).

In an embodiment, with the PCB (350; 450; 550; 1450; 1550) viewed in the first direction (T), the plurality of coupling pads (451; 551; 1451; 1551) may be disposed such that a first coupling pad (5511-1, 5511-2) and a second coupling pad (5512-1, 5512-2) adjacent to each other may have substantially the same overlap area (A).

In an embodiment, the PCB (350; 450; 550; 1450; 1550) may include a plurality of conductive vias (555; 1455; 1555) penetrating the PCB (350; 450; 550; 1450; 1550) in the first direction (T) and electrically connecting at least some coupling pads (451; 551; 1451; 1551) of the plurality of coupling pads (451; 551; 1451; 1551) to each other. In an embodiment, the plurality of conductive vias (555; 1455; 1555) may include at least one first conductive via (5551; 14551; 15551) connected to the first coupling pad (5511; 14511; 15511), and at least one second conductive via (5552; 14552; 15552) electrically insulated from the first conductive via (5551; 14551; 15551) and connected to the second coupling pad (5512; 14512; 15512).

In an embodiment, the PCB (350; 450; 1050) may include a first board surface (1050a) and a second board surface (1050b) opposite the first board surface (1050a) with respect to the first direction (T). In an embodiment, the plurality of coupling pads (1051) may be disposed inside the PCB (350; 450; 1050) such that they are not exposed to an outer surface (1050a; 1050b) of the PCB (350; 450; 1050). In an embodiment, the electrical connection member (1053) may be disposed on the first board surface (1050a) of the PCB (1050). In an embodiment, the ground may be disposed on the second board surface (1050b) of the PCB (1050).

In an embodiment, the PCB (350; 450; 1850) may further include a switch (1859) connected to at least one conductive via (18551; 18552) of the plurality of conductive vias (18551; 18552) and configured to selectively block an electrical connection through the conductive via (18551; 18552).

In an embodiment, the PCB (350; 450; 550; 650) may further include a discharge inductive portion (557; 657) configured to induce an electrical signal from the first coupling pad (4511; 5511; 6511) to the ground (456; 556; 656).

In an embodiment, one first coupling pad (5511-2; 6511) of the plurality of first coupling pads (4511; 5511; 6511) may be disposed on the same plane (e.g., same layer) as the ground (456; 556; 656). In an embodiment, the discharge inductive portion (557; 657) may include at least one first discharge member (5571; 657) connected to the first coupling pad (5511-2; 6511) disposed on the same plane as the ground (456; 556; 656) and protruding toward the ground (456; 556; 656).

In an embodiment, the discharge inductive portion (557; 657) may further include at least one second discharge member (5572) connected to the ground (556; 656) and protruding toward the first coupling pad (5511-2) disposed on the same plane (e.g., same layer) as the ground (556; 656).

In an embodiment, the plurality of coupling pads (751) may form a plurality of coupling pad sets including at least one first coupling pad (7511) and at least one second coupling pad (7512) disposed adjacent to each other along the first direction (T) of the PCB (750E; 750F). In an embodiment, a distance (d1) in the first direction (T) of the PCB (750E; 750F) between the first coupling pad (7511-1) and the second coupling pad (7512-1) forming one coupling pad set may be smaller than a distance (d2) in the first direction (T) of the PCB (750E; 750F) between an adjacent coupling pad set.

In an embodiment, at least one first coupling pad (12511; 13511) and at least one second coupling pad (12512; 13512) may be disposed on the same plane (e.g., same layer) relative to the first direction (T) of the PCB (1250; 1350). In an embodiment, the first coupling pad (12511-1; 13511) and the second coupling pad (12512-1; 13512) that are disposed on the same plane may each include a plurality of pad portions (12511a; 13511a; 12512a; 13512a) alternately disposed in a direction perpendicular to the first direction (T) of the PCB (1250; 1350).

In an embodiment, the PCB (1550) may include a plurality of third coupling pads (15513) disposed overlappingly with the at least one second coupling pad (15512) when viewed in the first direction (T), and may further include at least one first conductive via (15551) penetrating the PCB (1550) in the first direction (T) and electrically connecting the plurality of first coupling pads (15511), at least one second conductive via (15552) penetrating the PCB (1550) in the first direction (T) and electrically connected to the second coupling pad (15512), and at least one third conductive via (15553) penetrating the PCB (1550) in the first direction (T) and electrically connecting the plurality of third coupling pads (15513). In an embodiment, the electrical connection member (15531; 15532) may include a first electrical connection member (15531) electrically connected to the plurality of first coupling pads (15511) and a second electrical connection member (15532) electrically connected to the plurality of third coupling pads (15513).

In an embodiment, the side member (1540) may include a plurality of conductive portions (15411-1; 15411-2) electrically separated along the side. In an embodiment, the first electrical connection member (15531) and the second electrical connection member (15532) may be connected to different conductive portions (15411-1; 15411-2) of the side member, respectively.

In an embodiment, the PCB (1450) may further include: at least one fourth coupling pad (14541) disposed overlappingly with the first coupling pad (14511) when viewed in the first direction (T) and electrically connected to the wireless communication circuit (1490); at least one first conductive via (14551) penetrating the PCB (1450) in the first direction (T) and electrically connecting the plurality of first coupling pads (14511); at least one second conductive via (14552) penetrating the PCB (1450) in the first direction (T) and electrically connected to the second coupling pad (14512); and at least one fourth conductive via (14554) penetrating the PCB (1450) in the first direction (T) and electrically connected to the fourth coupling pad (14514).

In an embodiment, the PCB (1750A; 1750B) may further include a radiation member (1756; 1757) including a conductive material or conductive pattern. In an embodiment, the radiation member (1756; 1757) may be disposed overlappingly with the second coupling pad (17512), with the PCB (1750A; 1750B) viewed in the first direction (T), or may be electrically connected to the wireless communication circuit (490).

According to an embodiment, an electronic device (101; 301; 401; 1401; 1501) may include: a housing including a front surface (310a), a rear surface (310b) opposite the front surface (310a), and a side (311c) enclosing an inner space between the front surface (310a) and the rear surface (310b), and including a side member (340; 441; 1441; 1541) forming at least a portion of the side (311c) and including a conductive portion (4411; 14411; 15411); a PCB (350; 450; 550; 1450; 1550) disposed in the inner space; and a wireless communication circuit (190; 490; 1490; 1590) electrically connected to the PCB (350; 450; 550; 1450; 1550). In an embodiment, the PCB (350; 450; 550; 650; 1450; 1550) may include: a plurality of coupling pads (451; 551; 651) disposed to be separated from each other; a dielectric (552; 652) disposed between the plurality of coupling pads (451; 551; 651) and configured to electrically insulate each of the plurality of coupling pads (451; 551; 651); a ground (456; 556; 656) disposed to be separated from the plurality of coupling pads (451; 551; 651); an electrical connection member (453; 553; 653) disposed on the PCB (450; 550; 650) and electrically connected to the conductive portion (4411); and a discharge inductive portion (557; 657) disposed adjacent to the ground (456; 556; 656). In an embodiment, the plurality of coupling pads (451; 551; 651) may include: at least one first coupling pad (4511; 5511; 6511) electrically connected to the electrical connection member (453; 553; 653); and at least one second coupling pad (4512; 5512; 6512) electrically connected to the wireless communication circuit (490) and, with the PCB (450; 550; 650) viewed in a first direction (T), at least partially overlapping the first coupling pad (4511; 5511; 6511). In an embodiment, the discharge inductive portion (557; 657) may be connected to any one of the first coupling pad (4511; 5511; 6511) and the ground (456; 556; 656) and include at least one discharge member (5571; 5572) configured to induce an electrical signal discharge from the first coupling pad (4511; 5511; 6511) to the ground.

In an embodiment, the ground (456; 556; 656) may be disposed on the surface (550b) of the PCB (450; 550; 650). In an embodiment, at least one first coupling pad (5511-2; 6511) may be disposed on the same plane as the ground (556; 656). In an embodiment, the discharge member (5571; 5572) may be disposed between the first coupling pad (5511-2; 6511) and the ground (556; 656) disposed on the same plane.

In an embodiment, the discharge inductive portion (557) may include: a first discharge member (5571) connected to the first coupling pad (5571-2) and extending toward the ground (556); or a second discharge member (5572) connected to the ground (556) and extending toward the first coupling pad (5571-2). In an embodiment, when facing the ground (556), a gap (G) may be formed between the first discharge member (5571) and the ground (556) and between the second discharge member (5572) and the first coupling pad (5571-2), in which the dielectric (552) is disposed.

In an embodiment, the gap G may be less than or equal to 200 μm.

According to an embodiment, an electronic device (101; 301; 1501) may include: a housing (310) including a front surface (310a), a rear surface (310b) opposite the front surface (310a), and a side (311c) enclosing an inner space between the front surface (310a) and the rear surface (310b), and including a side member (1540) forming at least a portion of the side (311c) and including a first conductive portion (15411) and a second conductive portion (15411) that are electrically separable; a PCB (1550) disposed in the inner space; and a wireless communication circuit (1590) electrically connected to the PCB (1550). In an embodiment, the PCB (1550) may include: a plurality of coupling pads (1551) disposed to be separated from each other; a dielectric (1552) disposed between the plurality of coupling pads (1551) and configured to electrically insulate each of the plurality of coupling pads (1551); a ground (456) disposed to be separated from the plurality of coupling pads (1551); a first electrical connection member (15531) disposed on a surface of the PCB (1550) and electrically connected to the first conductive portion (15411); and a second electrical connection member (15532) disposed on the surface of the PCB (1550) and electrically connected to the second conductive portion (15411). In an embodiment, the plurality of coupling pads (1551) may include: a first coupling pad (15511) electrically connected to the first electrical connection member (15531); a second coupling pad (15512) electrically connected to the wireless communication circuit (1590); and a third coupling pad (15513) electrically connected to the second electrical connection member (15532). In an embodiment, with the PCB (1550) viewed in a first direction (T), the first coupling pad (15511) and the third coupling pad (15513) may each be disposed to at least partially overlap the second coupling pad (15512).

According to an embodiment, an electronic device (101; 301; 1501) may include: a housing (310) including a front surface (310a), a rear surface (310b) opposite the front surface (310a), and a side (311c) enclosing an inner space between the front surface (310a) and the rear surface (310b), and including a side member (1440) forming at least a portion of the side (311c) and including a conductive portion (1441); a PCB (1450) disposed in the inner space; and a wireless communication circuit (1490) electrically connected to the PCB (1450). In an embodiment, the PCB (1450) may include: a plurality of coupling pads (1451) disposed to be separated from each other; a dielectric (1452) disposed between the plurality of coupling pads (1451) and configured to electrically insulate each of the plurality of coupling pads (1451); a ground (456) disposed to be separated from the plurality of coupling pads (1451); an electrical connection member (1453) disposed on a surface of the PCB (1450) and electrically connected to the conductive portion (1441); and a first signal line (14541) and a second signal line (14542) each connected to the wireless communication circuit (1490). In an embodiment, the plurality of coupling pads (1451) may include: a first coupling pad (14511) electrically connected to the electrical connection member (1453); a second coupling pad (14512) electrically connected to the first signal line (14541); and a fourth coupling pad (14514) electrically connected to the second signal line (14542). In an embodiment, with the PCB (1450) viewed in a first direction (T), the second coupling pad (14512) and the fourth coupling pad (14514) may each overlap at least partially the first coupling pad (14511).

According to an embodiment, an electronic device (101; 301; 1601) may include: a housing including a front surface (310a), a rear surface (310b) opposite the front surface, and a side (311a) enclosing an inner space between the front surface (310a) and the rear surface (310b), and including a side member (1640) forming at least a portion of the side (311c) and including a first conductive portion (16411) and a second conductive portion (16411) that are electrically separable; and a PCB (1650) disposed in the inner space. In an embodiment, the PCB (1650) may include: a plurality of coupling pads (1651) disposed to be separated from each other; a dielectric (1652) disposed between the plurality of coupling pads (1651) and configured to electrically insulate each of the plurality of coupling pads (1651); a first electrical connection member (16531) disposed on a surface of the PCB (1650) and electrically connected to the first conductive portion (16411); and a second electrical connection member (16532) disposed on the surface of the PCB (1650) and electrically connected to the second conductive portion (16411). In an embodiment, the plurality of coupling pads (1651) may include: a first coupling pad (16511) electrically connected to the first electrical connection member (16531); and a second coupling pad (16512) electrically connected to the second electrical connection member (16532). In an embodiment, with the PCB (1650) viewed in a first direction (T), the first coupling pad (16511) and the second coupling pad (16512) may at least partially overlap each other.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device, comprising:
a housing comprising a side member forming a portion of an outer side of the electronic device and comprising a conductive portion;
a printed circuit board (PCB) provided in the housing; and
a wireless communication circuit electrically connected to the PCB,
wherein the PCB comprises:
a plurality of first coupling pads provided on at least some of a plurality of layers of the PCB;
at least one second coupling pad spaced apart from the plurality of first coupling pads;
a dielectric provided between the plurality of first coupling pads and the at least one second coupling pad; and
an electrical connection member connected to the plurality of first coupling pads to form an electrical path, and connected to the conductive portion,
wherein the at least one second coupling pad is connected to the wireless communication circuit to form an electrical path, and
wherein at least a portion of the at least one second coupling pad is provided between a pair of first coupling pads among the plurality of first coupling pads.

2. The electronic device of claim 1, wherein the at least one second coupling pad is provided as a plurality of second coupling pads, and
wherein the plurality of first coupling pads and the plurality of second coupling pads are alternately provided on at least some of the plurality of layers of the PCB along a first direction.

3. The electronic device of claim 2, wherein, the plurality of first coupling pads are adjacent to the plurality of second coupling pads, and respective capacitances for indirect electrical signal delivery are configured to form between the plurality of first coupling pads and the plurality of second coupling pads, and
wherein a total sum of the respective capacitances formed on the PCB is configured to be greater than or equal to 10 picofarads (pF).

4. The electronic device of claim 2, wherein an overlap area among the plurality of first coupling pads and the plurality of second coupling pads is substantially similar in the first direction.

5. The electronic device of claim 1, wherein the PCB further comprises:
at least one first conductive via connected to the plurality of first coupling pads to form an electrical path; and
at least one second conductive via connected to the second coupling pad to form an electrical path.

6. The electronic device of claim 1, wherein the PCB has a first board surface and a second board surface opposite the first board surface, and
wherein the dielectric is provided on the first board surface and the second board surface such that the plurality of first coupling pads and the at least one second coupling pad are not exposed to an outside of the PCB.

7. The electronic device of claim 5, wherein the PCB further comprises:
a switch connected to at least one conductive via among the at least one first conductive via and the at least one second conductive via, and configured to selectively block an electrical path formed by the at least one conductive via.

8. The electronic device of claim 1, wherein the PCB further comprises:
a ground spaced apart from the plurality of first coupling pads and the at least one second coupling pad; and
a discharge inductive portion configured to induce an electrical signal discharge from the plurality of first coupling pads to the ground.

9. The electronic device of claim 8, wherein at least one first coupling pad, among the plurality of first coupling pads, and the ground are provided on a same layer of the PCB, and
wherein the discharge inductive portion comprises at least one first discharge member directly connected to the at least one first coupling pad on the same layer as the ground and protruding toward the ground.

10. The electronic device of claim 9, wherein the discharge inductive portion further comprises at least one second discharge member connected to the ground and protruding toward the at least one first coupling pad provided on the same layer as the ground.

11. The electronic device of claim 1, wherein a first coupling pad, among the plurality of first coupling pads, is adjacent to a second coupling pad, among the at least one second coupling pad, along a first direction,
wherein the first coupling pad and the second coupling pad form a coupling pad set, and
wherein a distance in the first direction between the first coupling pad and the second coupling pad that form the coupling pad set is less than a distance in the first direction between an adjacent coupling pad set.

12. The electronic device of claim 1, wherein at least one first coupling pad, among the plurality of first coupling pads, and the at least one second coupling pad are provided on a same layer relative to a first direction of the PCB, and
wherein the at least one first coupling pad and the at least one second coupling pad on the same layer are alternately provided in a second direction of the PCB perpendicular to the first direction.

13. The electronic device of claim 1, wherein the PCB further comprises:
a third coupling pad electrically insulated from the plurality of first coupling pads and the at least one second coupling pad based on the dielectric,
wherein the third coupling pad and the at least one second coupling pad at least partially overlap in a first direction of the PCB, and
wherein the electrical connection member comprises:
a first electrical connection member connected to at least some of the plurality of first coupling pads to form an electrical path; and
a second electrical connection member connected to the third coupling pad to form an electrical path.

14. The electronic device of claim 13, wherein the side member comprises a first conductive portion and a second conductive portion electrically separated along the outer side of the electronic device, and
wherein the first electrical connection member and the second electrical connection member are connected to the first conductive portion and the second conductive portion, respectively.

15. The electronic device of claim 1, wherein the PCB further comprises:
a fourth coupling pad electrically insulated from the plurality of first coupling pads and the at least one second coupling pad based on the dielectric, and connected to the wireless communication circuit to form an electrical path, and
wherein at least one first coupling pad, among the plurality of first coupling pads, and the fourth coupling pad overlap at least partially in a first direction of the PCB.

16. The electronic device of claim 1, wherein the PCB further comprises:
a radiation member comprising a conductive material or conductive pattern, and
wherein the radiation member overlaps the at least one second coupling pad in a first direction of the PCB or is electrically connected to the wireless communication circuit.

17. An electronic device, comprising:
a housing comprising a side member forming a portion of an outer side of the electronic device and comprising a conductive portion;
a printed circuit board (PCB) provided in the housing; and
a wireless communication circuit electrically connected to the PCB,
wherein the PCB comprises:
a first coupling pad;
a second coupling pad spaced apart from the first coupling pad and connected to the wireless communication circuit to form an electrical path;
a dielectric configured to electrically insulate the first coupling pad and the second coupling pad;
an electrical connection member connected to the first coupling pad to form an electrical path, and connected to the conductive portion;
a ground electrically separated from the first coupling pad and the second coupling pad; and
a discharge inductive portion configured to induce an electrical signal discharge from the first coupling pad to the ground, and
wherein the first coupling pad and the second coupling pad at least partially overlap along a first direction of the PCB.

18. The electronic device of claim 17, wherein the ground is provided on a surface of the PCB,
the first coupling pad is provided on a same layer as the ground, and
the discharge inductive portion is between the first coupling pad and the ground on the same layer.

19. The electronic device of claim 18, wherein the discharge inductive portion comprises:
a first discharge member connected to the first coupling pad and protruding toward the ground; or
a second discharge member connected to the ground and protruding toward the first coupling pad,
wherein, a gap is formed between the first discharge member and the ground, or between the second discharge member and the first coupling pad, and
wherein the dielectric is provided in the gap.

20. An electronic device, comprising:
a housing comprising a side member forming a portion of an outer side of the electronic device and comprising a conductive portion;
a printed circuit board (PCB) provided in the housing; and
a wireless communication circuit electrically connected to the PCB,
wherein the PCB comprises:
a first coupling pad;
a plurality of second coupling pads spaced apart from the first coupling pad;
a dielectric configured to electrically insulate the first coupling pad and the plurality of second coupling pads; and
an electrical connection member connected to the first coupling pad to form an electrical path, and connected to the conductive portion, and
wherein the plurality of second coupling pads are connected to the wireless communication circuit to form an electrical path, and at least a portion of the first coupling pad is provided between a pair of second coupling pads among the plurality of second coupling pads.
